(19) United States
(12) Patent Application Publication
(10) Pub. No.: US 2026/0222863 A1
(43) Pub. Date: Jul. 30, 2026

(54) METHOD, DEVICE AND COMPUTER STORAGE MEDIUM OF COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/141,744

(22) PCT Filed: Dec. 21, 2022
(86) PCT No.: PCT/CN2022/140844

§ 371 Date: Jun. 20, 2025

(51) Int. Cl. H04W 24/10; H04L 5/00

(52) U.S. Cl. CPC H04W 24/10; H04L 5/0051

(57) ABSTRACT

Embodiments of the present disclosure provide a solution on CSI. According to embodiments of the present disclosure, a network device transmits, to a terminal device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report. Each value in a combination of values for first vector corresponds to one of the plurality of CSI-RS resources. The terminal device determines a first combination from the set of combinations of values for first vector, a first value from the set of values for second vector and a second value from the set of values for the first parameter based on at least a set of CSI-RS resources from the plurality of CSI-RS resources and transmits the CSI report based on the determination.

### TECHNICAL FIELD

Embodiments of the present disclosure generally relate to the field of telecommunication, and in particular, to methods, devices and computer storage media of communication for channel state information (CSI).

### BACKGROUND

Several technologies have been proposed to improve communication performances. For example, multi-input multi-output (MIMO) has been proposed. MIMO includes features that facilitate utilization of a large number of antenna elements at base station for both sub-6 GHz and over-6 GHz frequency bands. In this situation, a plurality of antennas at a transmitter and/or receiver can be used to achieve array and diversity gain instead of capacity gain. In wireless communications, channel state information (CSI) is the known channel properties of a communication link. This information describes how a signal propagates from the transmitter to the receiver and represents the combined effect of, for example, scattering, fading, and power decay with distance. The method is called Channel estimation. The CSI makes it possible to adapt transmissions to current channel conditions, which is crucial for achieving reliable communication with high data rates in multi-antenna systems. Therefore, CSI enhancement is worth studying.

### SUMMARY

In general, embodiments of the present disclosure provide methods, devices and computer storage media for CSI.

In a first aspect, there is provided a terminal device. The terminal device comprises a processor, configured to cause the terminal device to: receive, from a network device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; determine a first combination from the set of combinations of values for first vector, a first value from the set of values for second vector and a second value from the set of values for the first parameter based on at least a set of CSI-RS resources from the plurality of CSI-RS resources; and transmit the CSI report based on the first combination, the first value from the set of values for second vectors and the second value from the set of values for the first parameter.

In a second aspect, there is provided a terminal device. The terminal device comprises a processor configured to cause the terminal device to: receive, from a network device, at least one configuration indicating a plurality of channel state information reference signal (CSI-RS) resources for channel measurement for a CSI report and the at least one configuration indicates a number of second vectors and a size of a second vector window for a channel state information (CSI) report; and transmit, to the network device, an indication in the CSI report indicating a second vector offset corresponding to one CSI-RS resource of the plurality of CSI-RS resources, and the second vector offset is in a specific value range.

In a third aspect, there is provided a network device. The network device comprises a processor configured to cause the network device to: transmit, to a terminal device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; and receive the CSI report based on a first combination, a first value from the set of values for second vectors and the second value from the set of values for the first parameter, wherein the first combination is determined from the set of combinations of values for first vector, the first value is determined from the set of values for second vector and the second value is determined from the set of values for the first parameter based on at least a set of CSI-RS resources from the plurality of CSI-RS resources.

In a fourth aspect, there is provided a network device. The network device comprises a processor configured to cause the network device to: transmit, to a terminal device, at least one configuration indicating a plurality of channel state information reference signal (CSI-RS) resources for channel measurement for a CSI report and the at least one configuration indicates a number of second vectors and a size of a second vector window for a channel state information (CSI) report; and receive, from the terminal device, an indication in the CSI report indicating a second vector offset corresponding to one CSI-RS resource of the plurality of CSI-RS resources, and the second vector offset is in a specific value range.

In a fifth aspect, there is provided a communication method. The method comprises: receiving, at a terminal device and from a network device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; determining a first combination from the set of combinations of values for first vector, a first value from the set of values for second vector and a second value from the set of values for the first parameter based on at least a set of CSI-RS resources from the plurality of CSI-RS resources; and transmitting the CSI report based on the first combination, the first value from the set of values for second vectors and the second value from the set of values for the first parameter.

In a sixth aspect, there is provided a communication method. The method comprises: receiving, at a terminal device and from a network device, at least one configuration indicating a plurality of channel state information reference signal (CSI-RS) resources for channel measurement for a CSI report and the at least one configuration indicates a number of second vectors and a size of a second vector window for a channel state information (CSI) report; and transmitting, to the network device, an indication in the CSI report indicating a second vector offset corresponding to one CSI-RS resource of the plurality of CSI-RS resources, and the second vector offset is in a specific value range.

In a seventh aspect, there is provided a communication method. The method comprises: transmitting, at a network device and to a terminal device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; and receiving the CSI report based on a first combination, a first value from the set of values for second vectors and the second value from the set of values for the first parameter, wherein the first combination is determined from the set of combinations of values for first vector, the first value is determined from the set of values for second vector and the second value is determined from the set of values for the first parameter based on at least a set of CSI-RS resources from the plurality of CSI-RS resources.

In an eighth aspect, there is provided a communication method. The method comprises: transmitting, at a network device and to a terminal device, at least one configuration indicating a plurality of channel state information reference signal (CSI-RS) resources for channel measurement for a CSI report and the at least one configuration indicates a number of second vectors and a size of a second vector window for a channel state information (CSI) report; and receiving, from the terminal device, an indication in the CSI report indicating a second vector offset corresponding to one CSI-RS resource of the plurality of CSI-RS resources, and the second vector offset is in a specific value range.

In a ninth aspect, there is provided a computer readable medium having instructions stored thereon, the instructions, when executed on at least one processor, causing the at least one processor to carry out the method according to the fifth, sixth, seventh, or eighth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a signaling flow for communications according to some embodiments of the present disclosure;

FIGS. 4A-4C illustrates schematic diagrams of offsets for TRP according to some embodiments of the present disclosure, respectively;

FIG. 5 is a flowchart of an example method in accordance with an embodiment of the present disclosure;

FIG. 6 is a flowchart of an example method in accordance with an embodiment of the present disclosure;

FIG. 7 is a flowchart of an example method in accordance with an embodiment of the present disclosure;

FIG. 8 is a flowchart of an example method in accordance with an embodiment of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (910 MHz to 7125 MHz), FR2 (24.25 GHz to 71 GHz), FR2-2 (52.6 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, CSI enhancement is worth studying. According to some solutions, the enhancements of CSI acquisition for Coherent-joint transmission (CJT) targeting FR1 and up to 4 TRPs, assuming ideal backhaul and synchronization as well as the same number of antenna ports across TRPs, are specified as follows: Release (Rel)-16/17 Type-II codebook refinement for CJT mTRP targeting FDD and its associated CSI reporting, taking into account throughput-overhead trade-off; sounding reference signal (SRS) enhancement to manage inter-transmission reception point (TRP) cross-SRS interference targeting time domain division (TDD) CJT via SRS capacity enhancement and/or interference randomization, with the constraints that 1) without consuming additional resources for SRS; 2) reuse existing SRS comb structure; 3) without new SRS root sequences. It is noted that the maximum number of CSI-RS ports per resource remains the same as in Rel-17, i.e. 32.

According to some solutions, on the Type-II codebook refinement for CJT mTRP, the selection of N CSI-RS resources is performed by UE and the reported as a part of CSI report, where N is in a range from 1 to N_{TRP}. N represents the number of cooperating CSI-RS resources while N_{TRP} is the maximum number of cooperating CSI-RS resources configured by gNB via higher-layer signaling. The selection of N out of N_{TRP} CSI-RS resources is reported via N_{TRP}-bit bitmap in CSI part 1. A restricted configuration (gNB-configured via higher-layer signaling) where N=N_{TRP} is supposed. N_{TRP}-bit bitmap is not reported when the restriction is configured.

In addition, according to some solutions, on the type-II codebook refinement for CJT mTRP, regarding the spatial domain (SD) basis selection, for a configured value of N_{TRP}, a set of N_{L} combinations, of values for {L₁, . . . , L_{NTRP}} is gNB-configured via higher layer (for example, radio resource control (RRC)) signaling. When N_{L}>1, the selected combination of values for {L₁, . . . , L_{NTRP}} is reported in CSI part 1 using an indication, selected from the N_{L} configured combinations. The SD basis selection for the n-th (n=1, . . . , N) selected CSI-RS resource is indicted in CSI part 2 using a combinatorial indicator selected from a set of

$$( \begin{matrix}{P}_{CSI - RS} / 2 \\ \text{?}\end{matrix} )$$

$$\text{?} \text{indicates text missing or illegible when filed}$$

codepoints where, for Rel-16-based refinement P_{CSI-RS}=2*N₁N₂. The supported candidate values for each of the Lₜ parameters include the conventional candidate value, i.e., {2, 4, 6} for Rel-16-based refinement, and for Rel-17-based refinement, the gNB configures a set of N_L combinations for {alpha₁, . . . , alpha_{NTRP}}, Lₜ=αₜP_{CSI-RS}/2 where αₜ={½, ¾, 1}. In some embodiments, P_{CSI-RS} may be the number of antenna ports for one CSI-RS in the plurality of CSI-RS resources or in the second plurality of CSI-RS resources. In some embodiments, P_{CSI-RS} may be same as P.

In some solutions, on the Type-II codebook refinement for CJT mTRP, for codebook mode-1 or for the first mode of codebook structure, at least one of the following embodiments may be selected. In some embodiments, the use of per-CSI-RS-resource frequency domain (FD) basis selection offset (relative to a reference CSI-RS resource) for independent FD basis selection across N CSI-RS resources, example formulation:

$${W}_{f , n} = diag ( [ 1 e \text{?} … , e \text{?} ] ) {W}_{f}$$

$$\text{?} \text{indicates text missing or illegible when filed}$$

where φₙ is the FD basis selection offset for CSI-RS resource n relative to a reference CSI-RS resource ñ with φ_{ñ}=0. and W_{f} is commonly selected across N CSI-RS resources. In some embodiments, W_{f,n} independently selected across N CSI-RS resources (without any per-CSI-RS-resource FD basis selection offset). In some embodiments, the use of per-CSI-RS-resource FD basis selection offset (relative to a reference CSI-RS resource) for independent FD basis selection across N CSI-RS resources, example formulation:

$${W}_{f , n} = diag [ 1 e \text{?} … , e \text{?} ] ) {\tilde{W}}_{f , n} ,$$

$$\text{?} \text{indicates text missing or illegible when filed}$$

where φₙ is the FD basis selection offset for CSI-RS resource n relative to a reference CSI-RS resource ñ with φ_{ñ}=0, and \tilde{W}_{f,n} is commonly selected across N CSI-RS resources. In some other solutions, on the Type-II codebook refinement for CJT mTRP, regarding the codebook parameter pᵥ, it may support the additional value of pᵥ=½ for v=1, 2, 3, 4 with the following condition: only to be used in combination with other parameter value(s) to limit the increase in precoding matrix indicator (PMI) overhead comparable to the maximum overhead of the Rel-16/17 Type-II codebooks.

Moreover, it proposes CSI enhancement for CJT, bitmap to indicate TRP selection, and multiple combinations of Lt for TRPs can be configured. Therefore, the relationship between combination of Lt and bitmap for TRP selection needs to be studied. For example, considering CSI payload, UE complexity, relationship between combination of Lt and β, pᵥ needs to be studied. In addition, for Rel-17 codebook, based on reciprocity, the network can obtain delay/angle information (SD-FD basis), the FD window size (FD_s) can be reduced, and starting from the first FD basis (all ones vector), while in case of multi-TRP CJT, network may not know the delay difference between different TRPs (i.e. the FD basis offset with large range is needed), or network may not obtain the accurate delay difference (i.e. for other TRPs, the FD basis offset with small range is needed). Reference TRP for SCI and for lowest delay may be different. Thus, FD basis selection also needs to be improved.

Embodiments of the present disclosure provide a solution on CSI. According to embodiments of the present disclosure, a network device transmits, to a terminal device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report. Each value in a combination of values for first vector corresponds to one of the plurality of CSI-RS resources. The terminal device determines a first combination from the set of combinations of values for first vector, a first value from the set of values for second vector and a second value from the set of values for the first parameter based on at least a set of CSI-RS resources from the plurality of CSI-RS resources and transmits the CSI report based on the determination. In this way, the relationship between combination of Lt and bitmap can be optimized.

Principles and implementations of the present disclosure will be described in detail below with reference to the figures.

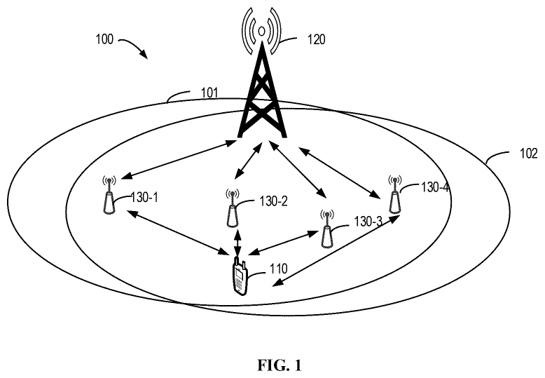

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 102 to serve one or more terminal devices. In this example, the terminal device 110 is located in the cell 102 and is served by the network device 120.

For example, the network device 120 may be configured with at least one of four TRPs/panels 130-1, 130-2, 130-3 and 130-4 (collectively referred to as TRPs 130 or individually referred to as TRP 130). It is to be understood that the number of network devices, terminal devices and TRPs as shown in FIG. 1 is only for the purpose of illustration without suggesting any limitations to the present disclosure. The network 100 may include any suitable number of devices adapted for implementing embodiments of the present disclosure. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As shown in FIG. 1, the network device 120 may communicate with the terminal device 110 via at least one of the TRPs 130-1, 130-2, 130-3 and 130-4. In the following text, the TRP 130-1 may be also referred to as the first TRP, the TRP 130-2 may be also referred to as the second TRP, the TRP 130-3 may be also referred to as the third TRP and the TRP 130-4 may be also referred to as the fourth TRP. Each of the TRPs 130 may provide a plurality of beams for communication with the terminal device 110. It is noted that the number of TRPs shown in FIG. 1 is only an example not limitation.

In some embodiments, the first TRP and/or the second TRP and/or the third TRP and/or the fourth TRP may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 130 and the terminal device 110. When the terminal device 110 receives two DCIs in two CORESETs which are associated with different higher-layer configured identities, the two DCIs are indicated from different TRPs. Further, the first and second TRPs 130 may be implicitly identified by a dedicated configuration to the physical channels or signals. For example, a dedicated CORESET, a RS, and a TCI state, which are associated with a TRP, are used to identify a transmission from a different TRP to the terminal device 110. For example, when the terminal device 110 receives a DCI from a dedicated CORESET, the DCI is indicated from the associated TRP dedicated by the CORESET.

In some embodiments, before transmitting data (such as, via the TRP 130-1 and/or 130-2 and/or 130-3 and/or 130-4) to the terminal device 110, the network device 120 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information are not limited to the ones as listed above. Embodiments of the present disclosure may equally applicable to control information including any transmission parameters.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17” “tci_Stateld_r17”, “TCI_state_r17 indicating a unified TCI state”, “TCI state shared/applied for all or subset of CORESETs and UE-dedicated reception on PDSCH”, “Rel-17 TCI state”, “TCI state with tci_StateId_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably.

In the context of the present application, the terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably.

In the context of the present application, the terms “precoding matrix”, “precoding”, “beam”, “beamforming”, “vector”, “first vector”, “first basis”, “first basis vector” and “precoder” may be used interchangeably. The terms “vector”, “bases” and “basis” can be used interchangeably.

In the context of the present application, the terms “single TRP”, “single TCI state”, “single TCI”, “S-TCI”, “single CORESET”, “single control resource set pool”, “S-TRP” and “S-TCI state” can be used interchangeably.

In the context of the present application, the terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

In the context of the present application, the terms “pool”, “set”, “subset”, “group”, “unit” and “subgroup” can be used interchangeably.

In the context of the present application, the terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field”, “bitwidth” and “field size” can be used interchangeably.

In the context of the present application, the terms “first vector”, “first beam”, “beam”, “first bases”, “first basis vector”, “spatial domain/SD basis vector”, “spatial domain/SD vectors”, “spatial domain/SD basis”, “spatial domain/SD bases”, “spatial domain/SD basis vectors corresponding to a TRP index”, “spatial domain/SD vectors corresponding to a TRP index”, “spatial domain/SD basis corresponding to a TRP index”, “spatial domain/SD bases corresponding to a TRP index”, “first basis corresponding to a TRP index” and “first basis” can be used interchangeably.

In the context of the present application, the terms “second vector”, “second basis”, “frequency domain/FD basis vector”, “frequency domain/FD vector”, “frequency domain/FD basis”, “frequency domain/FD bases”, “second bases”, “second vector corresponding to a TRP index”, “second bases corresponding to a TRP index”, “frequency domain/FD basis vectors corresponding to a TRP index”, “frequency domain/FD vectors corresponding to a TRP index”, “frequency domain/FD basis corresponding to a TRP index”, “frequency domain/FD bases corresponding to a TRP index” and “second basis corresponding to a TRP index” can be used interchangeably.

In the context of the present application, the terms “third vector”, “third bases”, “doppler domain/DD basis vectors”, “doppler domain/DD vectors”, “doppler domain/DD basis”, “doppler domain/DD bases”, “third basis”, “third vector corresponding to a TRP index”, “third bases corresponding to a TRP index”, “doppler domain/DD basis vectors corresponding to a TRP index”, “doppler domain/DD vectors corresponding to a TRP index”, “doppler domain/DD basis corresponding to a TRP index”, “doppler domain/DD bases corresponding to a TRP index”, and “third basis corresponding to a TRP index” can be used interchangeably. In the context of the present application, the terms “doppler domain”, “time domain”, “TD” and “DD” can be used interchangeably.

In the context of the present application, the terms “a TRP”, “a TRP group”, “a CSI-RS resource” and “a group of CSI-RS ports” can be used interchangeably.

In the context of the present application, the embodiments described for the first vector may be applied for the second vector and/or for the third vector and/or for the FD basis vector or for the SD basis vector or for the DD basis vector. In the context of the present application, the embodiments described for the second vector may be applied for the first vector and/or for the third vector and/or for the FD basis vector or for the SD basis vector or for the DD basis vector.

In the context of the present application, the terms “a TRP index”, “a TRP group index”, “a CSI-RS resource index” and “a group of CSI-RS ports index” can be used interchangeably.

In the context of the present application, the terms “element of indication field”, “parameter” and “indication” can be used interchangeably.

In the context of the present application, the terms “CSI report”, “CSI reporting”, “CSI report setting”, “CSI feedback”, “codebook”, “codebook configuration”, “codebookConfig” and “CSI” can be used interchangeably.

In the context of the present application, the terms “first type of codebook”, “codebook enhancement based on Rel-16 codebook” and “CSI enhancement based on Rel-16 codebook” can be used interchangeably. In the context of the present application, the terms “second type of codebook”, “codebook enhancement based on Rel-17 codebook” and “CSI enhancement based on Rel-17 codebook” can be used interchangeably.

In the context of the present application, the terms “first mode of codebook structure”, “codebook mode 1”, “codebook mode-1”, “first mode”, “mode 1” and “mode-1” can be used interchangeably. In the context of the present application, the terms “second mode of codebook structure”, “codebook mode 2”, “codebook mode-2”, “second mode”, “mode 2” and “mode-2” can be used interchangeably.

The term “Channel State Information (CSI)” used herein may refer to channel properties of a communication link. CSI describes how a signal propagate from the transmitter to the receiver and represents the combined effect of, for example, scattering, fading, and power decay with distance. The term “CSI report” may refer to a report that indicate how good or bad the channel is.

According to some solutions, a UE can be configured with a list of up to T TCI-State configurations within the higher layer parameter PDSCH-Config to decode PDSCH according to a detected PDCCH with DCI intended for the UE and the given serving cell, where T depends on the UE capability maxNumberConfiguredTCIstatesPerCC. Each TCI-State contains parameters for configuring a quasi co-location relationship between one or two downlink reference signals and the DMRS ports of the PDSCH, the DMRS port of PDCCH or the channel state information reference signal (CSI-RS) port(s) of a CSI-RS resource. The quasi co-location relationship is configured by the higher layer parameter qcl-Type1 for the first downlink (DL) RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:

‘QCL-TypeA’: {Doppler shift, Doppler spread,
average delay, delay spread}
‘QCL-TypeB’: {Doppler shift, Doppler spread}
‘QCL-TypeC’: {Doppler shift, average delay }
‘QCL-TypeD’: {Spatial Rx parameter}

In addition to normal data communications, the network device 120 may send a RS P_{GP}-2₄,T₂ to the terminal device 110 in a downlink. Similarly, the terminal device 110 may transmit a RS to the network device 120 in an uplink. Generally speaking, a RS is a signal sequence (also referred to as “RS sequence”) that is known by both the network device 120 and the terminal devices 110. For example, a RS sequence may be generated and transmitted by the network device 120 based on a certain rule and the terminal device 110 may deduce the RS sequence based on the same rule. For another example, a RS sequence maybe generated and transmitted by the terminal device 110 based on a certain rule and the network device 120 may deduce the RS sequence based on the same rule. Examples of the RS may include but are not limited to downlink or uplink Demodulation Reference Signal (DMRS), CSI-RS, Sounding Reference Signal (SRS), Phase Tracking Reference Signal (PTRS), Tracking Reference Signal (TRS), fine time-frequency Tracking Reference Signal (TRS), CSI-RS for tracking, Positioning Reference Signal (PRS) and so on.

In addition to normal data communications, the network device 120 may transmit DCI via a PDCCH to the terminal device 110. The DCI may indicate resource allocation for data transmission in a DL or UL. Concurrently, a DMRS associated with the PDCCH may also be transmitted from the network device 120 to the terminal device 110. The DMRS may be used by the terminal device 110 for channel demodulation. Then, the terminal device 110 may attempt to blindly decode the DCI in a PDCCH in a search space which is associated with a control resource set (CORESET). As used herein, a “CORESET” and/or a search space refers to a set of resource element groups (REGs) within which the terminal device 110 attempts to blindly decode the DCI. A search space indicating the start time and a periodicity for monitoring a PDCCH in the CORESET may be indicated to the terminal device 110. In response to decoding the DCI successfully, the terminal device 110 may perform the UL and/or DL data transmission (for example, data transmission via PDSCH and/or Physical Uplink Shared Channel (PUSCH)) with the network device 120 accordingly.

The network device 120 may communicate data and control information to the terminal device 110 via a plurality of beams (also referred to as “DL beams”). The terminal device 110 may also communicate data and control information to the network device 120 via a plurality of beams (also referred to as “UL beams”). In 3GPP specifications for new radio (NR), a beam is also defined and indicated by parameters of a transmission configuration indicator. For example, there may be a transmission configuration indication (TCI) field in DCI. A value of the TCI field may be referred to as a “TCI codepoint”. A TCI codepoint may indicate one or more TCI states. Each TCI state contains parameters for configuring a quasi co-location (QCL) relationship between one or two DL and/or UL reference signals and the DMRS ports of the PDSCH, the DMRS ports of PDCCH, the DMRS ports of PUSCH, the DMRS ports of PUCCH, the SRS ports of a SRS resource or the CSI-RS ports of a CSI-RS resource.

In some embodiments, for the CSI report described according to some embodiments in this disclosure, there may be a first type of codebook and a second type of codebook. In some embodiments, for the first type of codebook, the enhancements may be based on Rel-16 codebook or based on enhanced Type II codebook. In some embodiments, for the second type of codebook, the enhancements may be based on Rel-17 port selection codebook or based on further enhanced Type II port selection codebook. In some embodiments, the terminal device 110 may be configured with at least one of the first type of codebook and the second type of codebook. For example, through RRC signalling.

In some embodiments, for the CSI report described according to some embodiments in this disclosure, there may be a first mode of codebook structure and a second mode of codebook structure. In some embodiments, the terminal device 110 may be configured with at least one of the first mode of codebook structure and the second mode of codebook structure. For example, through RRC signalling.

In some embodiments, the terminal device 110 may be configured with the first type of codebook and the first mode of codebook structure. In some embodiments, the terminal device 110 may be configured with the first type of codebook and the second mode of codebook structure. In some embodiments, the terminal device 110 may be configured with the second type of codebook and the first mode of codebook structure. In some embodiments, the terminal device 110 may be configured with the second type of codebook and the second mode of codebook structure.

In some embodiments, if the terminal device 110 is configured with the first mode of codebook structure and/or configured with the second mode of codebook structure and/or configured with first type of codebook and/or configured with second type of codebook, the number of first vectors for each CSI-RS resource in the plurality of CSI-RS resources or in the second plurality of CSI-RS resources may be same or different or independent. In some embodiments, if the terminal device 110 is configured with the first mode of codebook structure and/or configured with the second mode of codebook structure and/or configured with first type of codebook and/or configured with second type of codebook, the first vectors for each CSI-RS resource in the plurality of CSI-RS resources or in the second plurality of CSI-RS resources may be independent or different.

In some embodiments, if the terminal device 110 is configured with the first mode of codebook structure, the terminal device 110 may determine or select a number of first vectors corresponding to each CSI-RS resource in the plurality of CSI-RS resources or in the second plurality of CSI-RS resources, and the terminal device 110 may determine or select a number of second vectors corresponding to each CSI-RS resource in the plurality of CSI-RS resources or in the second plurality of CSI-RS resources. In some embodiments, if the terminal device 110 is configured with the first mode of codebook structure, the terminal device 110 may determine or select independent second vectors across CSI-RS resources in the plurality of CSI-RS resources or in the second plurality of CSI-RS resources. In some embodiments, if the terminal device 110 is configured with the first mode of codebook structure, the second vectors for each CSI-RS resource in the plurality of CSI-RS resources or in the second plurality of CSI-RS resources may be different or independent.

In some embodiments, if the terminal device 110 is configured with the first mode of codebook structure, the terminal device 110 may determine or select M_{υ} second vectors for each CSI-RS resource in the plurality of CSI-RS resources or in the second plurality of CSI-RS resources. For example, the terminal device 110 may be configured with the first type of codebook. In some embodiments, the number of second vectors M_{υ} for each CSI-RS resource in the plurality of CSI-RS resources or in the second plurality of CSI-RS resources may be same. In some embodiments, the value of M_{υ} may be positive integer. For example, 2≤M_{υ}≤36. For another example, 1≤M_{υ}≤38. For another example, 1≤M_{υ}≤36. In some embodiments, the total number of second vectors for the CSI report may be M_{υ}*N_{TRP} or M_{υ}*N.

In some embodiments, if the terminal device 110 is configured with the first mode of codebook structure, the terminal device 110 may determine or select M second vectors for each CSI-RS resource in the plurality of CSI-RS resources or in the second plurality of CSI-RS resources. For example, the terminal device 110 may be configured with the second type of codebook. In some embodiments, the number of second vectors M for each CSI-RS resource in the plurality of CSI-RS resources or in the second plurality of CSI-RS resources may be same. In some embodiments, the value of M may be positive integer. For example, M may be 1 or 2. For another example, M may be 1, if the number of CSI-RS resources in the second plurality of CSI-RS resources is larger than 1 or larger than 2. In some embodiments, the total number of second vectors for the CSI report may be M*N_{TRP} or M*N.

In some embodiments, if the terminal device 110 is configured with the first mode of codebook structure, the first vectors and/or the second vectors selection may be per CSI-RS resource or per TRP or per TRP group, the first mode of codebook structure may allow independent second vectors selection across CSI-RS resources or across TRPs or across TRP groups.

In some embodiments, an example formulation for the first mode of codebook structure may be:

$$[ \begin{matrix}{W}_{1 , 1} {\tilde{W}}_{2 , 1} {W}_{f , 1}^{H} \\ ⋮ \\ {W}_{1 , N} {\tilde{W}}_{2 , N} {W}_{f , N}^{H}\end{matrix} ] or \\ [ \begin{matrix}{W}_{1 , 1} {\tilde{W}}_{2 , 1} {W}_{f , 1}^{H} \\ ⋮ \\ {W}_{1 , {N}_{TRP}} {\tilde{W}}_{2 , {N}_{TRP}} {W}_{f , {N}_{TRP}}^{H}\end{matrix} ] .$$

In some embodiments, if the terminal device 110 is configured with the second mode of codebook structure, the terminal device 110 may determine or select a number of first vectors corresponding to each CSI-RS resource in the plurality of CSI-RS resources or in the second plurality of CSI-RS resources, and the terminal device 110 may determine or select a number of same second vectors corresponding to each CSI-RS resource in the plurality of CSI-RS resources or in the second plurality of CSI-RS resources. In some embodiments, if the terminal device 110 is configured with the second mode of codebook structure, the terminal device 110 may determine or select same or common second vectors across CSI-RS resources in the plurality of CSI-RS resources or in the second plurality of CSI-RS resources. In some embodiments, if the terminal device 110 is configured with the second mode of codebook structure, the terminal device 110 may determine or select same or common second vectors across CSI-RS resources in the plurality of CSI-RS resources or in the second plurality of CSI-RS resources. In some embodiments, if the terminal device 110 is configured with the second mode of codebook structure, the second vectors for each CSI-RS resource in the plurality of CSI-RS resources or in the second plurality of CSI-RS resources may be same or common.

In some embodiments, if the terminal device 110 is configured with the second mode of codebook structure, the terminal device 110 may determine or select M_{υ} second vectors for all CSI-RS resources in the plurality of CSI-RS resources or in the second plurality of CSI-RS resources. In some embodiments, if the terminal device 110 is configured with the second mode of codebook structure, the determined or selected M_{υ} second vectors may be common or same for each one of the plurality of CSI-RS resources or for each one of the second plurality of CSI-RS resources. For example, the terminal device 110 may be configured with the first type of codebook. In some embodiments, the number of second vectors M_{υ} for each one of the plurality of CSI-RS resources or each one of the second plurality of CSI-RS resources may be same. In some embodiments, the value of M_{υ} may be positive integer. For example, 2≤M_{υ}≤36. For another example, 1≤M_{υ}≤38. For another example, 1≤M_{υ}≤36. In some embodiments, the total number of second vectors for the CSI report may be M_{υ}.

In some embodiments, if the terminal device 110 is configured with the second mode of codebook structure, the terminal device 110 may determine or select M second vectors for for all CSI-RS resources in the plurality of CSI-RS resources or in the second plurality of CSI-RS resources. In some embodiments, if the terminal device 110 is configured with the second mode of codebook structure, the determined or selected M second vectors may be common or same for each one of the plurality of CSI-RS resources or for each one of the second plurality of CSI-RS resources. For example, the terminal device 110 may be configured with the second type of codebook. In some embodiments, the number of second vectors M for each one of the plurality of CSI-RS resources or each one of the second plurality of CSI-RS resources may be same. In some embodiments, the value of M may be positive integer. For example, M may be 1 or 2. For another example, M may be 1, if the number of CSI-RS resources in the second plurality of CSI-RS resources is larger than 1 or larger than 2. In some embodiments, the total number of second vectors for the CSI report may be M.

In some embodiments, if the terminal device 110 is configured with the second mode of codebook structure, the first vectors and/or the second vectors selection may be same or common for each CSI-RS resource or for each TRP or for each TRP group or for all CSI-RS resources or for all TRPs or for all TRP groups. For example, the second mode of codebook structure may determine or select common or joint second vectors across CSI-RS resources or across TRPs or across TRP groups.

In some embodiments, an example formulation for the second mode of codebook structure may be:

$$[ \begin{matrix}{W}_{1 , 1} {\tilde{W}}_{2 , 1} {W}_{f}^{H} \\ ⋮ \\ {W}_{1 , N} {\tilde{W}}_{2 , N} {W}_{f}^{H}\end{matrix} ] or \\ [ \begin{matrix}{W}_{1 , 1} {\tilde{W}}_{2 , 1} {W}_{f}^{H} \\ ⋮ \\ {W}_{1 , {N}_{TRP}} {\tilde{W}}_{2 , {N}_{TRP}} {W}_{f}^{H}\end{matrix} ] .$$

In some embodiments, W_{1,t} may be a matrix comprising the first vectors corresponding to the t-th CSI-RS resource in the plurality of CSI-RS resources or corresponding to the t-th selected CSI-RS resource in the second plurality of CSI-RS resources. In some embodiments,

$${W}_{1 , t} = [ \begin{matrix}{B}_{t} & 0 \\ 0 & {B}_{t}\end{matrix} ] ,$$

wherein

$${B}_{t} = {v}_{{m}_{1}^{( 0 , t )} , {m}_{2}^{( 0 , t )}} {v}_{{m}_{1}^{( 1 , t )} , {m}_{2}^{( 1 , t )}} … {v}_{{m}_{1}^{( {L}_{t} - 1 , t )} , {m}_{2}^{( {L}_{t} - 1 , t )}} .$$

For example, size of W_{1,t} may be (2*N₁*N₂)*(2*Lₜ). For example, there may be 2*N₁*N₂ rows and 2*Lₜ columns in W_{1,t}. For example, a size of Bₜ and “0” in W_{1,t} may be (N₁*N₂)*Lₜ. For example, N₁*N₂ rows and Lₜ columns. For example, “0” in W_{1,t} may be a zero matrix with size (N₁*N₂)*Lₜ. For example, N₁*N₂ rows and Lₜ columns.

In some embodiments,

$${W}_{1 , t} = [ \begin{matrix}{v}_{{m}_{1}^{( 0 , t )} , {m}_{2}^{( 0 , t )}} {v}_{{m}_{1}^{( 1 , t )} , {m}_{2}^{( 1 , t )}} … {v}_{{m}_{1}^{( {L}_{t} - 1 , t )} , {m}_{2}^{( {L}_{t} - 1 , t )}} & 0 \\ 0 & {v}_{{m}_{1}^{( 0 , t )} , {m}_{2}^{( 0 , t )}} {v}_{{m}_{1}^{( 1 , t )} , {m}_{2}^{( 1 , t )}} … {v}_{{m}_{1}^{( {L}_{t} - 1 , t )} , {m}_{2}^{( {L}_{t} - 1 , t )}}\end{matrix} ] .$$

In some embodiments,

$${v}_{{m}_{1}^{( i , t )} , {m}_{2}^{( i , t )}}$$

may be the (i+1)-th first vector of the first vectors corresponding to the t-th CSI-RS resource in the plurality of CSI-RS resources or corresponding to the t-th selected CSI-RS resource in the second plurality of CSI-RS resources. In some embodiments, i may be a non-negative integer. For example, 0≤i≤Lₜ−1. In some embodiments, Lₜ may be the number of first vectors corresponding to the t-th CSI-RS resource in the plurality of CSI-RS resources or corresponding to the t-th selected CSI-RS resource in the second plurality of CSI-RS resources. In some embodiments, Lₜ may be a positive integer or a non-negative integer. For example, 0≤Lₜ≤6. For example, Lₜ may be at least one of {0, 2, 4, 6} or at least one of {2,4,6}. In some embodiments, Lₜ may be the value corresponding to the selected one of the set of combinations of values for first vector and/or corresponding to t-th CSI-RS resource in the plurality of CSI-RS resources and/or corresponding to the t-th selected CSI-RS resource in the second plurality of CSI-RS resources.

In some embodiments, there may be a vector uₘ_{₂}. In some embodiments, uₘ_{₂} may be a DFT vector. In some embodiments, if N₂>1,

$${u}_{{m}_{2}} = [ 1 , {e}^{j \frac{2 π {m}_{2}}{{O}_{2} {N}_{2}}} , … , {e}^{j \frac{2 π {m}_{2} ( {N}_{2} - 1 )}{{O}_{2} {N}_{2}}} ] .$$

In some embodiments, if N₂=2,

$${u}_{{m}_{2}} = [ 1 , {e}^{j \frac{2 π {m}_{2}}{{O}_{2} {N}_{2}}} ] .$$

In some embodiments, if N₂=1, uₘ_{₂}=1. In some embodiments, m₂ may be a non-negative integer. For example, 0≤m₂≤2N₂−1. In some embodiments, there may be a vector Vₘ_{₁}ₘ_{₂}. In some embodiments,

$${v}_{{m}_{1} , {m}_{2}} = {[ {u}_{{m}_{2}} , {u}_{{m}_{2}} * {e}^{j \frac{2 π {m}_{1}}{{O}_{1} {N}_{1}}} , … , {u}_{{m}_{2}} * {e}^{j \frac{2 π {m}_{1} ( {N}_{1} - 1 )}{{O}_{1} {N}_{1}}} ]}^{T} .$$

In some embodiments, if N₁=2 and N₂=2,

$${v}_{{m}_{1} , {m}_{2}} = {[ 1 , {e}^{j \frac{2 π {m}_{2}}{{O}_{2} {N}_{2}}} , {e}^{j \frac{2 π {m}_{1}}{{O}_{1} {N}_{1}}} , {e}^{j \frac{2 π {m}_{2}}{{O}_{2} {N}_{2}}} * {e}^{j \frac{2 π {m}_{1}}{{O}_{1} {N}_{1}}} ]}^{T} .$$

In some embodiments, if N₁=4 and N₂=1,

$${v}_{{m}_{1} , {m}_{2}} = {[ 1 , {e}^{j \frac{2 π {m}_{1}}{{O}_{1} {N}_{1}}} , {e}^{j \frac{2 π {m}_{1} * 2}{{O}_{1} {N}_{1}}} , {e}^{j \frac{2 π {m}_{1} * 3}{{O}_{1} {N}_{1}}} ]}^{T} .$$

In some embodiments, m₁ may be a non-negative integer. For example, 0 m₁≤O₁N₁−1. In some embodiments, [ ]^{T} may represent a transposition of a vector or a matrix.

In some embodiments, \tilde{W}_{2,t} may be a matrix comprising at least one of the first amplitude coefficients, the second amplitude coefficients, the third amplitude coefficients, the phase coefficients corresponding to the t-th CSI-RS resource in the plurality of CSI-RS resources or corresponding to the t-th selected CSI-RS resource in the second plurality of CSI-RS resources.

In some embodiments, for \tilde{W}_{2,t} corresponding to layer with index r:

$${\tilde{W}}_{2 , t} = {P}_{t}^{( 3 )} [ \begin{matrix}{P}_{r , 0}^{( 1 )} * {P}_{r , 0 , 0 , 0}^{( 2 )} * {φ}_{r , 0 , 0 , 0}^{( 2 )} & {P}_{r , 0}^{( 1 )} * {P}_{r , 0 , 0 , 1}^{( 2 )} * {φ}_{r , 0 , 0 , 1}^{( 2 )} & & {P}_{r , 0}^{( 1 )} * {P}_{r , 0 , 0 , {M}_{v} - 1}^{( 2 )} * {φ}_{r , 0 , 0 , {M}_{v} - 1}^{( 2 )} \\ {P}_{r , 0}^{( 1 )} * {P}_{r , 1 , 0 , 0}^{( 2 )} * {φ}_{r , 1 , 0 , 0}^{( 2 )} & {P}_{r , 0}^{( 1 )} * {P}_{r , 1 , 0 , 1}^{( 2 )} * {φ}_{r , 1 , 0 , 1}^{( 2 )} & & {P}_{r , 0}^{( 1 )} * {P}_{r , 1 , 0 , {M}_{v} - 1}^{( 2 )} * {φ}_{r , 1 , 0 , {M}_{v} - 1}^{( 2 )} \\ ⋮ & ⋮ & & ⋮ \\ {P}_{r , 0}^{( 1 )} * {P}_{r , {L}_{t} - 1 , 0 , 0}^{( 2 )} * {φ}_{r , {L}_{t} - 1 , 0 , 0}^{( 2 )} & {P}_{r , 0}^{( 1 )} * {P}_{r , {L}_{t} - 1 , 0 , 1}^{( 2 )} * {φ}_{r , {L}_{t} - 1 , 0 , 1}^{( 2 )} & … & {P}_{r , 0}^{( 1 )} * {P}_{r , {L}_{t} - 1 , 0 , {M}_{v} - 1}^{( 2 )} * {φ}_{r , {L}_{t} - 1 , 0 , {M}_{v} - 1}^{( 2 )} \\ {P}_{r , 1}^{( 1 )} * {P}_{r , 0 , 1 , 0}^{( 2 )} * {φ}_{r , 0 , 1 , 0}^{( 2 )} & {P}_{r , 1}^{( 1 )} * {P}_{r , 0 , 1 , 1}^{( 2 )} * {φ}_{r , 0 , 1 , 1}^{( 2 )} & & {P}_{r , 1}^{( 1 )} * {P}_{r , 0 , 1 , {M}_{v} - 1}^{( 2 )} * {φ}_{r , 0 , 1 , {M}_{v} - 1}^{( 2 )} \\ {P}_{r , 1}^{( 1 )} * {P}_{r , 1 , 1 , 0}^{( 2 )} * {φ}_{r , 1 , 1 , 0}^{( 2 )} & {P}_{r , 1}^{( 1 )} * {P}_{r , 1 , 1 , 1}^{( 2 )} * {φ}_{r , 1 , 1 , 1}^{( 2 )} & & {P}_{r , 1}^{( 1 )} * {P}_{r , 1 , 1 , {M}_{v} - 1}^{( 2 )} * {φ}_{r , 1 , 1 , {M}_{v} - 1}^{( 2 )} \\ ⋮ & ⋮ & & ⋮ \\ {P}_{r , 1}^{( 1 )} * {P}_{r , {L}_{t} - 1 , 1 , 0}^{( 2 )} * {φ}_{r , {L}_{t} - 1 , 1 , 0}^{( 2 )} & {P}_{r , 1}^{( 1 )} * {P}_{r , {L}_{t} - 1 , 1 , 1}^{( 2 )} * {φ}_{r , {L}_{t} - 1 , 1 , 1}^{( 2 )} & & {P}_{r , 1}^{( 1 )} * {P}_{r , {L}_{t} - 1 , 1 , {M}_{v} - 1}^{( 2 )} * {φ}_{r , {L}_{t} - 1 , 1 , {M}_{v} - 1}^{( 2 )}\end{matrix} ] .$$

In some embodiments, f may be an index of one second vector. For example, f=0, 1, . . . Mᵥ−1.

In some embodiments,

$${P}_{r , s , t}^{( 1 )}$$

may be the first amplitude coefficient corresponding to layer with index r and corresponding to the t-th CSI-RS resource in the plurality of CSI-RS resources or corresponding to the t-th selected CSI-RS resource in the second plurality of CSI-RS resources. In some embodiments,

$${P}_{r , s , t}^{( 1 )}$$

may not be needed. In some embodiments,

$${P}_{r , s , t}^{( 1 )}$$

may be fixed to be 1.

In some embodiments,

$${P}_{r , i , s , f , t}^{( 2 )}$$

may be second amplitude coefficient corresponding to the layer with index r and corresponding to one first vector with index i and corresponding to second vector with index f and corresponding to the t-th CSI-RS resource in the plurality of CSI-RS resources or corresponding to the t-th selected CSI-RS resource in the second plurality of CSI-RS resources.

In some embodiments,

$${P}_{t}^{( 3 )}$$

may be first amplitude coefficient corresponding to the t-th CSI-RS resource in the plurality of CSI-RS resources or corresponding to the t-th selected CSI-RS resource in the second plurality of CSI-RS resources and/or corresponding to the layer with index r. In some embodiments,

$${P}_{t}^{( 3 )}$$

may not be needed. In some embodiments,

$${P}_{t}^{( 3 )}$$

may be fixed to be 1. In some embodiments,

$${P}_{t}^{( 3 )}$$

may be same for different layers.

In some embodiments,

$${φ}_{r , i , s , f , t}^{( 2 )}$$

may be phase coefficient corresponding to the layer with index r and corresponding to a first vector with index i and corresponding to second vector with index f and corresponding to the t-th CSI-RS resource in the plurality of CSI-RS resources or corresponding to the t-th selected CSI-RS resource in the second plurality of CSI-RS resources.

In some embodiments,

$${φ}_{r , i , f , t}^{( 2 )}$$

(For example, i may be non-negative integer. For example, 0≤i≤Lₜ−1) may be phase coefficient corresponding to the layer with index r and corresponding to a first vector with index i and corresponding to second vector with index f and corresponding to the t-th CSI-RS resource in the plurality of CSI-RS resources or corresponding to the t-th selected CSI-RS resource in the second plurality of CSI-RS resources. In some embodiments,

$${φ}_{r , i + {L}_{t} , f , t}^{( 2 )}$$

(For example, i may be non-negative integer. For example, 0≤i≤Lₜ−1) may be phase coefficient corresponding to the layer with index r and corresponding to a first vector with index i+Lₜ and corresponding to second vector with index f and corresponding to the t-th CSI-RS resource in the plurality of CSI-RS resources or corresponding to the t-th selected CSI-RS resource in the second plurality of CSI-RS resources.

In some embodiments,

$${P}_{r , i , f , t}^{( 2 )}$$

(For example, i may be non-negative integer. For example, 0≤i≤Lₜ−1) may be second amplitude coefficient corresponding to the layer with index r and corresponding to one first vector with index i and corresponding to second vector with index f and corresponding to the t-th CSI-RS resource in the plurality of CSI-RS resources or corresponding to the t-th selected CSI-RS resource in the second plurality of CSI-RS resources. In some embodiments,

$${P}_{r , i + {L}_{t} , f , t}^{( 2 )}$$

(For example, i may be non-negative integer. For example, 0≤i≤Lₜ−1) may be second amplitude coefficient corresponding to the layer with index r and corresponding to one first vector with index i+Lₜ and corresponding to second vector with index f and corresponding to the t-th CSI-RS resource in the plurality of CSI-RS resources or corresponding to the t-th selected CSI-RS resource in the second plurality of CSI-RS resources.

In some embodiments, s may be 0 and/or 1. For example, s may be for two polarizations. In some embodiments, s may be for different groups of first vectors.

In some embodiments, a value of one phase coefficient may be e^{j2π·c}^{ₚ}^{/N}^{_{PSK}}. In some embodiments, cₚ may be a value of one indicator or one field for the phase coefficient. In some embodiments, cₚ may be a non-negative integer. In some embodiments, cₚ may be at least one of {0,1,2,3} or {0,1,2,3,4,5,6,7} or {0,1,2,3,4,5,6,7,8,9,10,11,12,13,14,15}. In some embodiments, N_{PSK} may be the size for indication of cₚ. In some embodiments, N_{PSK} may be a positive integer. In some embodiments, N_{PSK} may be at least one of {2, 4, 8, 16}.

In some embodiments, a value of one first amplitude coefficient may be at least one of reserved or 0,

$$\frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} or \\ \{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, a value of one second amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, a value of one first amplitude coefficient may be at least one of

$$\{ 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} 1 \} or$$

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} 1 \} or$$

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} or \\ \{ 0 , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} or \\ \{ \frac{1}{\sqrt{2}} , 1 \} or \{ \frac{1}{2 \sqrt{2}} , \frac{1}{2} , \frac{1}{\sqrt{2}} , 1 \} .$$

In some embodiments,

$${W}_{f , t}^{H}$$

may be a matrix comprising the second vectors corresponding to thet-th CSI-RS resource in the plurality of CSI-RS resources or corresponding to the t-th selected CSI-RS resource in the second plurality of CSI-RS resources. For example, the terminal device 110 is configured with the first mode of codebook structure. In some embodiments, t may a positive integer. For example, 1≤t≤N_{TRP}. For another example, 1≤t≤N. In some embodiments,

$${W}_{f}^{H}$$

may be a matrix comprising the second vectors corresponding to all or each one of CSI-RS resource in the plurality of CSI-RS resources or corresponding to all or each one of CSI-RS resource in the second plurality of CSI-RS resources. For example, the terminal device 110 is configured with the second mode of codebook structure. In some embodiments, [ ]^{H} may represent a conjugate transpose or conjugate transposition of a vector or a matrix.

In some embodiments, for second vectors (e.g. represented as W_{f} or

$${W}_{f}^{H} or {W}_{f , t}^{H} )$$

corresponding to layer with index r and corresponding to the t-th CSI-RS resource in the plurality of CSI-RS resources or corresponding to the t-th selected CSI-RS resource in the second plurality of CSI-RS resources,

$${W}_{f} or {W}_{f}^{H} or {W}_{f , t}^{H} = {[ {F}_{{n}_{3 , r}^{( 0 )}} {F}_{{n}_{3 , r}^{( 1 )}} … {F}_{{n}_{3 , r}^{( {M}_{v} - 1 )}} ]}^{T} .$$

In some embodiments, the size of W_{f} or

$${W}_{f}^{H} or {W}_{f , t}^{H}$$

may be Mᵥ*N₃.

In some embodiments,

$${n}_{3 , r}^{( f )} ∈ \{ 0 , 1 , … , {N}_{3} - 1 \} .$$

In some embodiments,

$${n}_{3 , r , t}^{( f )} ∈ \{ 0 , 1 , … , {N}_{3} - 1 \} .$$

corresponding to layer with index r and corresponding to the t-th CSI-RS resource in the plurality of CSI-RS resources or corresponding to the t-th selected CSI-RS resource in the second plurality of CSI-RS resources. In some embodiments,

$${n}_{3 , t}^{( f )} ∈ \{ 0 , 1 , … , {N}_{3} - 1 \}$$

corresponding to the t-th CSI-RS resource in the plurality of CSI-RS resources or corresponding to the t-th selected CSI-RS resource in the second plurality of CSI-RS resources. For example, common or same for different layers.

In some embodiments,

$${F}_{{n}_{3 , r}^{( f )}} = {[ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} & … & {e}^{j \frac{2 π * ( {N}_{3} - 1 ) * {n}_{3 , r}^{( f )}}{{N}_{3}}}\end{matrix} ]}^{T} .$$

In some embodiments, for the first type of codebook and/or for the second type of codebook and/or first mode of codebook structure corresponding to layer with index r, the precoding matrix with index z may be

$${W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r , 1}^{( f )} {P}_{r , i , 0 , f , 1}^{( 2 )} {φ}_{r , i , 0 , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 0 , N}^{( 1 )} {\sum }_{f = 0}^{{M}_{v} - 1} {y}_{z , r , N}^{( f )} {P}_{r , i , 0 , f , N}^{( 2 )} {φ}_{r , i , 0 , f , N}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r , 1}^{( f )} {P}_{r , i , 1 , f , 1}^{( 2 )} {φ}_{r , i , 1 , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 1 , N}^{( 1 )} {\sum }_{f = 0}^{{M}_{v} - 1} {y}_{z , r , N}^{( f )} {P}_{r , i , 1 , f , N}^{( 2 )} {φ}_{r , i , 1 , f , N}^{( 2 )}\end{matrix} ] . \\ Or \\ {W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r , 1}^{( f )} {P}_{r , i , 0 , f , 1}^{( 2 )} {φ}_{r , i , 0 , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 0 , {N}_{TRP}}^{( 1 )} {\sum }_{f = 0}^{{M}_{v} - 1} {y}_{z , r , {N}_{TRP}}^{( f )} {P}_{r , i , 0 , f , {N}_{TRP}}^{( 2 )} {φ}_{r , i , 0 , f , {N}_{TRP}}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r , 1}^{( f )} {P}_{r , i , 1 , f , 1}^{( 2 )} {φ}_{r , i , 1 , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 1 , {N}_{TRP}}^{( 1 )} {\sum }_{f = 0}^{{M}_{v} - 1} {y}_{z , r , {N}_{TRP}}^{( f )} {P}_{r , i , 1 , f , {N}_{TRP}}^{( 2 )} {φ}_{r , i , 1 , f , {N}_{TRP}}^{( 2 )}\end{matrix} ] .$$

In some embodiments, for the first type of codebook and/or for the second type of codebook and/or first mode of codebook structure corresponding to layer with index r, the precoding matrix with index z may be

$${W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r , 1}^{( f )} {P}_{r , i , f , 1}^{( 2 )} {φ}_{r , i , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 0 , N}^{( 1 )} {\sum }_{f = 0}^{{M}_{v} - 1} {y}_{z , r , N}^{( f )} {P}_{r , i , f , N}^{( 2 )} {φ}_{r , i , f , N}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r , 1}^{( f )} {P}_{r , i + {L}_{1} , f , 1}^{( 2 )} {φ}_{r , i + {L}_{1} , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 1 , N}^{( 1 )} {\sum }_{f = 0}^{{M}_{v} - 1} {y}_{z , r , N}^{( f )} {P}_{r , i + {L}_{N} , f , N}^{( 2 )} {φ}_{r , i + {L}_{N} , f , N}^{( 2 )}\end{matrix} ] . \\ Or \\ {W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r , 1}^{( f )} {P}_{r , i , f , 1}^{( 2 )} {φ}_{r , i , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 0 , {N}_{TRP}}^{( 1 )} {\sum }_{f = 0}^{{M}_{v} - 1} {y}_{z , r , {N}_{TRP}}^{( f )} {P}_{r , i , f , {N}_{TRP}}^{( 2 )} {φ}_{r , i , f , {N}_{TRP}}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r , 1}^{( f )} {P}_{r , i + {L}_{1} , f , 1}^{( 2 )} {φ}_{r , i + {L}_{1} , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 1 , {N}_{TRP}}^{( 1 )} {\sum }_{f = 0}^{{M}_{v} - 1} {y}_{z , r , {N}_{TRP}}^{( f )} {P}_{r , i + {L}_{{N}_{TRP}} , f , {N}_{TRP}}^{( 2 )} {φ}_{r , i + {L}_{{N}_{TRP}} , f , {N}_{TRP}}^{( 2 )}\end{matrix} ] .$$

In some embodiments,

$${y}_{z , r , t}^{( f )}$$

may be an element in the second vector with index f corresponding to layer with index r and corresponding to the t-th CSI-RS resource in the plurality of CSI-RS resources or corresponding to the t-th selected CSI-RS resource in the second plurality of CSI-RS resources and/or corresponding to the precoding matrix with index z. In some embodiments,

$${y}_{z , r , t}^{( f )} = {e}^{j \frac{2 π * z * {n}_{3 , r , t}^{( f )}}{{N}_{3}}} .$$

In some embodiments, if the terminal device 110 is configured with first mode of codebook structure, the value of

$${y}_{z , r , t}^{( f )} or {n}_{3 , r , t}^{( f )}$$

may be independent or different with different values of t. In some embodiments, if the terminal device 110 is configured with second mode of codebook structure, the value of

$${y}_{z , r , t}^{( f )} or {n}_{3 , r , t}^{( f )}$$

may be same with different values of t. In some embodiments, if the terminal device 110 is configured with second mode of codebook structure, the value of

$${y}_{z , r}^{( f )} or {n}_{3 , r}^{( f )}$$

may be same or common for different values of t. In some embodiments,

$${y}_{z , r}^{( f )} = {e}^{j \frac{2 π * z * {n}_{3 , r}^{( f )}}{{N}_{3}}} .$$

In some embodiments,

$${y}_{z , r}^{( f )}$$

may be an element in the second vector with index f corresponding to layer with index r and common or same to each CSI-RS resource in the plurality of CSI-RS resources or in the second plurality of CSI-RS resources and/or corresponding to the precoding matrix with index z.

In some embodiments, if the terminal device 110 is configured with second mode of codebook structure, for the first type of codebook corresponding to layer with index r, the precoding matrix with index z may be

$${W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r}^{( f )} {P}_{r , i , 0 , f , 1}^{( 2 )} {φ}_{r , i , 0 , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 0 , N}^{( 1 )} {\sum }_{f = 0}^{{M}_{v} - 1} {y}_{z , r}^{( f )} {P}_{r , i , 0 , f , N}^{( 2 )} {φ}_{r , i , 0 , f , N}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r}^{( f )} {P}_{r , i , 1 , f , 1}^{( 2 )} {φ}_{r , i , 1 , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 1 , N}^{( 1 )} {\sum }_{f = 0}^{{M}_{v} - 1} {y}_{z , r}^{( f )} {P}_{r , i , 1 , f , N}^{( 2 )} {φ}_{r , i , 1 , f , N}^{( 2 )}\end{matrix} ] . \\ Or \\ {W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r}^{( f )} {P}_{r , i , 0 , f , 1}^{( 2 )} {φ}_{r , i , 0 , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 0 , {N}_{TRP}}^{( 1 )} {\sum }_{f = 0}^{{M}_{v} - 1} {y}_{z , r}^{( f )} {P}_{r , i , 0 , f , {N}_{TRP}}^{( 2 )} {φ}_{r , i , 0 , f , {N}_{TRP}}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r}^{( f )} {P}_{r , i , 1 , f , 1}^{( 2 )} {φ}_{r , i , 1 , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 1 , {N}_{TRP}}^{( 1 )} {\sum }_{f = 0}^{{M}_{v} - 1} {y}_{z , r}^{( f )} {P}_{r , i , 1 , f , {N}_{TRP}}^{( 2 )} {φ}_{r , i , 1 , f , {N}_{TRP}}^{( 2 )}\end{matrix} ] .$$

In some embodiments, if the terminal device 110 is configured with second mode of codebook structure, for the first type of codebook corresponding to layer with index r, the precoding matrix with index z may be

$${W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r}^{( f )} {P}_{r , i , f , 1}^{( 2 )} {φ}_{r , i , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 0 , N}^{( 1 )} {\sum }_{f = 0}^{{M}_{v} - 1} {y}_{z , r}^{( f )} {P}_{r , i , f , N}^{( 2 )} {φ}_{r , i , f , N}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r}^{( f )} {P}_{r , i + {L}_{1} , f , 1}^{( 2 )} {φ}_{r , i + {L}_{1} , f , 1}^{( 2 )} \\ … \\ {P}_{N}^{( 3 )} {\sum }_{i = 0}^{{L}_{N} - 1} {v}_{{m}_{1}^{( i , N )} , {m}_{2}^{( i , N )}} {P}_{r , 1 , N}^{( 1 )} {\sum }_{f = 0}^{{M}_{v} - 1} {y}_{z , r}^{( f )} {P}_{r , i + {L}_{N} , f , N}^{( 2 )} {φ}_{r , i + {L}_{N} , f , N}^{( 2 )}\end{matrix} ] . \\ Or \\ {W}_{z}^{r} = \frac{1}{\sqrt{{N}_{1} {N}_{2} {γ}_{z , r}}} [ \begin{matrix}{P}_{1}^{( 3 )} {\sum }_{i = 0}^{{L}_{1} - 1} {v}_{{m}_{1}^{( i , 1 )} , {m}_{2}^{( i , 1 )}} {P}_{r , 0 , 1}^{( 1 )} {\sum }_{f = 0}^{{M}_{v} - 1} {y}_{z , r}^{( f )} {P}_{r , i , f , 1}^{( 2 )} {φ}_{r , i , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 0 , {N}_{TRP}}^{( 1 )} {\sum }_{f = 0}^{{M}_{v} - 1} {y}_{z , r}^{( f )} {P}_{r , i , f , {N}_{TRP}}^{( 2 )} {φ}_{r , i , f , {N}_{TRP}}^{( 2 )} \\ {P}_{1}^{( 3 )} {\sum }_{i = 0}^{{L}_{1} - 1} {v}_{{m}_{1}^{( i , 1 )} , {m}_{2}^{( i , 1 )}} {P}_{r , 1 , 1}^{( 1 )} {\sum }_{f = 0}^{{M}_{v} - 1} {y}_{z , r}^{( f )} {P}_{r , i + {L}_{1} , f , 1}^{( 2 )} {φ}_{r , i + {L}_{1} , f , 1}^{( 2 )} \\ … \\ {P}_{{N}_{TRP}}^{( 3 )} {\sum }_{i = 0}^{{L}_{{N}_{TRP}} - 1} {v}_{{m}_{1}^{( i , {N}_{TRP} )} , {m}_{2}^{( i , {N}_{TRP} )}} {P}_{r , 1 , {N}_{TRP}}^{( 1 )} {\sum }_{f = 0}^{{M}_{v} - 1} {y}_{z , r}^{( f )} {P}_{r , i + {L}_{N} , f , {N}_{TRP}}^{( 2 )} {φ}_{r , i + {L}_{N} , f , {N}_{TRP}}^{( 2 )}\end{matrix} ] .$$

In some embodiments, for the second type of codebook and/or first mode of codebook structure corresponding to layer with index r, the precoding matrix with index z may be

$${W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z , 1}^{( f )} {P}_{r , i , 0 , f , 1}^{( 2 )} {φ}_{r , i , 0 , f , 1}^{( 2 )} \\ … \\ {P}_{N}^{( 3 )} {\sum }_{i = 0}^{{L}_{N} - 1} {v}_{{m}^{( i , N )}} {P}_{r , 0 , N}^{( 1 )} {\sum }_{f = 0}^{M - 1} {y}_{z , N}^{( f )} {P}_{r , i , 0 , f , N}^{( 2 )} {φ}_{r , i , 0 , f , N}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z , 1}^{( f )} {P}_{r , i , 1 , f , 1}^{( 2 )} {φ}_{r , i , 1 , f , 1}^{( 2 )} \\ … \\ {P}_{N}^{( 3 )} {\sum }_{i = 0}^{{L}_{N} - 1} {v}_{{m}^{( i , N )}} {P}_{r , 1 , N}^{( 1 )} {\sum }_{f = 0}^{M - 1} {y}_{z , N}^{( f )} {P}_{r , i , 1 , f , N}^{( 2 )} {φ}_{r , i , 1 , f , N}^{( 2 )}\end{matrix} ] . \\ Or \\ {W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z , 1}^{( f )} {P}_{r , i , 0 , f , 1}^{( 2 )} {φ}_{r , i , 0 , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 0 , {N}_{TRP}}^{( 1 )} {\sum }_{f = 0}^{M - 1} {y}_{z , {N}_{TRP}}^{( f )} {P}_{r , i , 0 , f , {N}_{TRP}}^{( 2 )} {φ}_{r , i , 0 , f , {N}_{TRP}}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z , 1}^{( f )} {P}_{r , i , 1 , f , 1}^{( 2 )} {φ}_{r , i , 1 , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 1 , {N}_{TRP}}^{( 1 )} {\sum }_{f = 0}^{M - 1} {y}_{z , {N}_{TRP}}^{( f )} {P}_{r , i , 1 , f , {N}_{TRP}}^{( 2 )} {φ}_{r , i , 1 , f , {N}_{TRP}}^{( 2 )}\end{matrix} ] .$$

In some embodiments, for the second type of codebook and/or first mode of codebook structure corresponding to layer with index r, the precoding matrix with index z may be

$${W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z , 1}^{( f )} {P}_{r , i , f , 1}^{( 2 )} {φ}_{r , i , f , 1}^{( 2 )} \\ … \\ {P}_{N}^{( 3 )} {\sum }_{i = 0}^{{L}_{N} - 1} {v}_{{m}^{( i , N )}} {P}_{r , 0 , N}^{( 1 )} {\sum }_{f = 0}^{M - 1} {y}_{z , N}^{( f )} {P}_{r , i , f , N}^{( 2 )} {φ}_{r , i , f , N}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z , 1}^{( f )} {P}_{r , i + {L}_{1} , f , 1}^{( 2 )} {φ}_{r , i + {L}_{1} , f , 1}^{( 2 )} \\ … \\ {P}_{N}^{( 3 )} {\sum }_{i = 0}^{{L}_{N} - 1} {v}_{{m}^{( i , N )}} {P}_{r , 1 , N}^{( 1 )} {\sum }_{f = 0}^{M - 1} {y}_{z , N}^{( f )} {P}_{r , i + {L}_{N} , f , N}^{( 2 )} {φ}_{r , i + {L}_{N} , f , N}^{( 2 )}\end{matrix} ] . \\ Or \\ {W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z , 1}^{( f )} {P}_{r , i , f , 1}^{( 2 )} {φ}_{r , i , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 0 , {N}_{TRP}}^{( 1 )} {\sum }_{f = 0}^{M - 1} {y}_{z , {N}_{TRP}}^{( f )} {P}_{r , i , f , {N}_{TRP}}^{( 2 )} {φ}_{r , i , f , {N}_{TRP}}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z , 1}^{( f )} {P}_{r , i + {L}_{1} , f , 1}^{( 2 )} {φ}_{r , i + {L}_{1} , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 1 , {N}_{TRP}}^{( 1 )} {\sum }_{f = 0}^{M - 1} {y}_{z , {N}_{TRP}}^{( f )} {P}_{r , i + {L}_{{N}_{TRP}} , f , {N}_{TRP}}^{( 2 )} {φ}_{r , i + {L}_{{N}_{TRP}} , f , {N}_{TRP}}^{( 2 )}\end{matrix} ] .$$

In some embodiments,

$${y}_{z , t}^{( f )}$$

may be an element in the second vector with index f corresponding to the t-th CSI-RS resource in the plurality of CSI-RS resources or corresponding to the t-th selected CSI-RS resource in the second plurality of CSI-RS resources and/or corresponding to the precoding matrix with index z. In some embodiments,

$${y}_{z , t}^{( f )} = {e}^{j \frac{2 π * z * {n}_{3 , t}^{( f )}}{{N}_{3}}} .$$

In some embodiments,

$${y}_{z}^{( f )}$$

may be an element in the second vector with index f and same or common to each CSI-RS resource in the plurality of CSI-RS resources or in the second plurality of CSI-RS resources and/or corresponding to the precoding matrix with index z. In some embodiments,

$${y}_{z}^{( f )} = {e}^{j \frac{2 π * z * {n}_{3}^{( f )}}{{N}_{3}}} .$$

In some embodiments, if the terminal device 110 is configured with first mode of codebook structure, the value of

$${y}_{z , t}^{( f )} or {n}_{3 , t}^{( f )}$$

may be independent or different with different values of t. In some embodiments, if the terminal device 110 is configured with second mode of codebook structure, the value of

$${y}_{z , t}^{( f )} or {n}_{3 , t}^{( f )}$$

may be same with different values of t.

In some embodiments, if the terminal device 110 is configured with second mode of codebook structure, the value of

$${y}_{z}^{( f )} or {n}_{3}^{( f )}$$

may be same or common for different values of t.

In some embodiments,

$${y}_{z , t}^{( f )} or {n}_{3 , t}^{( f )}$$

may be same or common for different layers. For example, when the number of layers is larger than 1. For example, the terminal device 110 may be configured with second type of codebook.

In some embodiments, the second vector with index f (For example, f∈{0, . . . , M−1}) may be identified by n₃. In some embodiments,

$${n}_{3} = [ {n}_{3}^{( 0 )} … {n}_{3}^{( M - 1 )} ] .$$

In some embodiments

$${n}_{3}^{( f )} ∈ \{ \begin{matrix}\{ 0 \} & M = 1 \\ \{ 0 , 1 , … , min ( {N}_{f} , {N}_{3} ) - 1 \} & M = 2\end{matrix} .$$

In some embodiments, the fourth parameter for codebook N_{f} may be a size of window for second vectors. In some embodiments, the value of N_{f} may be at least one of {1,2,4} or {2,4}. In some embodiments, the indices f∈{0, . . . , M−1} may be assigned such that

$${n}_{3}^{( f )}$$

increases with f.

In some embodiments, if the terminal device 110 is configured with second mode of codebook structure, for the second type of codebook corresponding to layer with index r, the precoding matrix with index z may be

$${W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z}^{( f )} {P}_{r , i , 0 , f , 1}^{( 2 )} {φ}_{r , i , 0 , f , 1}^{( 2 )} \\ … \\ {P}_{N}^{( 3 )} {\sum }_{i = 0}^{{L}_{N} - 1} {v}_{{m}^{( i , N )}} {P}_{r , 0 , N}^{( 1 )} {\sum }_{f = 0}^{M - 1} {y}_{z}^{( f )} {P}_{r , i , 0 , f , N}^{( 2 )} {φ}_{r , i , 0 , f , N}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z}^{( f )} {P}_{r , i , 1 , f , 1}^{( 2 )} {φ}_{r , i , 1 , f , 1}^{( 2 )} \\ … \\ {P}_{N}^{( 3 )} {\sum }_{i = 0}^{{L}_{N} - 1} {v}_{{m}^{( i , N )}} {P}_{r , 1 , N}^{( 1 )} {\sum }_{f = 0}^{M - 1} {y}_{z}^{( f )} {P}_{r , i , 1 , f , N}^{( 2 )} {φ}_{r , i , 1 , f , N}^{( 2 )}\end{matrix} ] . \\ Or$$

$${W}_{z}^{r} = \text{} \frac{1}{\sqrt{{γ}_{z , r}}} [ \text{} \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z}^{( f )} {P}_{r , i , 0 , f , 1}^{( 2 )} {φ}_{r , i , 0 , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 0 , {N}_{TRP}}^{( 1 )} {\sum }_{f = 0}^{M - 1} {y}^{( f )} {P}_{r , i , 0 , f , {N}_{TRP}}^{( 2 )} {φ}_{r , i , 0 , f , {N}_{TRP}}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z}^{( f )} {P}_{r , i , 1 , f , 1}^{( 2 )} {φ}_{r , i , 1 , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 1 , {N}_{TRP}}^{( 1 )} {\sum }_{f = 0}^{M - 1} {y}_{z}^{( f )} {P}_{r , i , 1 , f , {N}_{TRP}}^{( 2 )} {φ}_{r , i , 1 , f , {N}_{TRP}}^{( 2 )}\end{matrix} ] .$$

In some embodiments, if the terminal device 110 is configured with second mode of codebook structure, for the second type of codebook corresponding to layer with index r, the precoding matrix with index z may be

$${W}_{z}^{r} = \frac{1}{\sqrt{{γ}_{z , r}}} [ \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z}^{( f )} {P}_{r , i , f , 1}^{( 2 )} {φ}_{r , i , f , 1}^{( 2 )} \\ … \\ {P}_{N}^{( 3 )} {\sum }_{i = 0}^{{L}_{N} - 1} {v}_{{m}^{( i , N )}} {P}_{r , 0 , N}^{( 1 )} {\sum }_{f = 0}^{M - 1} {y}_{z}^{( f )} {P}_{r , i , f , N}^{( 2 )} {φ}_{r , i , f , N}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z}^{( f )} {P}_{r , i + {L}_{1} , f , 1}^{( 2 )} {φ}_{r , i + {L}_{1} , f , 1}^{( 2 )} \\ … \\ {P}_{N}^{( 3 )} {\sum }_{i = 0}^{{L}_{N} - 1} {v}_{{m}^{( i , N )}} {P}_{r , 1 , N}^{( 1 )} {\sum }_{f = 0}^{M - 1} {y}_{z}^{( f )} {P}_{r , i + {L}_{N} , f , N}^{( 2 )} {φ}_{r , i + {L}_{N} , f , N}^{( 2 )}\end{matrix} ] . \\ Or$$

$${W}_{z}^{r} = \text{} \frac{1}{\sqrt{{γ}_{z , r}}} [ \text{} \begin{matrix}{P}_{1}^{( 3 )} {\sum }_{i = 0}^{{L}_{1} - 1} {v}_{{m}^{( i , 1 )}} {P}_{r , 0 , 1}^{( 1 )} {\sum }_{f = 0}^{M - 1} {y}_{z}^{( f )} {P}_{r , i , f , 1}^{( 2 )} {φ}_{r , i , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 0 , {N}_{TRP}}^{( 1 )} {\sum }_{f = 0}^{M - 1} {y}_{z}^{( f )} {P}_{r , i , f , {N}_{TRP}}^{( 2 )} {φ}_{r , i , f , {N}_{TRP}}^{( 2 )} \\ {P}_{1}^{( 3 )} {\sum }_{i = 0}^{{L}_{1} - 1} {v}_{{m}^{( i , 1 )}} {P}_{r , 1 , 1}^{( 1 )} {\sum }_{f = 0}^{M - 1} {y}_{z}^{( f )} {P}_{r , i + {L}_{1} , f , 1}^{( 2 )} {φ}_{r , i + {L}_{1} , f , 1}^{( 2 )} \\ … \\ {P}_{{N}_{TRP}}^{( 3 )} {\sum }_{i = 0}^{{L}_{{N}_{TRP}} - 1} {v}_{{m}^{( i , {N}_{TRP} )}} {P}_{r , 1 , {N}_{TRP}}^{( 1 )} {\sum }_{f = 0}^{M - 1} {y}_{z}^{( f )} {P}_{r , i + {L}_{{N}_{TRP}} , f , {N}_{TRP}}^{( 2 )} {φ}_{r , i + {L}_{{N}_{TRP} ,} f , {N}_{TRP}}^{( 2 )}\end{matrix} ] .$$

In some embodiments, z may be an index of the plurality of precoding matrices for the CSI report. For example, z={0,1, . . . N₃−1}.

In some embodiments, vₘ^{(i,t)} may be the (i+1)-th first vector of the first vectors corresponding to the t-th CSI-RS resource in the plurality of CSI-RS resources or corresponding to the t-th selected CSI-RS resource in the second plurality of CSI-RS resources. In some embodiments, i may be a non-negative integer. For example, 0≤i≤Lₜ−1. In some embodiments, Lₜ may be the number of first vectors corresponding to the t-th CSI-RS resource in the plurality of CSI-RS resources or corresponding to the t-th selected CSI-RS resource in the second plurality of CSI-RS resources. In some embodiments, Lₜ=K₁,t/2. In some embodiments, K_{1,t} may be the number of ports selected from P ports corresponding to the t-th CSI-RS resource in the plurality of CSI-RS resources or corresponding to the t-th selected CSI-RS resource in the second plurality of CSI-RS resources. In some embodiments, K_{1,t}=αₜ*P. In some embodiments, αₜ may be at least one of {0, ½, ¾, 1} or at least one of {½, ¾, 1}. In some embodiments, αₜ may be the value corresponding to the selected one of the set of combinations of values for first vector and/or corresponding to t-th CSI-RS resource in the plurality of CSI-RS resources and/or corresponding to the t-th selected CSI-RS resource in the second plurality of CSI-RS resources. For example, configured for the second type of codebook. In some embodiments, Lₜ may be a positive integer or a non-negative integer. For example, 0≤Lₜ≤16. For example, 1≤Lₜ≤16. For example, the terminal device 110 may be configured with the second type of codebook.

In some embodiments, vₘ_{^{(i,t)}} may be a P/2-element column vector containing a value of 1 in element (For example, the element with index m(i^{t})mod(P/2)) and zeros elsewhere. In some embodiments, the first element in vₘ_{^{(i,t)}} may be element 0 or element with index 0.

In some embodiments, K_{1,t} ports may be selected from P ports corresponding to the t-th CSI-RS resource in the plurality of CSI-RS resources or corresponding to the t-th selected CSI-RS resource in the second plurality of CSI-RS resources based on Lₜ first vectors vₘ_{^{(i,t)}}. In some embodiments, i=0,1, . . . Lₜ−1. In some embodiments, m=[m⁽⁰⁾ . . . m^{(L}^{ₜ}^{t-1)}]. In some embodiments,

$${m}^{( i , t )} ∈ \{ 0 , 1 , … , \frac{P}{2} - 1 \} .$$

In some embodiments, the first vectors may be indicated based on an index i₁,2, and

$${i}_{1 , 2} ∈ \{ 0 , 1 , … , ( \begin{matrix}{P}_{CSI - RS} / 2 \\ L\end{matrix} ) - 1 \} .$$

In some embodiments, r may be at least one of {1,2,3,4}.

In some embodiments, if the number of layers is 1, the codebook with index z may be

$${W}_{z}^{( 1 )} = {W}_{z}^{1} .$$

In some embodiments, if the number of layers is 3, the z may be

$${W}_{z}^{( 2 )} = \frac{1}{\sqrt{2}} [ {W}_{z}^{1} {W}_{z}^{2} ] .$$

In some embodiments, if the number of layers is 3, the codebook with index z may be

$${W}_{z}^{( 3 )} = \frac{1}{\sqrt{3}} [ {W}_{z}^{1} {W}_{z}^{2} {W}_{z}^{3} ] .$$

In some embodiments, if the number of layers is 4, the codebook with index z may be

$${W}_{Z}^{( 4 )} = \frac{1}{2} [ {W}_{z}^{1} {W}_{z}^{2} {W}_{z}^{3} {W}_{z}^{4} ] .$$

In some embodiments, γ_{z,r} may be a variant for power calculation or power normalization. In some embodiments, γ_{z,r} may be based on the plurality of second amplitude coefficients, the plurality of phase coefficients and at least one of: the plurality of first amplitude coefficients, the plurality of third amplitude coefficients. In some embodiments, γ_{z,r} may be based on at least one of: the number of the plurality of first vectors and the number of the plurality of second vectors and the number of CSI-RS resources in the plurality of CSI-RS resources or in the second plurality of CSI-RS resources.

In some embodiments,

$${γ}_{z , r} = {\sum }_{i = 0}^{2 L - 1} {( {p}_{r , ⌊ \frac{i}{L} ⌋}^{( 1 )} )}^{2} {\vert {\sum }_{f = 0}^{{M}_{v} - 1} {y}_{z , r}^{( f )} {p}_{r , i , f}^{( 2 )} {φ}_{r , i , f} \vert}^{2} .$$

For example, for the first type of codebook.

In some embodiments,

$${γ}_{t , l} = {\sum }_{t = 1}^{N} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{M - 1} {y}_{z , t}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{M - 1} {y}_{z , t}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{N} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{M - 1} {y}_{z , t}^{( f )} {p}_{r , i , s , f , t}^{( 2 )} {φ}_{r , i , s , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{M - 1} {y}_{z , t}^{( f )} {p}_{r , i , s , f , t}^{( 2 )} {φ}_{r , i , s , f , t}^{( 2 )} \vert}^{2} .$$

For example, for the second type of codebook. For example, for the first mode of codebook structure.

In some embodiments,

$${γ}_{t , l} = {\sum }_{t = 1}^{N} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{M - 1} {y}_{z}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{M - 1} {y}_{z}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{N} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{M - 1} {y}_{z}^{( f )} {p}_{r , i , s , f , t}^{( 2 )} {φ}_{r , i , s , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{M - 1} {y}_{z}^{( f )} {p}_{r , i , s , f , t}^{( 2 )} {φ}_{r , i , s , f , t}^{( 2 )} \vert}^{2} .$$

For example, for the second type of codebook. For example, for the second mode of codebook structure.

In some embodiments,

$${γ}_{t , l} = {\sum }_{t = 1}^{N} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{{M}_{v} - 1} {y}_{z , r , t}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{{M}_{v} - 1} {y}_{z , r , t}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{N} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{{M}_{v} - 1} {y}_{z , r , t}^{( f )} {p}_{r , i , s , f , t}^{( 2 )} {ϕ}_{r , i , s , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{{M}_{v} - 1} {y}_{z , r , t}^{( f )} {p}_{r , i , s , f , t}^{( 2 )} {φ}_{r , i , s , f , t}^{( 2 )} \vert}^{2} .$$

For example, for the first type of codebook. For example, for the first mode of codebook structure.

In some embodiments,

$${γ}_{t , l} = {\sum }_{t = 1}^{N} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{{M}_{v} - 1} {y}_{z , r}^{( f )} {p}_{r , i , f , t}^{( 2 )} {φ}_{r ,}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{i = 0}^{2 L - 1} {( {p}_{r , ⌊ \frac{i}{L} ⌋ , t}^{( 1 )} )}^{2} {\vert {\sum }_{f = 0}^{{M}_{v} - 1} {y}_{z , r}^{( f )} {p}_{r , i , f , t}^{( 2 )} {φ}_{r , i , f , t}^{( 2 )} \vert}^{2} .$$

In some embodiments,

$${γ}_{t , l} = {\sum }_{t = 1}^{N} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{{M}_{v} - 1} {y}_{z , r}^{( f )} {p}_{r , i , s , f , t}^{( 2 )} {φ}_{r , i , s , f , t}^{( 2 )} \vert}^{2} .$$

In some embodiments,

$${γ}_{t , l} = {\sum }_{t = 1}^{{N}_{TRP}} {( {P}_{t}^{( 3 )} )}^{2} {\sum }_{s = 0}^{1} {\sum }_{i = 0}^{L - 1} {( {p}_{r , i , s , t}^{( 1 )} )}^{2} {\vert {\sum }_{f = 0}^{{M}_{v} - 1} {y}_{z , r}^{( f )} {p}_{r , i , s , f , t}^{( 2 )} {φ}_{r , i , s , f , t}^{( 2 )} \vert}^{2} .$$

For example, for the first type of codebook. For example, for the second mode of codebook structure.

In some embodiments, the terminal device 110 may receive, from the network device, at least one configuration for one channel state information (CSI) report, wherein the at least one configuration may indicate or determine at least one of: at least one first number of first vectors, at least one first number of second vectors and a number of a plurality of channel state information reference signal (CSI-RS) resources.

In some embodiments, the terminal device 110 may determine a second plurality of CSI-RS resources, wherein the second plurality of CSI-RS resources may be same as or a subset of the plurality of CSI-RS resources. In some embodiments, the terminal device 110 may determine at least one of: at least one second number of selected first vectors based on the second plurality of CSI-RS resources and at least one second number of selected second vectors based on the second plurality of CSI-RS resources and the at least one configuration. In some embodiments, the terminal device 110 may transmit, based on the at least one configuration, the CSI report to the network device.

In some embodiments, a CSI report may be divided into two parts. For example, CSI part 1 (or part 1 or a first part of CSI) and CSI part 2 (or part 2 or a second part of CSI). In some embodiments, CSI part 2 may be further divided into three groups. For example, CSI group 0, CSI group 1, and CSI group 2. In some embodiments, a CSI report may comprise PMI fields X₁ and PMI fields X₂. For example, PMI fields X₁ may be comprised in CSI group 0. For another example, PMI fields X₂ may be comprised in CSI group 1 and CSI group 2. For another example, a subset of PMI fields X₂ may be comprised in CSI group 1, and the remaining of PMI fields X₂ may be comprised in CSI group 2.

In some embodiments, in CSI part 1 of a CSI report, there may be at least one of: rand indicator (RI), if reported; wideband channel quality indicator (CQI) for the first transport block (TB), if reported; subband differential CQI for the first TB with increasing order of subband number, if reported and indicator of the total number of non-zero coefficients summed across all layers (e.g. represented as K^{NZ}), if reported.

In some embodiments, the bitwidth for the rank indicator may be min(2, ┌log₂n_{RI}┐), where n_{RI} may be the number of allowed rank indicator values. In some embodiments, a parameter of number of allowed rank indicator values (e.g. n_{RI}) may be configured by the network device. In some embodiments, the values of the rank indicator (RI) field are mapped to allowed rank indicator values with increasing order, where ‘0’ is mapped to the smallest allowed rank indicator value. In some embodiments, the bitwidth for the wideband CQI may be 4. In some embodiments, the bitwidth for the subband differential CQI may be 2.

In some embodiments, the bitwidth for the indicator of the total number of non-zero coefficients summed across all layers K^{NZ} may be ┌log₂(K₀)┐ if max allowed rank is 1, and the bitwidth for the indicator of the total number of non-zero coefficients summed across all layers K^{NZ} may be ┌log₂(2K₀)┐ otherwise. In some embodiments, the bitwidth for the indicator of the total number of non-zero coefficients summed across all layers K^{NZ} may be ┌log₂(K₀)┐ if max allowed rank is 1, and the bitwidth for the indicator of the total number of non-zero coefficients summed across all layers K^{NZ} may be ┌log₂(2K₀)┐ if max allowed rank is larger than 1 (For example, the max allowed rank may be 2 or 3 or 4).

In some embodiments,

$${K}_{0} = ⌈ 2 L ⌈ {p}_{1} \times \frac{{N}_{3}}{R} ⌉ β ⌉ ,$$

where p₁, N₃, R, and β may be configured or determined by network device according to some embodiments in this disclosure. For example, p₁ may be the parameter of pᵥ when v=1. In some embodiments, the values of the K^{NZ} indicator field are mapped to the allowed values of K^{NZ} with increasing order, where ‘0’ is mapped to K^{NZ}=1. For example, for a first type of codebook. For example, for a codebook based on Rel-16 codebook.

In some embodiments, ┌K₁Mβ┐, where K₁, M, and β may be configured or determined by network device according to some embodiments in this disclosure. In some embodiments, the values of the K^{NZ} indicator field are mapped to the allowed values of K^{NZ} with increasing order, where ‘0’ is mapped to K^{NZ}=1. For example, for a second type of codebook. For example, for a codebook based on Rel-17 port selection codebook.

In some embodiments, v may be the number of layers or the value of rank indicator field. For example, the number of layers or the value of the RI field may be reported by the terminal device 110 to the network device.

In some embodiments, the terminal device 110 may receive, from the network device, at least one configuration for one CSI report, wherein the at least one configuration may include at least one of: a plurality of CSI-RS resources for channel measurement for the CSI report, a set of combinations of values for first vector for the CSI report (For example, the set of combinations of values for first vector may be represented as Lₜ (For example, for the first type of codebook). For example, the set of combinations of values for first vector may be represented as αₜ (For example, for the second type of codebook). For example, 1≤t≤N. For example, 1≤t≤N_{TRP}), a set of values for second vector (e.g. represented as M_{υ} or represented as M) for the CSI report and a set of values for a first parameter (e.g. represented as β) for the CSI report, at least one parameter for antenna port configuration (e.g. a first parameter for antenna port configuration N₁ and a second parameter for antenna port configuration N₂), a configuration for codebook type, at least one parameter for codebook, a total number of precoding matrices in the CSI report (e.g. represented as N₃), the number of a plurality of third vectors (e.g. represented as M_{d}), a set of values for a second parameter for codebook (e.g. represented as pᵥ), a third parameter for codebook (e.g. represented as R) and a fourth parameter for codebook (e.g. represented as N_{f}). In some embodiments, the fourth parameter for codebook N_{f} may be configured when the terminal device 110 is configured with second type of codebook. In some embodiments, the fourth parameter for codebook N_{f} may be a size of window for second vectors. In some embodiments, the value of N_{f} may be at least one of {1,2,4} or {2,4}.

In some embodiments, the terminal device 110 may receive, from the network device, at least one configuration indicating the number of physical resource blocks (PRBs) in a bandwidth part (BWP), the number of a plurality of first subbands, a size of one first subband, the number of PRBs of one first subband, the number of a plurality of time units (e.g. represented as N₄) and a size of one time unit (e.g. represented as Tᵤ or Tᵢ).

In some embodiments, each value in a combination of values for first vector may correspond to one of the plurality of CSI-RS resources or correspond to one TRP or correspond to one TRP group.

In some embodiments, the terminal device 110 may be configured with a number of PRBs for a bandwidth part (BWP) or with a size for the BWP. In some embodiments, the number of PRBs for the BWP (e.g. represented as

$${N}_{BWP}^{size} )$$

may be a positive integer. For example, N_{BWP} may be a positive integer. For example,

$$24 \leq {N}_{BWP}^{size} \leq 275.$$

In some embodiments the terminal device 110 may be configured with a starting position of the BWP (e.g. represented as

$${N}_{BWP}^{start} ) .$$

For example,

$${N}_{BWP}^{start}$$

may be a non-negative integer. For example,

$$0 \leq {N}_{BWP}^{start} \leq 275 .$$

In some embodiments, the starting position of the BWP and the number of PRBs for the BWP may be configured in one higher layer parameter.

In some embodiments, first subband may correspond to a subband for CQI or CQI subband or CSI subband.

In some embodiments, the size of one first subband or the number of PRBs of one first subband may be represented as

$${N}_{PRB}^{SB} , and {N}_{PRB}^{SB}$$

is a positive integer. For example,

$$1 \leq {N}_{PRB}^{SB} \leq 32.$$

For example,

$${N}_{PRB}^{SB}$$

may be at least one of {4, 8, 16, 32}. In some embodiments,

$${N}_{PRB}^{SB}$$

may be based on the value of N_{BWP}. In some embodiments, if 24≤N_{BWP}≤72,

$${N}_{PRB}^{SB}$$

may be 4 or 8. For example,

$${N}_{PRB}^{SB}$$

may be configured to be 4 or 8 based on one higher layer parameter for subband. In some embodiments, if 73≤N_{BWP}≤144,

$${N}_{PRB}^{SB}$$

may be 8 or 16. For example,

$${N}_{PRB}^{SB}$$

may be configured to be 8 or 16 based on the higher layer parameter for subband. In some embodiments, if 145≤N_{BWP}≤275,

$${N}_{PRB}^{SB}$$

may be 16 or 32. For example,

$${N}_{PRB}^{SB}$$

may be configured to be 16 or 32 based on the higher layer parameter for subband.

In some embodiments, the terminal device 110 may be configured with a plurality of CSI-RS resources. In some embodiments, the at least one configuration for the CSI report may comprise or indicate the plurality of CSI-RS resources. In some embodiments, the plurality of CSI-RS resources may comprise N_{TRP} CSI-RS resource. In some embodiments, the number of CSI-RS resources in the plurality of CSI-RS resources may be N_{TRP}. In some embodiments, N_{TRP} may be a positive integer, and 1≤N_{TRP}≤8 or 1≤N_{TRP}≤4 or 2≤N_{TRP}≤4. In some embodiments, N_{TRP} may be at least one of {1, 2, 3, 4} or at least one of {2, 3, 4}.

In some embodiments, each CSI-RS resource may be represented as t. In some embodiments, t may be a non-negative integer. For example, 0≤t≤N_{TRP}−1 or t∈{0,1, . . . N_{TRP}−1}. In some embodiments, the first CSI-RS resource in the plurality of CSI-RS resources may be represented as CSI-RS resource with index t=0. In some embodiments, the second CSI-RS resource in the plurality of CSI-RS resources may be represented as CSI-RS resource with index t=1. In some embodiments, the third CSI-RS resource in the plurality of CSI-RS resources may be represented as CSI-RS resource with index t=2. In some embodiments, the fourth CSI-RS resource in the plurality of CSI-RS resources may be represented as CSI-RS resource with index t=3. In some embodiments, the n-th CSI-RS resource in the plurality of CSI-RS resources may be represented as CSI-RS with index t=n−1. In some embodiments, n may be a positive integer. For example, 1≤n≤N_{TRP} or n∈{1,2, . . . N_{TRP}}.

In some embodiments, t may be a positive integer. For example, 1≤t≤N_{TRP} or t∈{1,2, . . . N_{TRP}}. In some embodiments, the first CSI-RS resource in the plurality of CSI-RS resources may be represented as CSI-RS resource with index t=1. In some embodiments, the second CSI-RS resource in the plurality of CSI-RS resources may be represented as CSI-RS resource with index t=2. In some embodiments, the third CSI-RS resource in the plurality of CSI-RS resources may be represented as CSI-RS resource with index t=3. In some embodiments, the fourth CSI-RS resource in the plurality of CSI-RS resources may be represented as CSI-RS resource with index t=4. In some embodiments, the t-th CSI-RS resource in the plurality of CSI-RS resources may be represented as CSI-RS with index t.

In some embodiments, the terminal device 110 may indicate or select or determine or report a second plurality of CSI-RS resources based on the plurality of CSI-RS resources. In some embodiments, the second plurality of CSI-RS resources may be same as the plurality of CSI-RS resources. In some embodiments, the second plurality of CSI-RS resources may be a subset of the plurality of CSI-RS resources. In some embodiments, the second plurality of CSI-RS resources may comprise N CSI-RS resource. In some embodiments, the number of CSI-RS resources in the second plurality of CSI-RS resources may be N. In some embodiments, N may be a positive integer, and 1≤N≤N_{TRP}. In some embodiments, N may be at least one of {1, 2, 3, 4} or at least one of {2, 3, 4}. In some embodiments, N may be less than or equal to N_{TRP}.

In some embodiments, the second plurality of CSI-RS resources may be indicated or reported based on a bitmap. In some embodiments, the number of bits in the bitmap may be N_{TRP}. In some embodiments, a bit in the bitmap may be represented as bₜ, and the value of bₜ may be either 0 or 1. In some embodiments, the bit bₜ in the bitmap may indicate whether the corresponding CSI-RS resource with index t in the plurality of CSI-RS resources selected or not. In some embodiments, the bit bₜ in the bitmap may indicate whether the corresponding CSI-RS resource with index t in the plurality of CSI-RS resources included or selected in the second plurality of CSI-RS resources or not. In some embodiments, the bitmap may be represented as {bₜ}, wherein 1≤t≤N_{TRP} or 0≤t≤N_{TRP}−1. In some embodiments, the bitmap may be {b₀, b₁} or {b₁, b₂} when N_{TRP}=2. In some embodiments, the bitmap may be {b₀, b₁, b₂} or {b₁, b₂, b₃} when N_{TRP}=3. In some embodiments, the bitmap may be {b₀, b₁, b₂, b₃} or {b₁, b₂, b₃, b₄} when N_{TRP}=4. In some embodiments, a CSI-RS resource t in the plurality of CSI-RS resources corresponding to a bit value bₜ is selected or is included in the second plurality of CSI-RS resources if the value bₜ=1. In some embodiments, at least one bit in the bitmap may be with value 1.

In some embodiments, there may be a reference CSI-RS resource in the plurality of CSI-RS resources or in the second plurality of CSI-RS resources. In some embodiments, the reference CSI-RS resource may be a CSI-RS resource corresponding to a strongest coefficient indication or a strongest amplitude coefficient or an indication in the bitmap for non zero coefficients indication. In some embodiments, the reference CSI-RS resource may be the first one of CSI-RS resource or the last one of CSI-RS resource or the latest one of CSI-RS resource in time in the plurality of CSI-RS resources. In some embodiments, the reference CSI-RS resource may be the first one of CSI-RS resource or the last one of CSI-RS resource or the latest one of CSI-RS resource in time in the second plurality of CSI-RS resources.

In some embodiments, the terminal device 110 may receive at least one of the plurality of CSI-RS resources based on the number of antenna ports.

In some embodiments, for each one CSI-RS resource in the plurality of CSI-RS resources, there may be P ports. In some embodiments, P may be a positive integer. In some embodiments, P may be at least one of {2, 4, 8, 12, 16, 24, 32}.

In some embodiments, a value of the first parameter of antenna port configuration may be represented as N₁. For example, N₁ may be a positive integer. For example, N₁ may be one of {2, 3, 4, 6, 8, 12, 16}. In some embodiments, a value of the second parameter of antenna port configuration may be represented as N₂. For example, N₂ may be a positive integer. For example, N₂ may be one of {1, 2, 3, 4}. In some embodiments, the first parameter of antenna port configuration and the second parameter of antenna port configuration may be configured in one higher layer parameter.

In some embodiments, the number of antenna ports for each CSI-RS resource in the plurality of CSI-RS resources or in the second plurality of CSI-RS resources may be determined based on the first parameter of antenna port configuration and a second parameter of antenna port configuration. In some embodiments, the number of antenna ports for the CSI-RS resource may be P=N₁·N₂·2.

In some embodiments, the terminal device 110 may determine or report a number of layers and at least one codebook indicator based on the at least one configuration to the network device. In some embodiments, the number of layers (e.g. represented as vᵣᵢ) may be one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤vᵣᵢ. For example, r maybe one of {1, 2, . . . vᵣᵢ} or {1, 2} or {1, 2,3, 4} or {1, 2,3,4,5,6,7, 8}.

In some embodiments, the third parameter for codebook (for example, represented as R) may be a positive integer. For example, R may be a positive integer. For example, R may be one of {1, 2}. In some embodiments, the total number of precoding matrices N₃ may be determined based on the third parameter for codebook and the number of the plurality of first subbands. In some embodiments, the third parameter for codebook may control the total number of precoding matrices N₃ indicated by the PMI as a function of the number of configured first subbands or the number of the plurality of first subbands, the size of one first subband and of the number of PRBs for the BWP. In some embodiments, if the second plurality of CSI-RS resources includes only one CSI-RS resource, the value of R may be either 1 or 2. In some embodiments, if the second plurality of CSI-RS resources includes more than one CSI-RS resource, the value of R may be 1.

In some embodiments, the total number of precoding matrices N₃ or the size or the length of one second vector may be a positive integer. For example, 9≤N₃≤36. For another example, For example, 1≤N₃≤38. For example,

$${N}_{3} = R * {N}_{BWP}^{size} / {N}_{PRB}^{SB} .$$

For another example,

$${N}_{3} = R * ⌊ {N}_{BWP}^{size} / {N}_{PRB}^{SB} ⌋ .$$

For another example,

$${N}_{3} = R * ⌈ {N}_{BWP}^{size} / {N}_{PRB}^{SB} ⌉ .$$

For another example,

$${N}_{3} = R * ⌊ {N}_{BWP}^{size} / {N}_{PRB}^{SB} ⌋ + 1.$$

For another example,

$${N}_{3} = R * ⌊ {N}_{BWP}^{size} / {N}_{PRB}^{SB} ⌋ + 2.$$

For another example,

$${N}_{3} = R * ⌊ {N}_{BWP}^{size} / {N}_{PRB}^{SB} ⌋ + 3.$$

For another example,

$${N}_{3} = R * ⌊ {N}_{BWP}^{size} / {N}_{PRB}^{SB} ⌋ + 4.$$

In some embodiments, when R=1, there may be one precoding matrix indicated for each first subband. In some embodiments, when R=2, for one first subband that is not the first/beginning one or the last/ending one of the plurality of first subbands in the BWP, there may be two precoding matrixes indicated for the one of the plurality of first subbands. For example, the first precoding matrix corresponds to the first

$${N}_{PRB}^{SB} / 2 PRBs$$

of the one of the plurality of first subbands, and the second precoding matrix corresponds to the last

$${N}_{PRB}^{SB} / 2 PRBs$$

of the one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) \geq \frac{{N}_{PRB}^{SB}}{2} ,$$

there may be one precoding matrix indicated corresponding to the first/beginning one of the plurality of first subbands.

In some embodiments, when R=2, for one first subband that is the first/beginning one or the last/ending one of the plurality of first subbands in the BWP, if

$$( {N}_{BWP}^{start} mod {N}_{PRB}^{SB} ) < \frac{{N}_{PRB}^{SB}}{2} ,$$

there may be two precoding matrices indicated corresponding to the first/beginning one of the plurality of first subbands. For example, the first precoding matrix may correspond to the first

$$\frac{{N}_{PRB}^{SB}}{2} - ( {N}_{BWP}^{start} mod {N}_{PRB}^{SB} ) PRBs$$

of the first/beginning one of the plurality of first subbands and the second precoding matrix corresponds to the last

$$\frac{{N}_{PRB}^{SB}}{2} PRBs$$

of the first/beginning one of the plurality of first subbands.

In some embodiments, when R=2, for one first subband that is the first/beginning one or the last/ending one of the plurality of first subbands in the BWP, if

$$1 + ( {N}_{BWP}^{start} + {N}_{BWP}^{size} - 1 ) mod {N}_{PRB}^{SB} \leq \frac{{N}_{PRB}^{SB}}{2} ,$$

there may be one precoding matrix indicated corresponding to the last/ending one of the plurality of first subbands.

In some embodiments, when R=2, for one first subband that is the first/beginning one or the last/ending one of the plurality of first subbands, if

$$1 + ( {N}_{BWP}^{start} + {N}_{BWP}^{size} - 1 ) mod {N}_{PRB}^{SB} > \frac{{N}_{PRB}^{SB}}{2} ,$$

there may be two precoding matrices indicated corresponding to the last/ending one of the plurality of first subbands. For example, the first precoding matrix may correspond to the first

$$\frac{{N}_{PRB}^{SB}}{2} PRBs$$

of the last/ending one of the plurality of first subbands and the second precoding matrix may correspond to the last

$$1 + ( {N}_{BWP , i}^{start} + {N}_{BWP , i}^{size} - 1 ) mod {N}_{PRB}^{SB} - \frac{{N}_{PRB}^{SB}}{2} PRBs$$

of the last/ending one of the plurality of first subbands.

In some embodiments, the number of the plurality of second vectors M_{υ} may be a positive integer. For example,

$${M}_{v} = ⌈ {p}_{v} \frac{{N}_{3}}{R} ⌉ .$$

For example, 1≤M_{υ}≤18. For example, M_{υ} may be one of {1, 2, 3, 4, 5, 6, 7, 8, 9, 10}.

In some embodiments, a plurality of precoding matrices may be determined from L+M_{υ} vectors or Lₜ+M_{υ} vectors or N_{TRP}·(Lₜ+M_{υ}) vectors or N_{TRP}·Lₜ+M_{υ} vectors.

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a. In some embodiments, b!=1*2* . . . *(b−1)*b. In some embodiments, (a−b)!=1*2* . . . *(a−b−1)*(a−b). In some embodiments, C(a, b) and/or

$$( \begin{matrix}a \\ b\end{matrix} )$$

may be nchoosek(a, b). In some embodiments, a and/or b may be positive integer. In soieienbodiments, a may be larger than or no less than b. In some embodiments, 1≤a≤32. In some embodiments, 1≤b≤32. In some embodiments, 1≤b≤a.

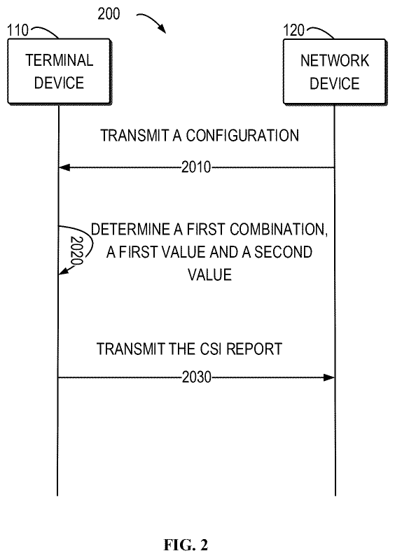

Reference is made to FIG. 2, which illustrates a signaling flow 200 of reporting angle information in accordance with some embodiments of the present disclosure. For the purposes of discussion, the signaling flow 200 will be discussed with reference to FIG. 1, for example, by using the terminal device 110 and the network device 120. It is noted that FIG. 2 is only an example embodiment.

The network device 120 transmits (2010) a configuration to the terminal device 110. The configuration indicates a plurality of channel state information reference signal (CSI-RS) resources for channel measurement for a CSI report and at least one configuration for a set of combinations of values for first vector, a set of values for second vector and a set of values for a first parameter for the CSI report. For example, the terminal device 110 may be configured with a plurality of CSI-RS resources (e.g. N_{TRP} CSI-RS resources). In some embodiments, one CSI-RS resource may correspond to one TRP or TPR group. For example, each CSI-RS resource may correspond to one TRP or TRP group (e.g. represented as t, t∈{0,1, . . . N_{TRP}−1} or t∈{1,2, . . . N_{TRP}}).

In some embodiments, the first vector may refer to a spatial domain (SD) basis or a SD vector. In addition, the second vector may refer to a FD basis or a FD vector. It is noted that the first and second vector may refer to a proper vector in a proper domain. In some embodiments, one CSI-RS resource may correspond to one TRP or TPR group.

The terminal device 110 determines (2020) a first combination from the set of combinations of values for first vector, a first value from the set of values for second vector and a second value from the set of values for the first parameter based at least on a subset of CSI-RS resources from the plurality of CSI-RS resources. In some embodiments, the determination (2020) may be based on a subset of the CSI-RS resources from the plurality of CSI-RS resources. Alternatively, the determination (2020) may be based on all of the plurality of CSI-RS resources.

In some embodiments, the first combination from the set of combinations of values for first vector may be configured to be associated with at least one of the first value and the second value. In some embodiments, the N_{L} (N_{L} may be {1,2,3,4,5,6,7,8}) combinations of values for {L₁, . . . , L_{NTRP}} may be associated with Nₛ (Nₛ may be {1,2,3,4}) values of pᵥ for a value of v (v may be {1,2,3,4}) and/or associated with Nₛ (Nₛ may be {1,2,3,4}) values of β. For example, one of the N_{L} combinations of values for {L₁, . . . , L_{NTRP}} combined with one of the Nₛ values of pᵥ for a value of v and/or combined with one of the Nₛ values of β may be selected/reported by the terminal device 110. The N_{L} combinations of values for {L₁, . . . , L_{NTRP}} and the Nₛ values of pᵥ and/or the Nₛ values of β may be associated with one value of parameter combination for codebook. There may be Nₚ (Nₚ may be positive integer, 8≤N_{y}≤32) values of parameter combination for codebook, and one value may be configured or determined or reported for one CSI report. For example, for different values of N_{TRP}, the paramCombination table may be different.

In some embodiments, the terminal device 110 may indicate or select N out of N_{TRP} CSI-RS resources via bitmap. In this case, 1<=N<=N_{TRP}. If restriction of N=N_{TRP} is configured, there may be no bitmap in CSI part 1 and value of Lₜ may be based on the reported one of N_{L} combinations. In some embodiments, for each CSI-RS resource, there may be P ports for the CSI-RS resource (P may be 2 or 4 or 8 or 12 or 16 or 24 or 32). In some embodiments, the total number of ports for CJT may be P*N or P*N_{TRP}. In some embodiments, the bitmap may be represented as b_t, e.g. {b1, b2, b3, b4}, and each value of b_t may be 0 or 1, and there is at least one value of b_t to be 1. In some embodiments, there may be additional values, for example, pᵥ=½ for v=1,2,3,4 (with restriction), where pᵥ represents the frequency domain basis and v represent the number of layers.

In some embodiments, candidate values for enhancement may be based on Rel-16 codebook. The number of FD basis vectors may be

$${M}_{v} = ⌈ {p}_{v} \frac{{N}_{3}}{R} ⌉ ,$$

wherein N₃ may represent the total number of precoding matrixes in the CSI report. The maximum number of non zero coefficients per layer may be

$${K}_{0} = ⌈ β2 {\sum }_{t = 1}^{{N}_{TRP}} {L}_{t} {M}_{1} ⌉ or {K}_{0} = ⌈ β2 {\sum }_{t = 1}^{N} {L}_{t} {M}_{1} ⌉ .$$

In some embodiments,

$${M}_{1} = ⌈ {p}_{1} \frac{{N}_{3}}{R} ⌉ .$$

In some embodiments, table 1 below shows candidates values for Lₜ (for example, the first vector). In some embodiments, table 2 below shows candidates value for pᵥ (for example, the second vector). In some embodiments, table 3 below shows candidates values for β (for example, the first parameter). In some embodiments, the first combination may be from Tables 1-3. In some embodiments, table 4 shows an example of the first combination (for example, candidate values for combination of Lₜ and N_{TRP} or N). It is noted that the values shown in Tables 1-4 are only examples not limitations and orders of the values shown in Tables 1-4 are also examples. In some embodiments, a subset of columns and/or rows in Table 1 and/or Table 2 and/or Table 3 and/or Table 4 may be applied for some embodiments in this disclosure. In some embodiments, the order of index t corresponding to the values “Lₜ configured for N_{TRP}” in the Table 4 may be changed. In some embodiments, the order of index t corresponding to the values “Lₜ configured for N_{TRP}” in the Table 4 may be t={1,2} or {2,1} or {1,2,3}1 or {1,3,2} or {2,3,1} or {2,1,3} or {3,1,2} or {3,2,1} or {1,2,3,4} or {1,2,4,3}1 or {1,3,2,4} or {1,3,4,2} or {1,4,2,3} or {1l,4,3,2} or {2,1,3,4} or {2,1,4,3} or {2,3,1,4} or {2,3,4,1} or {2,4,1,3} or {2,4,3,1} or {3,1,2,4} or {3,1,4,2} or {3,2,1,4} or {3,2,4,1} or {3,4,1,2} or {3,4,2,1} or {4,1,2,3} or {4,1,3,2} or {4,2,1,3} or {4,2,3,1} or {4,3,1,2} or {4,3,2,1}.

TABLE 1
Lₜ
2
4
6

TABLE 2
p_{ν}

| ν ∈ {1, 2} | ν ∈ {3, 4} |
|---|---|
| ¼ | 1/8 |
| ¼ | ¼ |
| ½ | ¼ |
| ¼ | — |
| 1/8 | 1/16 |
| ½ | ½ |
| ½ | — |

TABLE 3
β
¼
½
¾
1/8

TABLE 4

| Lₘₐₓ | Lₜₒₜ | N | N_{TRP} | Lₜ configured for N_{TRP} | Lₜ selected |
|---|---|---|---|---|---|
| | 4 | 2 | 2 | {2, 2} | {2, 2} |
| | 6 | 2 | 2 | {2, 4} | {2, 4} |
| | 8 | 2 | 2 | {2, 6} | {2, 6} |
| | 8 | 2 | 2 | {4, 4} | {4, 4} |
| | 10 | 2 | 2 | {4, 6} | {4, 6} |
| | 12 | 2 | 2 | {6, 6} | {6, 6} |
| | 2 | 1 | 2 | {2, 2} | {2} |
| | 2 | 1 | 2 | {2, 4} | {2} |
| | 4 | 1 | 2 | {2, 4} | {4} |
| | 2 | 1 | 2 | {2, 6} | {2} |
| | 6 | 1 | 2 | {2, 6} | {6} |
| | 4 | 1 | 2 | {4, 4} | {4} |
| | 4 | 1 | 2 | {4, 6} | {4} |
| | 6 | 1 | 2 | {4, 6} | {6} |
| | 6 | 1 | 2 | {6, 6} | {6} |
| | 6 | 3 | 3 | {2, 2, 2} | {2, 2, 2} |
| | 8 | 3 | 3 | {4, 2, 2} | {4, 2, 2} |
| | 10 | 3 | 3 | {6, 2, 2} | {6, 2, 2} |
| | 10 | 3 | 3 | {2, 4, 6} | {2, 4, 6} |
| | 12 | 3 | 3 | {4, 4, 4} | {4, 4, 4} |
| | 10 | 3 | 3 | {4, 4, 2} | {4, 4, 2} |
| | 14 | 3 | 3 | {4, 4, 6} | {4, 4, 6} |
| | 16 | 3 | 3 | {6, 6, 4} | {6, 6, 4} |
| | 18 | 3 | 3 | {6, 6, 6} | {6, 6, 6} |
| | 4 | 2 | 3 | {2, 2, 2} | {2, 2} |
| | 6 | 2 | 3 | {4, 2, 2} | {4, 2} |
| | 4 | 2 | 3 | {4, 2, 2} | {2, 2} |
| | 8 | 2 | 3 | {6, 2, 2} | {6, 2} |
| | 4 | 2 | 3 | {6, 2, 2} | {2, 2} |
| | 6 | 2 | 3 | {2, 4, 6} | {2, 4} |
| | 8 | 2 | 3 | {2, 4, 6} | {2, 6} |
| | 10 | 2 | 3 | {2, 4, 6} | {4, 6} |
| | 8 | 2 | 3 | {4, 4, 4} | {4, 4} |
| | 6 | 2 | 3 | {4, 4, 2} | {4, 2} |
| | 8 | 2 | 3 | {4, 4, 2} | {4, 4} |
| | 10 | 2 | 3 | {4, 4, 6} | {4, 6} |
| | 8 | 2 | 3 | {4, 4, 6} | {4, 4} |
| | 12 | 2 | 3 | {6, 6, 4} | {6, 6} |
| | 10 | 2 | 3 | {6, 6, 4} | {6, 4} |
| | 12 | 2 | 3 | {6, 6, 6} | {6, 6} |
| | 2 | 1 | 3 | {2, 2, 2} | {2} |
| | 4 | 1 | 3 | {4, 2, 2} | {4} |
| | 2 | 1 | 3 | {4, 2, 2} | {2} |
| | 6 | 1 | 3 | {6, 2, 2} | {6} |
| | 2 | 1 | 3 | {6, 2, 2} | {2} |
| | 2 | 1 | 3 | {2, 4, 6} | {2} |
| | 4 | 1 | 3 | {2, 4, 6} | {4} |
| | 6 | 1 | 3 | {2, 4, 6} | {6} |
| | 4 | 1 | 3 | {4, 4, 4} | {4} |
| | 2 | 1 | 3 | {4, 4, 2} | {2} |
| | 4 | 1 | 3 | {4, 4, 2} | {4} |
| | 6 | 1 | 3 | {4, 4, 6} | {6} |
| | 4 | 1 | 3 | {4, 4, 6} | {4} |
| | 6 | 1 | 3 | {6, 6, 4} | {6} |
| | 4 | 1 | 3 | {6, 6, 4} | {4} |
| | 6 | 1 | 3 | {6, 6, 6} | {6} |
| | 8 | 4 | 4 | {2, 2, 2, 2} | {2, 2, 2, 2} |
| | 10 | 4 | 4 | {4, 2, 2, 2} | {4, 2, 2, 2} |
| | 12 | 4 | 4 | {6, 2, 2, 2} | {6, 2, 2, 2} |
| | 14 | 4 | 4 | {2, 4, 6, 2} | {2, 4, 6, 2} |
| | 16 | 4 | 4 | {2, 4, 6, 4} | {2, 4, 6, 4} |
| | 18 | 4 | 4 | {2, 4, 6, 6} | {2, 4, 6, 6} |
| | 14 | 4 | 4 | {4, 4, 4, 2} | {4, 4, 4, 2} |
| | 16 | 4 | 4 | {4, 4, 4, 4} | {4, 4, 4, 4} |
| | 18 | 4 | 4 | {4, 4, 4, 6} | {4, 4, 4, 6} |
| | 16 | 4 | 4 | {2, 2, 6, 6} | {2, 2, 6, 6} |
| | 12 | 4 | 4 | {4, 4, 2, 2} | {4, 4, 2, 2} |
| | 20 | 4 | 4 | {4, 4, 6, 6} | {4, 4, 6, 6} |
| | 20 | 4 | 4 | {6, 6, 6, 2} | {6, 6, 6, 2} |
| | 22 | 4 | 4 | {6, 6, 6, 4} | {6, 6, 6, 4} |
| | 24 | 4 | 4 | {6, 6, 6, 6} | {6, 6, 6, 6} |
| | 6 | 3 | 4 | {2, 2, 2, 2} | {2, 2, 2} |
| | 8 | 3 | 4 | {4, 2, 2, 2} | {4, 2, 2} |
| | 6 | 3 | 4 | {4, 2, 2, 2} | {2, 2, 2} |
| | 10 | 3 | 4 | {6, 2, 2, 2} | {6, 2, 2} |
| | 6 | 3 | 4 | {6, 2, 2, 2} | {2, 2, 2} |
| | 12 | 3 | 4 | {2, 4, 6, 2} | {2, 4, 6} |
| | 8 | 3 | 4 | {2, 4, 6, 2} | {2, 4, 2} |
| | 10 | 3 | 4 | {2, 4, 6, 2} | {2, 6, 2} |
| | 12 | 3 | 4 | {2, 4, 6, 4} | {2, 4, 6} |
| | 10 | 3 | 4 | {2, 4, 6, 4} | {2, 4, 4} |
| | 14 | 3 | 4 | {2, 4, 6, 4} | {4, 6, 4} |
| | 12 | 3 | 4 | {2, 4, 6, 6} | {2, 4, 6} |
| | 14 | 3 | 4 | {2, 4, 6, 6} | {2, 6, 6} |
| | 16 | 3 | 4 | {2, 4, 6, 6} | {4, 6, 6} |
| | 12 | 3 | 4 | {4, 4, 4, 2} | {4, 4, 4} |
| | 10 | 3 | 4 | {4, 4, 4, 2} | {4, 4, 2} |
| | 12 | 3 | 4 | {4, 4, 4, 4} | {4, 4, 4} |
| | 12 | 3 | 4 | {4, 4, 4, 6} | {4, 4, 4} |
| | 14 | 3 | 4 | {4, 4, 4, 6} | {4, 4, 6} |
| | 10 | 3 | 4 | {2, 2, 6, 6} | {2, 2, 6} |
| | 14 | 3 | 4 | {2, 2, 6, 6} | {2, 6, 6} |
| | 10 | 3 | 4 | {4, 4, 2, 2} | {4, 4, 2} |
| | 8 | 3 | 4 | {4, 4, 2, 2} | {4, 2, 2} |
| | 14 | 3 | 4 | {4, 4, 6, 6} | {4, 4, 6} |
| | 16 | 3 | 4 | {4, 4, 6, 6} | {4, 6, 6} |
| | 18 | 3 | 4 | {6, 6, 6, 2} | {6, 6, 6} |
| | 14 | 3 | 4 | {6, 6, 6, 2} | {6, 6, 2} |
| | 18 | 3 | 4 | {6, 6, 6, 4} | {6, 6, 6} |
| | 16 | 3 | 4 | {6, 6, 6, 4} | {6, 6, 4} |
| | 18 | 3 | 4 | {6, 6, 6, 6} | {6, 6, 6} |
| | 4 | 2 | 4 | {2, 2, 2, 2} | {2, 2} |
| | 6 | 2 | 4 | {4, 2, 2, 2} | {4, 2} |
| | 4 | 2 | 4 | {4, 2, 2, 2} | {2, 2} |
| | 8 | 2 | 4 | {6, 2, 2, 2} | {6, 2} |
| | 4 | 2 | 4 | {6, 2, 2, 2} | {2, 2} |
| | 6 | 2 | 4 | {2, 4, 6, 2} | {2, 4} |
| | 8 | 2 | 4 | {2, 4, 6, 2} | {2, 6} |
| | 4 | 2 | 4 | {2, 4, 6, 2} | {2, 2} |
| | 10 | 2 | 4 | {2, 4, 6, 2} | {4, 6} |
| | 8 | 2 | 4 | {2, 4, 6, 4} | {2, 6} |
| | 6 | 2 | 4 | {2, 4, 6, 4} | {2, 4} |
| | 10 | 2 | 4 | {2, 4, 6, 4} | {6, 4} |
| | 8 | 2 | 4 | {2, 4, 6, 4} | {4, 4} |
| | 6 | 2 | 4 | {2, 4, 6, 6} | {2, 4} |
| | 8 | 2 | 4 | {2, 4, 6, 6} | {2, 6} |
| | 10 | 2 | 4 | {2, 4, 6, 6} | {4, 6} |
| | 12 | 2 | 4 | {2, 4, 6, 6} | {6, 6} |
| | 8 | 2 | 4 | {4, 4, 4, 2} | {4, 4} |
| | 6 | 2 | 4 | {4, 4, 4, 2} | {4, 2} |
| | 8 | 2 | 4 | {4, 4, 4, 4} | {4, 4} |
| | 8 | 2 | 4 | {4, 4, 4, 6} | {4, 4} |
| | 10 | 2 | 4 | {4, 4, 4, 6} | {4, 6} |
| | 4 | 2 | 4 | {2, 2, 6, 6} | {2, 2} |
| | 8 | 2 | 4 | {2, 2, 6, 6} | {2, 6} |
| | 12 | 2 | 4 | {2, 2, 6, 6} | {6, 6} |
| | 8 | 2 | 4 | {4, 4, 2, 2} | {4, 4} |
| | 6 | 2 | 4 | {4, 4, 2, 2} | {4, 2} |
| | 4 | 2 | 4 | {4, 4, 2, 2} | {2, 2} |
| | 8 | 2 | 4 | {4, 4, 6, 6} | {4, 4} |
| | 10 | 2 | 4 | {4, 4, 6, 6} | {4, 6} |
| | 12 | 2 | 4 | {4, 4, 6, 6} | {6, 6} |
| | 12 | 2 | 4 | {6, 6, 6, 2} | {6, 6} |
| | 8 | 2 | 4 | {6, 6, 6, 2} | {6, 2} |
| | 12 | 2 | 4 | {6, 6, 6, 4} | {6, 6} |
| | 10 | 2 | 4 | {6, 6, 6, 4} | {6, 4} |
| | 12 | 2 | 4 | {6, 6, 6, 6} | {6, 6} |
| | 2 | 1 | 4 | {2, 2, 2, 2} | {2} |
| | 4 | 1 | 4 | {4, 2, 2, 2} | {4} |
| | 2 | 1 | 4 | {4, 2, 2, 2} | {2} |
| | 6 | 1 | 4 | {6, 2, 2, 2} | {6} |
| | 2 | 1 | 4 | {6, 2, 2, 2} | {2} |
| | 4 | 1 | 4 | {2, 4, 6, 2} | {4} |
| | 6 | 1 | 4 | {2, 4, 6, 2} | {6} |
| | 2 | 1 | 4 | {2, 4, 6, 2} | {2} |
| | 2 | 1 | 4 | {2, 4, 6, 4} | {2} |
| | 4 | 1 | 4 | {2, 4, 6, 4} | {4} |
| | 6 | 1 | 4 | {2, 4, 6, 4} | {6} |
| | 2 | 1 | 4 | {2, 4, 6, 6} | {2} |
| | 4 | 1 | 4 | {2, 4, 6, 6} | {4} |
| | 6 | 1 | 4 | {2, 4, 6, 6} | {6} |
| | 4 | 1 | 4 | {4, 4, 4, 2} | {4} |
| | 2 | 1 | 4 | {4, 4, 4, 2} | {2} |
| | 4 | 1 | 4 | {4, 4, 4, 4} | {4} |
| | 4 | 1 | 4 | {4, 4, 4, 6} | {4} |
| | 6 | 1 | 4 | {4, 4, 4, 6} | {6} |
| | 2 | 1 | 4 | {2, 2, 6, 6} | {2} |
| | 6 | 1 | 4 | {2, 2, 6, 6} | {6} |
| | 4 | 1 | 4 | {4, 4, 2, 2} | {4} |
| | 2 | 1 | 4 | {4, 4, 2, 2} | {2} |
| | 4 | 1 | 4 | {4, 4, 6, 6} | {4} |
| | 6 | 1 | 4 | {4, 4, 6, 6} | {6} |
| | 6 | 1 | 4 | {6, 6, 6, 2} | {6} |
| | 2 | 1 | 4 | {6, 6, 6, 2} | {2} |
| | 6 | 1 | 4 | {6, 6, 6, 4} | {6} |
| | 4 | 1 | 4 | {6, 6, 6, 4} | {4} |
| | 6 | 1 | 4 | {6, 6, 6, 6} | {6} |

In some embodiments, the candidate values for combination of Lₜ and N_{TRP} or N may be the first combination of Table 5 that shows candidate values for Lₜ and Table 6 that shows candidate values for pᵥ and β.

TABLE 5
Lₜ
2
4
6

TABLE 6

| p_{ν} | | |
|---|---|---|
| ν ∈ {1, 2} | ν ∈ {3, 4} | β |
| ¼ | 1/8 | ¼ |
| ¼ | 1/8 | ½ |
| ¼ | ¼ | ¾ |
| ½ | ¼ | ½ |
| ¼ | — | ½ |
| ¼ | — | ¾ |
| 1/8 | 1/16 | ¼ |
| 1/8 | 1/16 | ½ |
| 1/8 | 1/16 | ¾ |
| 1/8 | 1/16 | 1/8 |
| ½ | ½ | 1/8 |
| ¼ | 1/8 | 1/8 |
| ¼ | ¼ | 1/8 |
| ½ | ¼ | 1/8 |

In some embodiments, candidate values for enhancement may be based on Rel-17 codebook. For example, the second type of codebook. The maximum number of non zero coefficients per layer may be

$${K}_{0} = ⌈ β * P * {\sum }_{t = 1}^{{N}_{TRP}} {α}_{t} M ⌉ .$$

In some embodiments, table 7 below shows candidates values for Lₜ (for example, the first vector). In some embodiments, table 8 below shows candidates value for αₜ. In some embodiments, table 9 shows candidate values for M. In some embodiments, table 10 below shows candidates values for β (for example, the first parameter). In this case, the first combination may be from Tables 7-10. Table 11 shows an example of the first combination (for example, candidate values for combination of αₜ and N_{TRP} or N). It is noted that the values shown in Tables 7-11 are only examples not limitations and orders of the values shown in Tables 7-11 are also examples. In some embodiments, a subset of columns and/or rows in Table 7 and/or Table 8 and/or Table 9 and/or Table 10 and/or Table 11 may be applied for some embodiments in this disclosure. In some embodiments, the order of index t corresponding to the values “αₜ configured for N_{TRP}” in the Table 11 may be changed. In some embodiments, the order of index t corresponding to the values “αₜ configured for N_{TRP}” in the Table 11 may be t={1,2} or {2,1} or {1,2,3} or {1,3,2} or {2,3,1} or {2,1,3} or {3,1,2} or {3,2,1} or {1,2,3,4} or {1,2,4,3}1 or {1,3,2,4} or {1,3,4,2} or {1,4,2,3} or {1,4,3,2} or {2,1,3,4} or {2,1,4,3} or {2,3,1,4} or {2,3,4,1}2341 or {2,4,1,3} or {2,4,3,1} or {3,1,2,4} or {3,1,4,2} or {3,2,1,4} or {3,2,4,1} or {3,4,1,2} or 5 {3,4,2,1} or {4,1,2,3} or {4,1,3,2} or {4,2,1,3} or {4,2,3,1} or {4,3,1,2} or {4,3,2,1}.

TABLE 7
Lₜ

1
2
3
4
6
8
9
12
16

TABLE 8
αₜ
½
¾
1

TABLE 9
M
1
2

TABLE 10
β
1/8
½
¾
1
¼

TABLE 11

| | | | | | αₜ configured for | |
|---|---|---|---|---|---|---|
| Lₘₐₓ | Lₜₒₜ | N | N_{TRP} | P | N_{TRP} 1/2, 3/4, 1 | Lₜ selected |
| | 2 | 2 | 2 | 4 | {1/2, 1/2} | {1, 1} |
| | 3 | 2 | 2 | | {1/2, 1} | {1, 2} |
| | 4 | 2 | 2 | | {1, 1} | {2, 2} |
| | 1 | 1 | 2 | | {1/2, 1/2} | {1} |
| | 1 | 1 | 2 | | {1/2, 1} | {1} |
| | 2 | 1 | 2 | | {1/2, 1} | {2} |
| | 2 | 1 | 2 | | {1, 1} | {2} |
| | 3 | 3 | 3 | | {1/2, 1/2, 1/2} | {1, 1, 1} |
| | 4 | 3 | 3 | | {1/2, 1/2, 1} | {1, 1, 2} |
| | 5 | 3 | 3 | | {1/2, 1, 1} | {1, 2, 2} |
| | 6 | 3 | 3 | | {1, 1, 1} | {2, 2, 2} |
| | 2 | 2 | 3 | | {1/2, 1/2, 1/2} | {1, 1} |
| | 2 | 2 | 3 | | {1/2, 1/2, 1} | {1, 1} |
| | 3 | 2 | 3 | | {1/2, 1/2, 1} | 1, 2} |
| | 3 | 2 | 3 | | {1/2, 1, 1} | {1, 2} |
| | 4 | 2 | 3 | | {1/2, 1, 1} | {2, 2} |
| | 4 | 2 | 3 | | {1, 1, 1} | {2, 2} |
| | 1 | 1 | 3 | | {1/2, 1/2, 1/2} | {1} |
| | 1 | 1 | 3 | | {1/2, 1/2, 1} | {1} |
| | 2 | 1 | 3 | | {1/2, 1/2, 1} | {2} |
| | 1 | 1 | 3 | | {1/2, 1, 1} | {1} |
| | 2 | 1 | 3 | | {1/2, 1, 1} | {2} |
| | 4 | 4 | 4 | | {1/2, 1/2, 1/2, 1/2} | {1, 1, 1, 1} |
| | 5 | 4 | 4 | | {1/2, 1/2, 1/2, 1} | {1, 1, 1, 2} |
| | 6 | 4 | 4 | | {1/2, 1/2, 1, 1} | {1, 1, 2, 2} |
| | 7 | 4 | 4 | | {1/2, 1, 1, 1} | {1, 2, 2, 2} |
| | 8 | 4 | 4 | | {1, 1, 1, 1} | {2, 2, 2, 2} |
| | 3 | 3 | 4 | | {1/2, 1/2, 1/2, 1/2} | {1, 1, 1} |
| | 3 | 3 | 4 | | {1/2, 1/2, 1/2, 1} | {1, 1, 1} |
| | 4 | 3 | 4 | | {1/2, 1/2, 1/2, 1} | {1, 1, 2} |
| | 4 | 3 | 4 | | {1/2, 1/2, 1, 1} | {1, 1, 2} |
| | 5 | 3 | 4 | | {1/2, 1/2, 1, 1} | {1, 2, 2} |
| | 5 | 3 | 4 | | {1/2, 1, 1, 1} | {1, 2, 2} |
| | 6 | 3 | 4 | | {1/2, 1, 1, 1} | {2, 2, 2} |
| | 6 | 3 | 4 | | {1, 1, 1, 1} | {2, 2, 2} |
| | 2 | 2 | 4 | | {1/2, 1/2, 1/2, 1/2} | {1, 1} |
| | 2 | 2 | 4 | | {1/2, 1/2, 1/2, 1} | {1, 1} |
| | 3 | 2 | 4 | | {1/2, 1/2, 1/2, 1} | {1, 2} |
| | 2 | 2 | 4 | | {1/2, 1/2, 1, 1} | {1, 1} |
| | 3 | 2 | 4 | | {1/2, 1/2, 1, 1} | {1, 2} |
| | 4 | 2 | 4 | | {1/2, 1/2, 1, 1} | {2, 2} |
| | 3 | 2 | 4 | | {1/2, 1, 1, 1} | {1, 2} |
| | 4 | 2 | 4 | | {1/2, 1, 1, 1} | {2, 2} |
| | 4 | 2 | 4 | | {1, 1, 1, 1} | {2, 2} |
| | 1 | 1 | 4 | | {1/2, 1/2, 1/2, 1/2} | {1} |
| | 1 | 1 | 4 | | {1/2, 1/2, 1/2, 1} | {1} |
| | 2 | 1 | 4 | | {1/2, 1/2, 1/2, 1} | {2} |
| | 1 | 1 | 4 | | {1/2, 1/2, 1, 1} | {1} |
| | 2 | 1 | 4 | | {1/2, 1/2, 1, 1} | {2} |
| | 1 | 1 | 4 | | {1/2, 1, 1, 1} | {1} |
| | 2 | 1 | 4 | | {1/2, 1, 1, 1} | {2} |
| | 2 | 1 | 4 | | {1, 1, 1, 1} | {2} |
| | 4 | 2 | 2 | 8 | {1/2, 1/2} | {2, 2} |
| | 5 | 2 | 2 | | {1/2, 3/4} | {2, 3} |
| | 6 | 2 | 2 | | {1/2, 1} | {2, 4} |
| | 6 | 2 | 2 | | {3/4, 3/4} | {3, 3} |
| | 7 | 2 | 2 | | {3/4, 1} | {3, 4} |
| | 8 | 2 | 2 | | {1, 1} | {4, 4} |
| | 2 | 1 | 2 | | {1/2, 1/2} | {2} |
| | 2 | 1 | 2 | | {1/2, 3/4} | {2} |
| | 3 | 1 | 2 | | {1/2, 3/4} | {3} |
| | 2 | 1 | 2 | | {1/2, 1} | {2} |
| | 4 | 1 | 2 | | {1/2, 1} | {4} |
| | 3 | 1 | 2 | | {3/4, 3/4} | {3} |
| | 3 | 1 | 2 | | {3/4, 1} | {3} |
| | 4 | 1 | 2 | | {3/4, 1} | {4} |
| | 4 | 1 | 2 | | {1, 1} | {4} |
| | 6 | 3 | 3 | | {1/2, 1/2, 1/2} | {2, 2, 2} |
| | 7 | 3 | 3 | | {3/4, 1/2, 1/2} | {3, 2, 2} |
| | 8 | 3 | 3 | | {1, 1/2, 1/2} | {4, 2, 2} |
| | 9 | 3 | 3 | | {1/2, 3/4, 1} | {2, 3, 4} |
| | 9 | 3 | 3 | | {3/4, 3/4, 3/4} | {3, 3, 3} |
| | 8 | 3 | 3 | | {3/4, 3/4, 1/2} | {3, 3, 2} |
| | 10 | 3 | 3 | | {3/4, 3/4, 1} | {3, 3, 4} |
| | 11 | 3 | 3 | | {1, 1, 3/4} | {4, 4, 3} |
| | 12 | 3 | 3 | | {1, 1, 1} | {4, 4, 4} |
| | 4 | 2 | 3 | | {1/2, 1/2, 1/2} | {2, 2} |
| | 5 | 2 | 3 | | {3/4, 1/2, 1/2} | {3, 2} |
| | 4 | 2 | 3 | | {3/4, 1/2, 1/2} | {2, 2} |
| | 6 | 2 | 3 | | {1, 1/2, 1/2} | {4, 2} |
| | 4 | 2 | 3 | | {1, 1/2, 1/2} | {2, 2} |
| | 5 | 2 | 3 | | {1/2, 3/4, 1} | {2, 3} |
| | 6 | 2 | 3 | | {1/2, 3/4, 1} | {2, 4} |
| | 7 | 2 | 3 | | {1/2, 3/4, 1} | {3, 4} |
| | 6 | 2 | 3 | | {3/4, 3/4, 3/4} | {3, 3} |
| | 5 | 2 | 3 | | {3/4, 3/4, 1/2} | {3, 2} |
| | 6 | 2 | 3 | | {3/4, 3/4, 1/2} | {3, 3} |
| | 7 | 2 | 3 | | {3/4, 3/4, 1} | {3, 4} |
| | 6 | 2 | 3 | | {3/4, 3/4, 1} | {3, 3} |
| | 8 | 2 | 3 | | {1, 1, 3/4} | {4, 4} |
| | 7 | 2 | 3 | | {1, 1, 3/4} | {4, 3} |
| | 8 | 2 | 3 | | {1, 1, 1} | {4, 4} |
| | 2 | 1 | 3 | | {1/2, 1/2, 1/2} | {2} |
| | 3 | 1 | 3 | | {3/4, 1/2, 1/2} | {3} |
| | 2 | 1 | 3 | | {3/4, 1/2, 1/2} | {2} |
| | 4 | 1 | 3 | | {1, 1/2, 1/2} | {4} |
| | 2 | 1 | 3 | | {1, 1/2, 1/2} | {2} |
| | 2 | 1 | 3 | | {1/2, 3/4, 1} | {2} |
| | 3 | 1 | 3 | | {1/2, 3/4, 1} | {3} |
| | 4 | 1 | 3 | | {1/2, 3/4, 1} | {4} |
| | 3 | 1 | 3 | | {3/4, 3/4, 3/4} | {3} |
| | 2 | 1 | 3 | | {3/4, 3/4, 1/2} | {2} |
| | 3 | 1 | 3 | | {3/4, 3/4, 1/2} | {3} |
| | 3 | 1 | 3 | | {3/4, 3/4, 1} | {3} |
| | 4 | 1 | 3 | | {3/4, 3/4, 1} | {4} |
| | 4 | 1 | 3 | | {1, 1, 3/4} | {4} |
| | 3 | 1 | 3 | | {1, 1, 3/4} | {3} |
| | 4 | 1 | 3 | | {1, 1, 1} | {4} |
| | 8 | 4 | 4 | | {1/2, 1/2, 1/2, 1/2} | {2, 2, 2, 2} |
| | 9 | 4 | 4 | | {3/4, 1/2, 1/2, 1/2} | {3, 2, 2, 2} |
| | 10 | 4 | 4 | | {1, 1/2, 1/2, 1/2} | {4, 2, 2, 2} |
| | 11 | 4 | 4 | | {1/2, 3/4, 1, 1/2} | {2, 3, 4, 2} |
| | 12 | 4 | 4 | | {1/2, 3/4, 1, 3/4} | {2, 3, 4, 3} |
| | 13 | 4 | 4 | | {1/2, 3/4, 1, 1} | {2, 3, 4, 4} |
| | 11 | 4 | 4 | | {3/4, 3/4, 3/4, 1/2} | {3, 3, 3, 2} |
| | 12 | 4 | 4 | | {3/4, 3/4, 3/4, 3/4} | {3, 3, 3, 3} |
| | 13 | 4 | 4 | | {3/4, 3/4, 3/4, 1} | {3, 3, 3, 4} |
| | 12 | 4 | 4 | | {1/2, 1/2, 1, 1} | {2, 2, 4, 4} |
| | 10 | 4 | 4 | | {3/4, 3/4, 1/2, 1/2} | {3, 3, 2, 2} |
| | 14 | 4 | 4 | | {3/4, 3/4, 1, 1} | {3, 3, 4, 4} |
| | 14 | 4 | 4 | | {1, 1, 1, 1/2} | {4, 4, 4, 2} |
| | 15 | 4 | 4 | | {1, 1, 1, 3/4} | {4, 4, 4, 3} |
| | 16 | 4 | 4 | | {1, 1, 1, 1} | {4, 4, 4, 4} |
| | 6 | 3 | 4 | | {1/2, 1/2, 1/2, 1/2} | {2, 2, 2} |
| | 7 | 3 | 4 | | {3/4, 1/2, 1/2, 1/2} | {3, 2, 2} |
| | 6 | 3 | 4 | | {3/4, 1/2, 1/2, 1/2} | {2, 2, 2} |
| | 8 | 3 | 4 | | {1, 1/2, 1/2, 1/2} | {4, 2, 2} |
| | 6 | 3 | 4 | | {1, 1/2, 1/2, 1/2} | {2, 2, 2} |
| | 9 | 3 | 4 | | {1/2, 3/4, 1, 1/2} | {2, 3, 4} |
| | 7 | 3 | 4 | | {1/2, 3/4, 1, 1/2} | {2, 3, 2} |
| | 8 | 3 | 4 | | {1/2, 3/4, 1, 1/2} | {2, 4, 2} |
| | 9 | 3 | 4 | | {1/2, 3/4, 1, 3/4} | {2, 3, 4} |
| | 8 | 3 | 4 | | {1/2, 3/4, 1, 3/4} | {2, 3, 3} |
| | 10 | 3 | 4 | | {1/2, 3/4, 1, 3/4} | {3, 4, 3} |
| | 9 | 3 | 4 | | {1/2, 3/4, 1, 1} | {2, 3, 4} |
| | 10 | 3 | 4 | | {1/2, 3/4, 1, 1} | {2, 4, 4} |
| | 11 | 3 | 4 | | {1/2, 3/4, 1, 1} | {3, 4, 4} |
| | 9 | 3 | 4 | | {3/4, 3/4, 3/4, 1/2} | {3, 3, 3} |
| | 8 | 3 | 4 | | {3/4, 3/4, 3/4, 1/2} | {3, 3, 2} |
| | 9 | 3 | 4 | | {3/4, 3/4, 3/4, 3/4} | {3, 3, 3} |
| | 9 | 3 | 4 | | {3/4, 3/4, 3/4, 1} | {3, 3, 3} |
| | 10 | 3 | 4 | | {3/4, 3/4, 3/4, 1} | {3, 3, 4} |
| | 8 | 3 | 4 | | {1/2, 1/2, 1, 1} | {2, 2, 4} |
| | 10 | 3 | 4 | | {1/2, 1/2, 1, 1} | {2, 4, 4} |
| | 8 | 3 | 4 | | {3/4, 3/4, 1/2, 1/2} | {3, 3, 2} |
| | 7 | 3 | 4 | | {3/4, 3/4, 1/2, 1/2} | {3, 2, 2} |
| | 10 | 3 | 4 | | {3/4, 3/4, 1, 1} | {3, 3, 4} |
| | 11 | 3 | 4 | | {3/4, 3/4, 1, 1} | {3, 4, 4} |
| | 12 | 3 | 4 | | {1, 1, 1, 1/2} | {4, 4, 4} |
| | 10 | 3 | 4 | | {1, 1, 1, 1/2} | {4, 4, 2} |
| | 12 | 3 | 4 | | {1, 1, 1, 3/4} | {4, 4, 4} |
| | 11 | 3 | 4 | | {1, 1, 1, 3/4} | {4, 4, 3} |
| | 18 | 3 | 4 | | {1, 1, 1, 1} | {4, 4, 4} |
| | 4 | 2 | 4 | | {1/2, 1/2, 1/2, 1/2} | {2, 2} |
| | 5 | 2 | 4 | | {3/4, 1/2, 1/2, 1/2} | {3, 2} |
| | 4 | 2 | 4 | | {3/4, 1/2, 1/2, 1/2} | {2, 2} |
| | 6 | 2 | 4 | | {1, 1/2, 1/2, 1/2} | {4, 2} |
| | 4 | 2 | 4 | | {1, 1/2, 1/2, 1/2} | {2, 2} |
| | 5 | 2 | 4 | | {1/2, 3/4, 1, 1/2} | {2, 3} |
| | 6 | 2 | 4 | | {1/2, 3/4, 1, 1/2} | {2, 4} |
| | 4 | 2 | 4 | | {1/2, 3/4, 1, 1/2} | {2, 2} |
| | 7 | 2 | 4 | | {1/2, 3/4, 1, 1/2} | {3, 4} |
| | 6 | 2 | 4 | | {1/2, 3/4, 1, 3/4} | {2, 4} |
| | 5 | 2 | 4 | | {1/2, 3/4, 1, 3/4} | {2, 3} |
| | 7 | 2 | 4 | | {1/2, 3/4, 1, 3/4} | {4, 3} |
| | 6 | 2 | 4 | | {1/2, 3/4, 1, 3/4} | {3, 3} |
| | 5 | 2 | 4 | | {1/2, 3/4, 1, 1} | {2, 3} |
| | 6 | 2 | 4 | | {1/2, 3/4, 1, 1} | {2, 4} |
| | 7 | 2 | 4 | | {1/2, 3/4, 1, 1} | {3, 4} |
| | 8 | 2 | 4 | | {1/2, 3/4, 1, 1} | {4, 4} |
| | 6 | 2 | 4 | | {3/4, 3/4, 3/4, 1/2} | {3, 3} |
| | 5 | 2 | 4 | | {3/4, 3/4, 3/4, 1/2} | {3, 2} |
| | 6 | 2 | 4 | | {3/4, 3/4, 3/4, 3/4} | {3, 3} |
| | 6 | 2 | 4 | | {3/4, 3/4, 3/4, 1} | {3, 3} |
| | 7 | 2 | 4 | | {3/4, 3/4, 3/4, 1} | {3, 4} |
| | 4 | 2 | 4 | | {1/2, 1/2, 1, 1} | {2, 2} |
| | 6 | 2 | 4 | | {1/2, 1/2, 1, 1} | {2, 4} |
| | 8 | 2 | 4 | | {1/2, 1/2, 1, 1} | {4, 4} |
| | 6 | 2 | 4 | | {3/4, 3/4, 1/2, 1/2} | {3, 3} |
| | 5 | 2 | 4 | | {3/4, 3/4, 1/2, 1/2} | {3, 2} |
| | 4 | 2 | 4 | | {3/4, 3/4, 1/2, 1/2} | {2, 2} |
| | 6 | 2 | 4 | | {3/4, 3/4, 1, 1} | {3, 3} |
| | 7 | 2 | 4 | | {3/4, 3/4, 1, 1} | {3, 4} |
| | 8 | 2 | 4 | | {3/4, 3/4, 1, 1} | {4, 4} |
| | 8 | 2 | 4 | | {1, 1, 1, 1/2} | {4, 4} |
| | 6 | 2 | 4 | | {1, 1, 1, 1/2} | {4, 2} |
| | 8 | 2 | 4 | | {1, 1, 1, 3/4} | {4, 4} |
| | 7 | 2 | 4 | | {1, 1, 1, 3/4} | {4, 3} |
| | 8 | 2 | 4 | | {1, 1, 1, 1} | {4, 4} |
| | 2 | 1 | 4 | | {1/2, 1/2, 1/2, 1/2} | {2} |
| | 3 | 1 | 4 | | {3/4, 1/2, 1/2, 1/2} | {3} |
| | 2 | 1 | 4 | | {3/4, 1/2, 1/2, 1/2} | {2} |
| | 4 | 1 | 4 | | {1, 1/2, 1/2, 1/2} | {4} |
| | 2 | 1 | 4 | | {1, 1/2, 1/2, 1/2} | {2} |
| | 3 | 1 | 4 | | {1/2, 3/4, 1, 1/2} | {3} |
| | 4 | 1 | 4 | | {1/2, 3/4, 1, 1/2} | {4} |
| | 2 | 1 | 4 | | {1/2, 3/4, 1, 1/2} | {2} |
| | 2 | 1 | 4 | | {1/2, 3/4, 1, 3/4} | {2} |
| | 3 | 1 | 4 | | {1/2, 3/4, 1, 3/4} | {3} |
| | 4 | 1 | 4 | | {1/2, 3/4, 1, 3/4} | {4} |
| | 2 | 1 | 4 | | {1/2, 3/4, 1, 1} | {2} |
| | 3 | 1 | 4 | | {1/2, 3/4, 1, 1} | {3} |
| | 4 | 1 | 4 | | {1/2, 3/4, 1, 1} | {4} |
| | 3 | 1 | 4 | | {3/4, 3/4, 1/2, 1/2} | {3} |
| | 2 | 1 | 4 | | {3/4, 3/4, 1/2, 1/2} | {2} |
| | 3 | 1 | 4 | | {3/4, 3/4, 3/4, 3/4} | {3} |
| | 3 | 1 | 4 | | {3/4, 3/4, 3/4, 1} | {3} |
| | 4 | 1 | 4 | | {3/4, 3/4, 3/4, 1} | {4} |
| | 2 | 1 | 4 | | {1/2, 1/2, 1, 1} | {2} |
| | 4 | 1 | 4 | | {1/2, 1/2, 1, 1} | {4} |
| | 3 | 1 | 4 | | {3/4, 3/4, 1/2, 1/2} | {3} |
| | 2 | 1 | 4 | | {3/4, 3/4, 1/2, 1/2} | {2} |
| | 3 | 1 | 4 | | {3/4, 3/4, 1, 1} | {3} |
| | 4 | 1 | 4 | | {3/4, 3/4, 1, 1} | {4} |
| | 4 | 1 | 4 | | {1, 1, 1, 1/2} | {4} |
| | 2 | 1 | 4 | | {1, 1, 1, 1/2} | {2} |
| | 4 | 1 | 4 | | {1, 1, 1, 3/4} | {4} |
| | 3 | 1 | 4 | | {1, 1, 1, 3/4} | {3} |
| | 4 | 1 | 4 | | {1, 1, 1, 1} | {4} |
| | 6 | 2 | 2 | 12 | {1/2, 1/2} | {3, 3} |
| | 9 | 2 | 2 | | {1/2, 1} | {3, 6} |
| | 12 | 2 | 2 | | {1, 1} | {6, 6} |
| | 3 | 1 | 2 | | {1/2, 1/2} | {3} |
| | 3 | 1 | 2 | | {1/2, 1} | {3} |
| | 6 | 1 | 2 | | {1/2, 1} | {6} |
| | 6 | 1 | 2 | | {3/4, 1} | {6} |
| | 6 | 1 | 2 | | {1, 1} | {6} |
| | 9 | 3 | 3 | | {1/2, 1/2, 1/2} | {3, 3, 3} |
| | 12 | 3 | 3 | | {1, 1/2, 1/2} | {6, 3, 3} |
| | 18 | 3 | 3 | | {1, 1, 1} | {6, 6, 6} |
| | 6 | 2 | 3 | | {1/2, 1/2, 1/2} | {3, 3} |
| | 9 | 2 | 3 | | {1, 1/2, 1/2} | {6, 3} |
| | 6 | 2 | 3 | | {1, 1/2, 1/2} | {3, 3} |
| | 12 | 2 | 3 | | {1, 1, 1} | {6, 6} |
| | 3 | 1 | 3 | | {1/2, 1/2, 1/2} | {3} |
| | 6 | 1 | 3 | | {1, 1/2, 1/2} | {6} |
| | 3 | 1 | 3 | | {1, 1/2, 1/2} | {3} |
| | 6 | 1 | 3 | | {1, 1, 1} | {6} |
| | 12 | 4 | 4 | | {1/2, 1/2, 1/2, 1/2} | {3, 3, 3, 3} |
| | 15 | 4 | 4 | | {1, 1/2, 1/2, 1/2} | {6, 3, 3, 3} |
| | 18 | 4 | 4 | | {1/2, 1/2, 1, 1} | {3, 3, 6, 6} |
| | 21 | 4 | 4 | | {1, 1, 1, 1/2} | {6, 6, 6, 3} |
| | 24 | 4 | 4 | | {1, 1, 1, 1} | {6, 6, 6, 6} |
| | 9 | 3 | 4 | | {1/2, 1/2, 1/2, 1/2} | {3, 3, 3} |
| | 12 | 3 | 4 | | {1, 1/2, 1/2, 1/2} | {6, 3, 3} |
| | 9 | 3 | 4 | | {1, 1/2, 1/2, 1/2} | {3, 3, 3} |
| | 18 | 3 | 4 | | {1, 1, 1, 1/2} | {6, 6, 6} |
| | 15 | 3 | 4 | | {1, 1, 1, 1/2} | {6, 6, 3} |
| | 27 | 3 | 4 | | {1, 1, 1, 1} | {6, 6, 6} |
| | 6 | 2 | 4 | | {1/2, 1/2, 1/2, 1/2} | {3, 3} |
| | 9 | 2 | 4 | | {1, 1/2, 1/2, 1/2} | {6, 3} |
| | 6 | 2 | 4 | | {1, 1/2, 1/2, 1/2} | {3, 3} |
| | 6 | 2 | 4 | | {1/2, 1/2, 1, 1} | {3, 3} |
| | 9 | 2 | 4 | | {1/2, 1/2, 1, 1} | {3, 6} |
| | 12 | 2 | 4 | | {1/2, 1/2, 1, 1} | {6, 6} |
| | 12 | 2 | 4 | | {1, 1, 1, 1/2} | {6, 6} |
| | 9 | 2 | 4 | | {1, 1, 1, 1/2} | {6, 3} |
| | 12 | 2 | 4 | | {1, 1, 1, 1} | {6, 6} |
| | 3 | 1 | 4 | | {1/2, 1/2, 1/2, 1/2} | {3} |
| | 6 | 1 | 4 | | {1, 1/2, 1/2, 1/2} | {6} |
| | 3 | 1 | 4 | | {1, 1/2, 1/2, 1/2} | {3} |
| | 3 | 1 | 4 | | {1/2, 1/2, 1, 1} | {3} |
| | 6 | 1 | 4 | | {1/2, 1/2, 1, 1} | {6} |
| | 6 | 1 | 4 | | {1, 1, 1, 1/2} | {6} |
| | 3 | 1 | 4 | | {1, 1, 1, 1/2} | {3} |
| | 6 | 1 | 4 | | {1, 1, 1, 1} | {6} |
| | 8 | 2 | 2 | 16 | {1/2, 1/2} | {4, 4} |
| | 10 | 2 | 2 | | {1/2, 3/4} | {4, 6} |
| | 12 | 2 | 2 | | {1/2, 1} | {4, 8} |
| | 12 | 2 | 2 | | {3/4, 3/4} | {6, 6} |
| | 14 | 2 | 2 | | {3/4, 1} | {6, 8} |
| | 16 | 2 | 2 | | {1, 1} | {8, 8} |
| | 4 | 1 | 2 | | {1/2, 1/2} | {4} |
| | 4 | 1 | 2 | | {1/2, 3/4} | {4} |
| | 6 | 1 | 2 | | {1/2, 3/4} | {6} |
| | 4 | 1 | 2 | | {1/2, 1} | {4} |
| | 8 | 1 | 2 | | {1/2, 1} | {8} |
| | 6 | 1 | 2 | | {3/4, 3/4} | {6} |
| | 6 | 1 | 2 | | {3/4, 1} | {6} |
| | 8 | 1 | 2 | | {3/4, 1} | {8} |
| | 8 | 1 | 2 | | {1, 1} | {8} |
| | 12 | 3 | 3 | | {1/2, 1/2, 1/2} | {4, 4, 4} |
| | 14 | 3 | 3 | | {3/4, 1/2, 1/2} | {6, 4, 4} |
| | 16 | 3 | 3 | | {1, 1/2, 1/2} | {8, 4, 4} |
| | 18 | 3 | 3 | | {1/2, 3/4, 1} | {4, 6, 8} |
| | 18 | 3 | 3 | | {3/4, 3/4, 3/4} | {6, 6, 6} |
| | 16 | 3 | 3 | | {3/4, 3/4, 1/2} | {6, 6, 4} |
| | 20 | 3 | 3 | | {3/4, 3/4, 1} | {6, 6, 8} |
| | 22 | 3 | 3 | | {1, 1, 3/4} | {8, 8, 6} |
| | 24 | 3 | 3 | | {1, 1, 1} | {8, 8, 8} |
| | 8 | 2 | 3 | | {1/2, 1/2, 1/2} | {4, 4} |
| | 10 | 2 | 3 | | {3/4, 1/2, 1/2} | {6, 4} |
| | 8 | 2 | 3 | | {3/4, 1/2, 1/2} | {4, 4} |
| | 12 | 2 | 3 | | {1, 1/2, 1/2} | {8, 4} |
| | 8 | 2 | 3 | | {1, 1/2, 1/2} | {4, 4} |
| | 10 | 2 | 3 | | {1/2, 3/4, 1} | {4, 6} |
| | 12 | 2 | 3 | | {1/2, 3/4, 1} | {4, 8} |
| | 14 | 2 | 3 | | {1/2, 3/4, 1} | {6, 8} |
| | 12 | 2 | 3 | | {3/4, 3/4, 3/4} | {6, 6} |
| | 10 | 2 | 3 | | {3/4, 3/4, 1/2} | {6, 4} |
| | 12 | 2 | 3 | | {3/4, 3/4, 1/2} | {6, 6} |
| | 14 | 2 | 3 | | {3/4, 3/4, 1} | {6, 8} |
| | 12 | 2 | 3 | | {3/4, 3/4, 1} | {6, 6} |
| | 16 | 2 | 3 | | {1, 1, 3/4} | {8, 8} |
| | 14 | 2 | 3 | | {1, 1, 3/4} | {8, 6} |
| | 16 | 2 | 3 | | {1, 1, 1} | {8, 8} |
| | 4 | 1 | 3 | | {1/2, 1/2, 1/2} | {4} |
| | 6 | 1 | 3 | | {3/4, 1/2, 1/2} | {6} |
| | 4 | 1 | 3 | | {3/4, 1/2, 1/2} | {4} |
| | 8 | 1 | 3 | | {1, 1/2, 1/2} | {8} |
| | 4 | 1 | 3 | | {1, 1/2, 1/2} | {4} |
| | 4 | 1 | 3 | | {1/2, 3/4, 1} | {4} |
| | 6 | 1 | 3 | | {1/2, 3/4, 1} | {6} |
| | 8 | 1 | 3 | | {1/2, 3/4, 1} | {8} |
| | 6 | 1 | 3 | | {3/4, 3/4, 3/4} | {6} |
| | 4 | 1 | 3 | | {3/4, 3/4, 1/2} | {4} |
| | 6 | 1 | 3 | | {3/4, 3/4, 1/2} | {6} |
| | 6 | 1 | 3 | | {3/4, 3/4, 1} | {6} |
| | 8 | 1 | 3 | | {3/4, 3/4, 1} | {8} |
| | 8 | 1 | 3 | | {1, 1, 3/4} | {8} |
| | 6 | 1 | 3 | | {1, 1, 3/4} | {6} |
| | 8 | 1 | 3 | | {1, 1, 1} | {8} |
| | 16 | 4 | 4 | | {1/2, 1/2, 1/2, 1/2} | {4, 4, 4, 4} |
| | 18 | 4 | 4 | | {3/4, 1/2, 1/2, 1/2} | {6, 4, 4, 4} |
| | 20 | 4 | 4 | | {1, 1/2, 1/2, 1/2} | {8, 4, 4, 4} |
| | 22 | 4 | 4 | | {1/2, 3/4, 1, 1/2} | {4, 6, 8, 4} |
| | 24 | 4 | 4 | | {1/2, 3/4, 1, 3/4} | {4, 6, 8, 6} |
| | 26 | 4 | 4 | | {1/2, 3/4, 1, 1} | {4, 6, 8, 8} |
| | 22 | 4 | 4 | | {3/4, 3/4, 3/4, 1/2} | {6, 6, 6, 4} |
| | 24 | 4 | 4 | | {3/4, 3/4, 3/4, 3/4} | {6, 6, 6, 6} |
| | 26 | 4 | 4 | | {3/4, 3/4, 3/4, 1} | {6, 6, 6, 8} |
| | 24 | 4 | 4 | | {1/2, 1/2, 1, 1} | {4, 4, 8, 8} |
| | 20 | 4 | 4 | | {3/4, 3/4, 1/2, 1/2} | {6, 6, 4, 4} |
| | 28 | 4 | 4 | | {3/4, 3/4, 1, 1} | {6, 6, 8, 8} |
| | 28 | 4 | 4 | | {1, 1, 1, 1/2} | {8, 8, 8, 4} |
| | 30 | 4 | 4 | | {1, 1, 1, 3/4} | {8, 8, 8, 6} |
| | 32 | 4 | 4 | | {1, 1, 1, 1} | {8, 8, 8, 8} |
| | 12 | 3 | 4 | | {1/2, 1/2, 1/2, 1/2} | {4, 4, 4} |
| | 14 | 3 | 4 | | {3/4, 1/2, 1/2, 1/2} | {6, 4, 4} |
| | 12 | 3 | 4 | | {3/4, 1/2, 1/2, 1/2} | {4, 4, 4} |
| | 16 | 3 | 4 | | {1, 1/2, 1/2, 1/2} | {8, 4, 4} |
| | 12 | 3 | 4 | | {1, 1/2, 1/2, 1/2} | {4, 4, 4} |
| | 18 | 3 | 4 | | {1/2, 3/4, 1, 1/2} | {4, 6, 8} |
| | 14 | 3 | 4 | | {1/2, 3/4, 1, 1/2} | {4, 6, 4} |
| | 16 | 3 | 4 | | {1/2, 3/4, 1, 1/2} | {4, 8, 4} |
| | 18 | 3 | 4 | | {1/2, 3/4, 1, 3/4} | {4, 6, 8} |
| | 16 | 3 | 4 | | {1/2, 3/4, 1, 3/4} | {4, 6, 6} |
| | 20 | 3 | 4 | | {1/2, 3/4, 1, 3/4} | {6, 8, 6} |
| | 18 | 3 | 4 | | {1/2, 3/4, 1, 1} | {4, 6, 8} |
| | 20 | 3 | 4 | | {1/2, 3/4, 1, 1} | {4, 8, 8} |
| | 22 | 3 | 4 | | {1/2, 3/4, 1, 1} | {6, 8, 8} |
| | 18 | 3 | 4 | | {3/4, 3/4, 3/4, 1/2} | {6, 6, 6} |
| | 16 | 3 | 4 | | {3/4, 3/4, 3/4, 1/2} | {6, 6, 4} |
| | 18 | 3 | 4 | | {3/4, 3/4, 3/4, 3/4} | {6, 6, 6} |
| | 18 | 3 | 4 | | {3/4, 3/4, 3/4, 1} | {6, 6, 6} |
| | 20 | 3 | 4 | | {3/4, 3/4, 3/4, 1} | {6, 6, 8} |
| | 16 | 3 | 4 | | {1/2, 1/2, 1, 1} | {4, 4, 8} |
| | 20 | 3 | 4 | | {1/2, 1/2, 1, 1} | {4, 8, 8} |
| | 16 | 3 | 4 | | {3/4, 3/4, 1/2, 1/2} | {6, 6, 4} |
| | 14 | 3 | 4 | | {3/4, 3/4, 1/2, 1/2} | {6, 4, 4} |
| | 20 | 3 | 4 | | {3/4, 3/4, 1, 1} | {6, 6, 8} |
| | 22 | 3 | 4 | | {3/4, 3/4, 1, 1} | {6, 8, 8} |
| | 24 | 3 | 4 | | {1, 1, 1, 1/2} | {8, 8, 8} |
| | 20 | 3 | 4 | | {1, 1, 1, 1/2} | {8, 8, 4} |
| | 24 | 3 | 4 | | {1, 1, 1, 3/4} | {8, 8, 8} |
| | 22 | 3 | 4 | | {1, 1, 1, 3/4} | {8, 8, 6} |
| | 36 | 3 | 4 | | {1, 1, 1, 1} | {8, 8, 8} |
| | 8 | 2 | 4 | | {1/2, 1/2, 1/2, 1/2} | {4, 4} |
| | 10 | 2 | 4 | | {3/4, 1/2, 1/2, 1/2} | {6, 4} |
| | 8 | 2 | 4 | | {3/4, 1/2, 1/2, 1/2} | {4, 4} |
| | 12 | 2 | 4 | | {1, 1/2, 1/2, 1/2} | {8, 4} |
| | 8 | 2 | 4 | | {1, 1/2, 1/2, 1/2} | {4, 4} |
| | 10 | 2 | 4 | | {1/2, 3/4, 1, 1/2} | {4, 6} |
| | 12 | 2 | 4 | | {1/2, 3/4, 1, 1/2} | {4, 8} |
| | 8 | 2 | 4 | | {1/2, 3/4, 1, 1/2} | {4, 4} |
| | 14 | 2 | 4 | | {1/2, 3/4, 1, 1/2} | {6, 8} |
| | 12 | 2 | 4 | | {1/2, 3/4, 1, 3/4} | {4, 8} |
| | 10 | 2 | 4 | | {1/2, 3/4, 1, 3/4} | {4, 6} |
| | 14 | 2 | 4 | | {1/2, 3/4, 1, 3/4} | {8, 6} |
| | 12 | 2 | 4 | | {1/2, 3/4, 1, 3/4} | {6, 6} |
| | 10 | 2 | 4 | | {1/2, 3/4, 1, 1} | {4, 6} |
| | 12 | 2 | 4 | | {1/2, 3/4, 1, 1} | {4, 8} |
| | 14 | 2 | 4 | | {1/2, 3/4, 1, 1} | {6, 8} |
| | 16 | 2 | 4 | | {1/2, 3/4, 1, 1} | {8, 8} |
| | 12 | 2 | 4 | | {3/4, 3/4, 3/4, 1/2} | {6, 6} |
| | 10 | 2 | 4 | | {3/4, 3/4, 3/4, 1/2} | {6, 4} |
| | 12 | 2 | 4 | | {3/4, 3/4, 3/4, 3/4} | {6, 6} |
| | 12 | 2 | 4 | | {3/4, 3/4, 3/4, 1} | {6, 6} |
| | 14 | 2 | 4 | | {3/4, 3/4, 3/4, 1} | {6, 8} |
| | 8 | 2 | 4 | | {1/2, 1/2, 1, 1} | {4, 4} |
| | 12 | 2 | 4 | | {1/2, 1/2, 1, 1} | {4, 8} |
| | 16 | 2 | 4 | | {1/2, 1/2, 1, 1} | {8, 8} |
| | 12 | 2 | 4 | | {3/4, 3/4, 1/2, 1/2} | {6, 6} |
| | 10 | 2 | 4 | | {3/4, 3/4, 1/2, 1/2} | {6, 4} |
| | 8 | 2 | 4 | | {3/4, 3/4, 1/2, 1/2} | {4, 4} |
| | 12 | 2 | 4 | | {3/4, 3/4, 1, 1} | {6, 6} |
| | 14 | 2 | 4 | | {3/4, 3/4, 1, 1} | {6, 8} |
| | 16 | 2 | 4 | | {3/4, 3/4, 1, 1} | {8, 8} |
| | 16 | 2 | 4 | | {1, 1, 1, 1/2} | {8, 8} |
| | 12 | 2 | 4 | | {1, 1, 1, 1/2} | {8, 4} |
| | 16 | 2 | 4 | | {1, 1, 1, 3/4} | {8, 8} |
| | 14 | 2 | 4 | | {1, 1, 1, 3/4} | {8, 6} |
| | 16 | 2 | 4 | | {1, 1, 1, 1} | {8, 8} |
| | 4 | 1 | 4 | | {1/2, 1/2, 1/2, 1/2} | {4} |
| | 6 | 1 | 4 | | {3/4, 1/2, 1/2, 1/2} | {6} |
| | 4 | 1 | 4 | | {3/4, 1/2, 1/2, 1/2} | {4} |
| | 8 | 1 | 4 | | {1, 1/2, 1/2, 1/2} | {8} |
| | 4 | 1 | 4 | | {1, 1/2, 1/2, 1/2} | {4} |
| | 6 | 1 | 4 | | {1/2, 3/4, 1, 1/2} | {6} |
| | 8 | 1 | 4 | | {1/2, 3/4, 1, 1/2} | {8} |
| | 4 | 1 | 4 | | {1/2, 3/4, 1, 1/2} | {4} |
| | 4 | 1 | 4 | | {1/2, 3/4, 1, 3/4} | {4} |
| | 6 | 1 | 4 | | {1/2, 3/4, 1, 3/4} | {6} |
| | 8 | 1 | 4 | | {1/2, 3/4, 1, 3/4} | {8} |
| | 4 | 1 | 4 | | {1/2, 3/4, 1, 1} | {4} |
| | 6 | 1 | 4 | | {1/2, 3/4, 1, 1} | {6} |
| | 8 | 1 | 4 | | {1/2, 3/4, 1, 1} | {8} |
| | 6 | 1 | 4 | | {3/4, 3/4, 1/2, 1/2} | {6} |
| | 4 | 1 | 4 | | {3/4, 3/4, 1/2, 1/2} | {4} |
| | 6 | 1 | 4 | | {3/4, 3/4, 3/4, 3/4} | {6} |
| | 6 | 1 | 4 | | {3/4, 3/4, 3/4, 1} | {6} |
| | 8 | 1 | 4 | | {3/4, 3/4, 3/4, 1} | {8} |
| | 4 | 1 | 4 | | {1/2, 1/2, 1, 1} | {4} |
| | 8 | 1 | 4 | | {1/2, 1/2, 1, 1} | {8} |
| | 6 | 1 | 4 | | {3/4, 3/4, 1/2, 1/2} | {6} |
| | 4 | 1 | 4 | | {3/4, 3/4, 1/2, 1/2} | {4} |
| | 6 | 1 | 4 | | {3/4, 3/4, 1, 1} | {6} |
| | 8 | 1 | 4 | | {3/4, 3/4, 1, 1} | {8} |
| | 8 | 1 | 4 | | {1, 1, 1, 1/2} | {8} |
| | 4 | 1 | 4 | | {1, 1, 1, 1/2} | {4} |
| | 8 | 1 | 4 | | {1, 1, 1, 3/4} | {8} |
| | 6 | 1 | 4 | | {1, 1, 1, 3/4} | {6} |
| | 8 | 1 | 4 | | {1, 1, 1, 1} | {8} |
| | 12 | 2 | 2 | 24 | {1/2, 1/2} | {6, 6} |
| | 15 | 2 | 2 | | {1/2, 3/4} | {6, 9} |
| | 18 | 2 | 2 | | {1/2, 1} | {6, 12} |
| | 18 | 2 | 2 | | {3/4, 3/4} | {9, 9} |
| | 21 | 2 | 2 | | {3/4, 1} | {9, 12} |
| | 24 | 2 | 2 | | {1, 1} | {12, 12} |
| | 6 | 1 | 2 | | {1/2, 1/2} | {6} |
| | 6 | 1 | 2 | | {1/2, 3/4} | {6} |
| | 9 | 1 | 2 | | {1/2, 3/4} | {9} |
| | 6 | 1 | 2 | | {1/2, 1} | {6} |
| | 12 | 1 | 2 | | {1/2, 1} | {12} |
| | 9 | 1 | 2 | | {3/4, 3/4} | {9} |
| | 9 | 1 | 2 | | {3/4, 1} | {9} |
| | 12 | 1 | 2 | | {3/4, 1} | {12} |
| | 12 | 1 | 2 | | {1, 1} | {12} |
| | 18 | 3 | 3 | | {1/2, 1/2, 1/2} | {6, 6, 6} |
| | 21 | 3 | 3 | | {3/4, 1/2, 1/2} | {9, 6, 6} |
| | 24 | 3 | 3 | | {1, 1/2, 1/2} | {12, 6, 6} |
| | 27 | 3 | 3 | | {1/2, 3/4, 1} | {6, 9, 12} |
| | 27 | 3 | 3 | | {3/4, 3/4, 3/4} | {9, 9, 9} |
| | 24 | 3 | 3 | | {3/4, 3/4, 1/2} | {9, 9, 6} |
| | 30 | 3 | 3 | | {3/4, 3/4, 1} | {9, 9, 12} |
| | 33 | 3 | 3 | | {1, 1, 3/4} | {12, 12, 9} |
| | 36 | 3 | 3 | | {1, 1, 1} | {12, 12, 12} |
| | 12 | 2 | 3 | | {1/2, 1/2, 1/2} | {6, 6} |
| | 15 | 2 | 3 | | {3/4, 1/2, 1/2} | {9, 6} |
| | 12 | 2 | 3 | | {3/4, 1/2, 1/2} | {6, 6} |
| | 18 | 2 | 3 | | {1, 1/2, 1/2} | {12, 6} |
| | 12 | 2 | 3 | | {1, 1/2, 1/2} | {6, 6} |
| | 15 | 2 | 3 | | {1/2, 3/4, 1} | {6, 9} |
| | 18 | 2 | 3 | | {1/2, 3/4, 1} | {6, 12} |
| | 21 | 2 | 3 | | {1/2, 3/4, 1} | {9, 12} |
| | 18 | 2 | 3 | | {3/4, 3/4, 3/4} | {9, 9} |
| | 15 | 2 | 3 | | {3/4, 3/4, 1/2} | {9, 6} |
| | 18 | 2 | 3 | | {3/4, 3/4, 1/2} | {9, 9} |
| | 21 | 2 | 3 | | {3/4, 3/4, 1} | {9, 12} |
| | 18 | 2 | 3 | | {3/4, 3/4, 1} | {9, 9} |
| | 24 | 2 | 3 | | {1, 1, 3/4} | {12, 12} |
| | 21 | 2 | 3 | | {1, 1, 3/4} | {12, 9} |
| | 24 | 2 | 3 | | {1, 1, 1} | {12, 12} |
| | 6 | 1 | 3 | | {1/2, 1/2, 1/2} | {6} |
| | 9 | 1 | 3 | | {3/4, 1/2, 1/2} | {9} |
| | 6 | 1 | 3 | | {3/4, 1/2, 1/2} | {6} |
| | 12 | 1 | 3 | | {1, 1/2, 1/2} | {12} |
| | 6 | 1 | 3 | | {1, 1/2, 1/2} | {6} |
| | 6 | 1 | 3 | | {1/2, 3/4, 1} | {6} |
| | 9 | 1 | 3 | | {1/2, 3/4, 1} | {9} |
| | 12 | 1 | 3 | | {1/2, 3/4, 1} | {12} |
| | 9 | 1 | 3 | | {3/4, 3/4, 3/4} | {9} |
| | 6 | 1 | 3 | | {3/4, 3/4, 1/2} | {6} |
| | 9 | 1 | 3 | | {3/4, 3/4, 1/2} | {9} |
| | 9 | 1 | 3 | | {3/4, 3/4, 1} | {9} |
| | 12 | 1 | 3 | | {3/4, 3/4, 1} | {12} |
| | 12 | 1 | 3 | | {1, 1, 3/4} | {12} |
| | 9 | 1 | 3 | | {1, 1, 3/4} | {9} |
| | 12 | 1 | 3 | | {1, 1, 1} | {12} |
| | 24 | 4 | 4 | | {1/2, 1/2, 1/2, 1/2} | {6, 6, 6, 6} |
| | 27 | 4 | 4 | | {3/4, 1/2, 1/2, 1/2} | {9, 6, 6, 6} |
| | 30 | 4 | 4 | | {1, 1/2, 1/2, 1/2} | {12, 6, 6, 6} |
| | 33 | 4 | 4 | | {1/2, 3/4, 1, 1/2} | {6, 9, 12, 6} |
| | 36 | 4 | 4 | | {1/2, 3/4, 1, 3/4} | {6, 9, 12, 9} |
| | 39 | 4 | 4 | | {1/2, 3/4, 1, 1} | {6, 9, 12, 12} |
| | 33 | 4 | 4 | | {3/4, 3/4, 3/4, 1/2} | {9, 9, 9, 6} |
| | 36 | 4 | 4 | | {3/4, 3/4, 3/4, 3/4} | {9, 9, 9, 9} |
| | 39 | 4 | 4 | | {3/4, 3/4, 3/4, 1} | {9, 9, 9, 12} |
| | 36 | 4 | 4 | | {1/2, 1/2, 1, 1} | {6, 6, 12, 12} |
| | 30 | 4 | 4 | | {3/4, 3/4, 1/2, 1/2} | {9, 9, 6, 6} |
| | 42 | 4 | 4 | | {3/4, 3/4, 1, 1} | {9, 9, 12, 12} |
| | 42 | 4 | 4 | | {1, 1, 1, 1/2} | {12, 12, 12, 6} |
| | 45 | 4 | 4 | | {1, 1, 1, 3/4} | {12, 12, 12, 9} |
| | 48 | 4 | 4 | | {1, 1, 1, 1} | {12, 12, 12, 12} |
| | 18 | 3 | 4 | | {1/2, 1/2, 1/2, 1/2} | {6, 6, 6} |
| | 21 | 3 | 4 | | {3/4, 1/2, 1/2, 1/2} | {9, 6, 6} |
| | 18 | 3 | 4 | | {3/4, 1/2, 1/2, 1/2} | {6, 6, 6} |
| | 24 | 3 | 4 | | {1, 1/2, 1/2, 1/2} | {12, 6, 6} |
| | 18 | 3 | 4 | | {1, 1/2, 1/2, 1/2} | {6, 6, 6} |
| | 27 | 3 | 4 | | {1/2, 3/4, 1, 1/2} | {6, 9, 12} |
| | 21 | 3 | 4 | | {1/2, 3/4, 1, 1/2} | {6, 9, 6} |
| | 24 | 3 | 4 | | {1/2, 3/4, 1, 1/2} | {6, 12, 6} |
| | 27 | 3 | 4 | | {1/2, 3/4, 1, 3/4} | {6, 9, 12} |
| | 24 | 3 | 4 | | {1/2, 3/4, 1, 3/4} | {6, 9, 9} |
| | 30 | 3 | 4 | | {1/2, 3/4, 1, 3/4} | {9, 12, 9} |
| | 27 | 3 | 4 | | {1/2, 3/4, 1, 1} | {6, 9, 12} |
| | 30 | 3 | 4 | | {1/2, 3/4, 1, 1} | {6, 12, 12} |
| | 33 | 3 | 4 | | {1/2, 3/4, 1, 1} | {9, 12, 12} |
| | 27 | 3 | 4 | | {3/4, 3/4, 3/4, 1/2} | {9, 9, 9} |
| | 24 | 3 | 4 | | {3/4, 3/4, 3/4, 1/2} | {9, 9, 6} |
| | 27 | 3 | 4 | | {3/4, 3/4, 3/4, 3/4} | {9, 9, 9} |
| | 27 | 3 | 4 | | {3/4, 3/4, 3/4, 1} | {9, 9, 9} |
| | 30 | 3 | 4 | | {3/4, 3/4, 3/4, 1} | {9, 9, 12} |
| | 24 | 3 | 4 | | {1/2, 1/2, 1, 1} | {6, 6, 12} |
| | 30 | 3 | 4 | | {1/2, 1/2, 1, 1} | {6, 12, 12} |
| | 24 | 3 | 4 | | {3/4, 3/4, 1/2, 1/2} | {9, 9, 6} |
| | 21 | 3 | 4 | | {3/4, 3/4, 1/2, 1/2} | {9, 6, 6} |
| | 30 | 3 | 4 | | {3/4, 3/4, 1, 1} | {9, 9, 12} |
| | 33 | 3 | 4 | | {3/4, 3/4, 1, 1} | {9, 12, 12} |
| | 36 | 3 | 4 | | {1, 1, 1, 1/2} | {12, 12, 12} |
| | 30 | 3 | 4 | | {1, 1, 1, 1/2} | {12, 12, 6} |
| | 36 | 3 | 4 | | {1, 1, 1, 3/4} | {12, 12, 12} |
| | 33 | 3 | 4 | | {1, 1, 1, 3/4} | {12, 12, 9} |
| | 54 | 3 | 4 | | {1, 1, 1, 1} | {12, 12, 12} |
| | 12 | 2 | 4 | | {1/2, 1/2, 1/2, 1/2} | {6, 6} |
| | 15 | 2 | 4 | | {3/4, 1/2, 1/2, 1/2} | {9, 6} |
| | 12 | 2 | 4 | | {3/4, 1/2, 1/2, 1/2} | {6, 6} |
| | 18 | 2 | 4 | | {1, 1/2, 1/2, 1/2} | {12, 6} |
| | 12 | 2 | 4 | | {1, 1/2, 1/2, 1/2} | {6, 6} |
| | 15 | 2 | 4 | | {1/2, 3/4, 1, 1/2} | {6, 9} |
| | 18 | 2 | 4 | | {1/2, 3/4, 1, 1/2} | {6, 12} |
| | 12 | 2 | 4 | | {1/2, 3/4, 1, 1/2} | {6, 6} |
| | 21 | 2 | 4 | | {1/2, 3/4, 1, 1/2} | {9, 12} |
| | 18 | 2 | 4 | | {1/2, 3/4, 1, 3/4} | {6, 12} |
| | 15 | 2 | 4 | | {1/2, 3/4, 1, 3/4} | {6, 9} |
| | 21 | 2 | 4 | | {1/2, 3/4, 1, 3/4} | {12, 9} |
| | 18 | 2 | 4 | | {1/2, 3/4, 1, 3/4} | {9, 9} |
| | 15 | 2 | 4 | | {1/2, 3/4, 1, 1} | {6, 9} |
| | 18 | 2 | 4 | | {1/2, 3/4, 1, 1} | {6, 12} |
| | 21 | 2 | 4 | | {1/2, 3/4, 1, 1} | {9, 12} |
| | 24 | 2 | 4 | | {1/2, 3/4, 1, 1} | {12, 12} |
| | 18 | 2 | 4 | | {3/4, 3/4, 3/4, 1/2} | {9, 9} |
| | 15 | 2 | 4 | | {3/4, 3/4, 3/4, 1/2} | {9, 6} |
| | 18 | 2 | 4 | | {3/4, 3/4, 3/4, 3/4} | {9, 9} |
| | 18 | 2 | 4 | | {3/4, 3/4, 3/4, 1} | {9, 9} |
| | 21 | 2 | 4 | | {3/4, 3/4, 3/4, 1} | {9, 12} |
| | 12 | 2 | 4 | | {1/2, 1/2, 1, 1} | {6, 6} |
| | 18 | 2 | 4 | | {1/2, 1/2, 1, 1} | {6, 12} |
| | 24 | 2 | 4 | | {1/2, 1/2, 1, 1} | {12, 12} |
| | 18 | 2 | 4 | | {3/4, 3/4, 1/2, 1/2} | {9, 9} |
| | 15 | 2 | 4 | | {3/4, 3/4, 1/2, 1/2} | {9, 6} |
| | 12 | 2 | 4 | | {3/4, 3/4, 1/2, 1/2} | {6, 6} |
| | 18 | 2 | 4 | | {3/4, 3/4, 1, 1} | {9, 9} |
| | 21 | 2 | 4 | | {3/4, 3/4, 1, 1} | {9, 12} |
| | 24 | 2 | 4 | | {3/4, 3/4, 1, 1} | {12, 12} |
| | 24 | 2 | 4 | | {1, 1, 1, 1/2} | {12, 12} |
| | 18 | 2 | 4 | | {1, 1, 1, 1/2} | {12, 6} |
| | 24 | 2 | 4 | | {1, 1, 1, 3/4} | {12, 12} |
| | 21 | 2 | 4 | | {1, 1, 1, 3/4} | {12, 9} |
| | 24 | 2 | 4 | | {1, 1, 1, 1} | {12, 12} |
| | 6 | 1 | 4 | | {1/2, 1/2, 1/2, 1/2} | {6} |
| | 9 | 1 | 4 | | {3/4, 1/2, 1/2, 1/2} | {9} |
| | 6 | 1 | 4 | | {3/4, 1/2, 1/2, 1/2} | {6} |
| | 12 | 1 | 4 | | {1, 1/2, 1/2, 1/2} | {12} |
| | 6 | 1 | 4 | | {1, 1/2, 1/2, 1/2} | {6} |
| | 9 | 1 | 4 | | {1/2, 3/4, 1, 1/2} | {9} |
| | 12 | 1 | 4 | | {1/2, 3/4, 1, 1/2} | {12} |
| | 6 | 1 | 4 | | {1/2, 3/4, 1, 1/2} | {6} |
| | 6 | 1 | 4 | | {1/2, 3/4, 1, 3/4} | {6} |
| | 9 | 1 | 4 | | {1/2, 3/4, 1, 3/4} | {9} |
| | 12 | 1 | 4 | | {1/2, 3/4, 1, 3/4} | {12} |
| | 6 | 1 | 4 | | {1/2, 3/4, 1, 1} | {6} |
| | 9 | 1 | 4 | | {1/2, 3/4, 1, 1} | {9} |
| | 12 | 1 | 4 | | {1/2, 3/4, 1, 1} | {12} |
| | 9 | 1 | 4 | | {3/4, 3/4, 1/2, 1/2} | {9} |
| | 6 | 1 | 4 | | {3/4, 3/4, 1/2, 1/2} | {6} |
| | 9 | 1 | 4 | | {3/4, 3/4, 3/4, 3/4} | {9} |
| | 9 | 1 | 4 | | {3/4, 3/4, 3/4, 1} | {9} |
| | 12 | 1 | 4 | | {3/4, 3/4, 3/4, 1} | {12} |
| | 6 | 1 | 4 | | {1/2, 1/2, 1, 1} | {6} |
| | 12 | 1 | 4 | | {1/2, 1/2, 1, 1} | {12} |
| | 9 | 1 | 4 | | {3/4, 3/4, 1/2, 1/2} | {9} |
| | 6 | 1 | 4 | | {3/4, 3/4, 1/2, 1/2} | {6} |
| | 9 | 1 | 4 | | {3/4, 3/4, 1, 1} | {9} |
| | 12 | 1 | 4 | | {3/4, 3/4, 1, 1} | {12} |
| | 12 | 1 | 4 | | {1, 1, 1, 1/2} | {12} |
| | 6 | 1 | 4 | | {1, 1, 1, 1/2} | {6} |
| | 12 | 1 | 4 | | {1, 1, 1, 3/4} | {12} |
| | 9 | 1 | 4 | | {1, 1, 1, 3/4} | {9} |
| | 12 | 1 | 4 | | {1, 1, 1, 1} | {12} |
| | 16 | 2 | 2 | 32 | {1/2, 1/2} | {8, 8} |
| | 20 | 2 | 2 | | {1/2, 3/4} | {8, 12} |
| | 24 | 2 | 2 | | {1/2, 1} | {8, 16} |
| | 24 | 2 | 2 | | {3/4, 3/4} | {12, 12} |
| | 28 | 2 | 2 | | {3/4, 1} | {12, 16} |
| | 32 | 2 | 2 | | {1, 1} | {16, 16} |
| | 8 | 1 | 2 | | {1/2, 1/2} | {8} |
| | 8 | 1 | 2 | | {1/2, 3/4} | {8} |
| | 12 | 1 | 2 | | {1/2, 3/4} | {12} |
| | 8 | 1 | 2 | | {1/2, 1} | {8} |
| | 16 | 1 | 2 | | {1/2, 1} | {16} |
| | 12 | 1 | 2 | | {3/4, 3/4} | {12} |
| | 12 | 1 | 2 | | {3/4, 1} | {12} |
| | 16 | 1 | 2 | | {3/4, 1} | {16} |
| | 16 | 1 | 2 | | {1, 1} | {16} |
| | 24 | 3 | 3 | | {1/2, 1/2, 1/2} | {8, 8, 8} |
| | 28 | 3 | 3 | | {3/4, 1/2, 1/2} | {12, 8, 8} |
| | 32 | 3 | 3 | | {1, 1/2, 1/2} | {16, 8, 8} |
| | 36 | 3 | 3 | | {1/2, 3/4, 1} | {8, 12, 16} |
| | 36 | 3 | 3 | | {3/4, 3/4, 3/4} | {12, 12, 12} |
| | 32 | 3 | 3 | | {3/4, 3/4, 1/2} | {12, 12, 8} |
| | 40 | 3 | 3 | | {3/4, 3/4, 1} | {12, 12, 16} |
| | 44 | 3 | 3 | | {1, 1, 3/4} | {16, 16, 12} |
| | 48 | 3 | 3 | | {1, 1, 1} | {16, 16, 16} |
| | 16 | 2 | 3 | | {1/2, 1/2, 1/2} | {8, 8} |
| | 20 | 2 | 3 | | {3/4, 1/2, 1/2} | {12, 8} |
| | 16 | 2 | 3 | | {3/4, 1/2, 1/2} | {8, 8} |
| | 24 | 2 | 3 | | {1, 1/2, 1/2} | {16, 8} |
| | 16 | 2 | 3 | | {1, 1/2, 1/2} | {8, 8} |
| | 20 | 2 | 3 | | {1/2, 3/4, 1} | {8, 12} |
| | 24 | 2 | 3 | | {1/2, 3/4, 1} | {8, 16} |
| | 28 | 2 | 3 | | {1/2, 3/4, 1} | {12, 16} |
| | 24 | 2 | 3 | | {3/4, 3/4, 3/4} | {12, 12} |
| | 20 | 2 | 3 | | {3/4, 3/4, 1/2} | {12, 8} |
| | 24 | 2 | 3 | | {3/4, 3/4, 1/2} | {12, 12} |
| | 28 | 2 | 3 | | {3/4, 3/4, 1} | {12, 16} |
| | 24 | 2 | 3 | | {3/4, 3/4, 1} | {12, 12} |
| | 32 | 2 | 3 | | {1, 1, 3/4} | {16, 16} |
| | 28 | 2 | 3 | | {1, 1, 3/4} | {16, 12} |
| | 32 | 2 | 3 | | {1, 1, 1} | {16, 16} |
| | 8 | 1 | 3 | | {1/2, 1/2, 1/2} | {8} |
| | 12 | 1 | 3 | | {3/4, 1/2, 1/2} | {12} |
| | 8 | 1 | 3 | | {3/4, 1/2, 1/2} | {8} |
| | 16 | 1 | 3 | | {1, 1/2, 1/2} | {16} |
| | 8 | 1 | 3 | | {1, 1/2, 1/2} | {8} |
| | 8 | 1 | 3 | | {1/2, 3/4, 1} | {8} |
| | 12 | 1 | 3 | | {1/2, 3/4, 1} | {12} |
| | 16 | 1 | 3 | | {1/2, 3/4, 1} | {16} |
| | 12 | 1 | 3 | | {3/4, 3/4, 3/4} | {12} |
| | 8 | 1 | 3 | | {3/4, 3/4, 1/2} | {8} |
| | 12 | 1 | 3 | | {3/4, 3/4, 1/2} | {12} |
| | 12 | 1 | 3 | | {3/4, 3/4, 1} | {12} |
| | 16 | 1 | 3 | | {3/4, 3/4, 1} | {16} |
| | 16 | 1 | 3 | | {1, 1, 3/4} | {16} |
| | 12 | 1 | 3 | | {1, 1, 3/4} | {12} |
| | 16 | 1 | 3 | | {1, 1, 1} | {16} |
| | 32 | 4 | 4 | | {1/2, 1/2, 1/2, 1/2} | {8, 8, 8, 8} |
| | 36 | 4 | 4 | | {3/4, 1/2, 1/2, 1/2} | {12, 8, 8, 8} |
| | 40 | 4 | 4 | | {1, 1/2, 1/2, 1/2} | {16, 8, 8, 8} |
| | 44 | 4 | 4 | | {1/2, 3/4, 1, 1/2} | {8, 12, 16, 8} |
| | 48 | 4 | 4 | | {1/2, 3/4, 1, 3/4} | {8, 12, 16, 12} |
| | 52 | 4 | 4 | | {1/2, 3/4, 1, 1} | {8, 12, 16, 16} |
| | 44 | 4 | 4 | | {3/4, 3/4, 3/4, 1/2} | {12, 12, 12, 8} |
| | 48 | 4 | 4 | | {3/4, 3/4, 3/4, 3/4} | {12, 12, 12, 12} |
| | 52 | 4 | 4 | | {3/4, 3/4, 3/4, 1} | {12, 12, 12, 16} |
| | 48 | 4 | 4 | | {1/2, 1/2, 1, 1} | {8, 8, 16, 16} |
| | 40 | 4 | 4 | | {3/4, 3/4, 1/2, 1/2} | {12, 12, 8, 8} |
| | 56 | 4 | 4 | | {3/4, 3/4, 1, 1} | {12, 12, 16, 16} |
| | 56 | 4 | 4 | | {1, 1, 1, 1/2} | {16, 16, 16, 8} |
| | 60 | 4 | 4 | | {1, 1, 1, 3/4} | {16, 16, 16, 12} |
| | 64 | 4 | 4 | | {1, 1, 1, 1} | {16, 16, 16, 16} |
| | 24 | 3 | 4 | | {1/2, 1/2, 1/2, 1/2} | {8, 8, 8} |
| | 28 | 3 | 4 | | {3/4, 1/2, 1/2, 1/2} | {12, 8, 8} |
| | 24 | 3 | 4 | | {3/4, 1/2, 1/2, 1/2} | {8, 8, 8} |
| | 32 | 3 | 4 | | {1, 1/2, 1/2, 1/2} | {16, 8, 8} |
| | 24 | 3 | 4 | | {1, 1/2, 1/2, 1/2} | {8, 8, 8} |
| | 36 | 3 | 4 | | {1/2, 3/4, 1, 1/2} | {8, 12, 16} |
| | 28 | 3 | 4 | | {1/2, 3/4, 1, 1/2} | {8, 12, 8} |
| | 32 | 3 | 4 | | {1/2, 3/4, 1, 1/2} | {8, 16, 8} |
| | 36 | 3 | 4 | | {1/2, 3/4, 1, 3/4} | {8, 12, 16} |
| | 32 | 3 | 4 | | {1/2, 3/4, 1, 3/4} | {8, 12, 12} |
| | 40 | 3 | 4 | | {1/2, 3/4, 1, 3/4} | {12, 16, 12} |
| | 36 | 3 | 4 | | {1/2, 3/4, 1, 1} | {8, 12, 16} |
| | 40 | 3 | 4 | | {1/2, 3/4, 1, 1} | {8, 16, 16} |
| | 44 | 3 | 4 | | {1/2, 3/4, 1, 1} | {12, 16, 16} |
| | 36 | 3 | 4 | | {3/4, 3/4, 3/4, 1/2} | {12, 12, 12} |
| | 32 | 3 | 4 | | {3/4, 3/4, 3/4, 1/2} | {12, 12, 8} |
| | 36 | 3 | 4 | | {3/4, 3/4, 3/4, 3/4} | {12, 12, 12} |
| | 36 | 3 | 4 | | {3/4, 3/4, 3/4, 1} | {12, 12, 12} |
| | 40 | 3 | 4 | | {3/4, 3/4, 3/4, 1} | {12, 12, 16} |
| | 32 | 3 | 4 | | {1/2, 1/2, 1, 1} | {8, 8, 16} |
| | 40 | 3 | 4 | | {1/2, 1/2, 1, 1} | {8, 16, 16} |
| | 32 | 3 | 4 | | {3/4, 3/4, 1/2, 1/2} | {12, 12, 8} |
| | 28 | 3 | 4 | | {3/4, 3/4, 1/2, 1/2} | {12, 8, 8} |
| | 40 | 3 | 4 | | {3/4, 3/4, 1, 1} | {12, 12, 16} |
| | 44 | 3 | 4 | | {3/4, 3/4, 1, 1} | {12, 16, 16} |
| | 48 | 3 | 4 | | {1, 1, 1, 1/2} | {16, 16, 16} |
| | 40 | 3 | 4 | | {1, 1, 1, 1/2} | {16, 16, 8} |
| | 48 | 3 | 4 | | {1, 1, 1, 3/4} | {16, 16, 16} |
| | 44 | 3 | 4 | | {1, 1, 1, 3/4} | {16, 16, 12} |
| | 72 | 3 | 4 | | {1, 1, 1, 1} | {16, 16, 16} |
| | 16 | 2 | 4 | | {1/2, 1/2, 1/2, 1/2} | {8, 8} |
| | 20 | 2 | 4 | | {3/4, 1/2, 1/2, 1/2} | {12, 8} |
| | 16 | 2 | 4 | | {3/4, 1/2, 1/2, 1/2} | {8, 8} |
| | 24 | 2 | 4 | | {1, 1/2, 1/2, 1/2} | {16, 8} |
| | 16 | 2 | 4 | | {1, 1/2, 1/2, 1/2} | {8, 8} |
| | 20 | 2 | 4 | | {1/2, 3/4, 1, 1/2} | {8, 12} |
| | 24 | 2 | 4 | | {1/2, 3/4, 1, 1/2} | {8, 16} |
| | 16 | 2 | 4 | | {1/2, 3/4, 1, 1/2} | {8, 8} |
| | 28 | 2 | 4 | | {1/2, 3/4, 1, 1/2} | {12, 16} |
| | 24 | 2 | 4 | | {1/2, 3/4, 1, 3/4} | {8, 16} |
| | 20 | 2 | 4 | | {1/2, 3/4, 1, 3/4} | {8, 12} |
| | 28 | 2 | 4 | | {1/2, 3/4, 1, 3/4} | {16, 12} |
| | 24 | 2 | 4 | | {1/2, 3/4, 1, 3/4} | {12, 12} |
| | 20 | 2 | 4 | | {1/2, 3/4, 1, 1} | {8, 12} |
| | 24 | 2 | 4 | | {1/2, 3/4, 1, 1} | {8, 16} |
| | 28 | 2 | 4 | | {1/2, 3/4, 1, 1} | {12, 16} |
| | 32 | 2 | 4 | | {1/2, 3/4, 1, 1} | {16, 16} |
| | 24 | 2 | 4 | | {3/4, 3/4, 3/4, 1/2} | {12, 12} |
| | 20 | 2 | 4 | | {3/4, 3/4, 3/4, 1/2} | {12, 8} |
| | 24 | 2 | 4 | | {3/4, 3/4, 3/4, 3/4} | {12, 12} |
| | 24 | 2 | 4 | | {3/4, 3/4, 3/4, 1} | {12, 12} |
| | 28 | 2 | 4 | | {3/4, 3/4, 3/4, 1} | {12, 16} |
| | 16 | 2 | 4 | | {1/2, 1/2, 1, 1} | {8, 8} |
| | 24 | 2 | 4 | | {1/2, 1/2, 1, 1} | {8, 16} |
| | 32 | 2 | 4 | | {1/2, 1/2, 1, 1} | {16, 16} |
| | 24 | 2 | 4 | | {3/4, 3/4, 1/2, 1/2} | {12, 12} |
| | 20 | 2 | 4 | | {3/4, 3/4, 1/2, 1/2} | {12, 8} |
| | 16 | 2 | 4 | | {3/4, 3/4, 1/2, 1/2} | {8, 8} |
| | 24 | 2 | 4 | | {3/4, 3/4, 1, 1} | {12, 12} |
| | 28 | 2 | 4 | | {3/4, 3/4, 1, 1} | {12, 16} |
| | 32 | 2 | 4 | | {3/4, 3/4, 1, 1} | {16, 16} |
| | 32 | 2 | 4 | | {1, 1, 1, 1/2} | {16, 16} |
| | 24 | 2 | 4 | | {1, 1, 1, 1/2} | {16, 8} |
| | 32 | 2 | 4 | | {1, 1, 1, 3/4} | {16, 16} |
| | 28 | 2 | 4 | | {1, 1, 1, 3/4} | {16, 12} |
| | 32 | 2 | 4 | | {1, 1, 1, 1} | {16, 16} |
| | 8 | 1 | 4 | | {1/2, 1/2, 1/2, 1/2} | {8} |
| | 12 | 1 | 4 | | {3/4, 1/2, 1/2, 1/2} | {12} |
| | 8 | 1 | 4 | | {3/4, 1/2, 1/2, 1/2} | {8} |
| | 16 | 1 | 4 | | {1, 1/2, 1/2, 1/2} | {16} |
| | 8 | 1 | 4 | | {1, 1/2, 1/2, 1/2} | {8} |
| | 12 | 1 | 4 | | {1/2, 3/4, 1, 1/2} | {12} |
| | 16 | 1 | 4 | | {1/2, 3/4, 1, 1/2} | {16} |
| | 8 | 1 | 4 | | {1/2, 3/4, 1, 1/2} | {8} |
| | 8 | 1 | 4 | | {1/2, 3/4, 1, 3/4} | {8} |
| | 12 | 1 | 4 | | {1/2, 3/4, 1, 3/4} | {12} |
| | 16 | 1 | 4 | | {1/2, 3/4, 1, 3/4} | {16} |
| | 8 | 1 | 4 | | {1/2, 3/4, 1, 1} | {8} |
| | 12 | 1 | 4 | | {1/2, 3/4, 1, 1} | {12} |
| | 16 | 1 | 4 | | {1/2, 3/4, 1, 1} | {16} |
| | 12 | 1 | 4 | | {3/4, 3/4, 1/2, 1/2} | {12} |
| | 8 | 1 | 4 | | {3/4, 3/4, 1/2, 1/2} | {8} |
| | 12 | 1 | 4 | | {3/4, 3/4, 3/4, 3/4} | {12} |
| | 12 | 1 | 4 | | {3/4, 3/4, 3/4, 1} | {12} |
| | 16 | 1 | 4 | | {3/4, 3/4, 3/4, 1} | {16} |
| | 8 | 1 | 4 | | {1/2, 1/2, 1, 1} | {8} |
| | 16 | 1 | 4 | | {1/2, 1/2, 1, 1} | {16} |
| | 12 | 1 | 4 | | {3/4, 3/4, 1/2, 1/2} | {12} |
| | 8 | 1 | 4 | | {3/4, 3/4, 1/2, 1/2} | {8} |
| | 12 | 1 | 4 | | {3/4, 3/4, 1, 1} | {12} |
| | 16 | 1 | 4 | | {3/4, 3/4, 1, 1} | {16} |
| | 16 | 1 | 4 | | {1, 1, 1, 1/2} | {16} |
| | 8 | 1 | 4 | | {1, 1, 1, 1/2} | {8} |
| | 16 | 1 | 4 | | {1, 1, 1, 3/4} | {16} |
| | 12 | 1 | 4 | | {1, 1, 1, 3/4} | {12} |
| | 16 | 1 | 4 | | {1, 1, 1, 1} | {16} |

In some embodiments, the candidate values for combination of αₜ and N_{TRP} (or N) may be from Table 12 that shows candidates values for Lₜ (for example, the first vector), Table 13 that shows candidates value for αₜ and Table 14 that shows candidate values for M and β. It is noted that the values shown in Tables 12-14 are only examples not limitations and orders of the values shown in Tables 12-14 are also examples.

TABLE 12
Lₜ

1
2
3
4
6
8
9
12
16

TABLE 13
αₜ
½
¾
1

TABLE 14

| M | β |
|---|---|
| 1 | ½ |
| 1 | ¾ |
| 1 | 1 |
| 1 | 1/8 |
| 2 | ½ |
| 2 | ¾ |
| 2 | 1/8 |

In some embodiments, there may be a restriction on bitmap for selection of CSJ-RS resources from the plurality of CSI-RS resources. For example, the restriction on bitmap may be configured via RRC signaling. Alternatively, or in addition, the restriction on bitmap may be configured via medium access control (MAC) signaling. In some embodiments, for N_{TRP} CSI-RS resources, at least one CSI-RS resource may always be selected. Or in other words, a subset of N_{TRP} CSI-RS resources can be determined/selected by the terminal device 110. In this case, each one of the subset of N_{TRP} CSI-RS resources selected or not may be based on one value in the bitmap.

In some embodiments, for a first number of the plurality of CSI-RS resources, the terminal device 110 may determine whether to select one of a second number of CSI-RS resources. In some embodiments, the first number N_{TRP} may be at least one of {1, 2, 3, 4}, the second number N_{TRP}_r may be a positive integer. For example, the 1<=N_{TRP}_r<=N_{TRP}. In some embodiments, the second number N_{TRP}_r may be at least one of {1, . . . , N_{TRP}}. In some embodiments, the second number may be configured via a radio resource control (RRC) signaling. In this case, selection or not for each one of the second number of CSI-RS resources may be indicated with a bitmap in a first part of CSI, and a number of bits in the bitmap may be same as the second number. In some embodiments, a remaining CSI-RS resource in the plurality of CSI-RS resources excluding the second number of CSI-RS resources may be always selected for the CSI report. In other words, N_{TRP} CSI-RS resources, selection or not of one of N_{TRP}_r CSI-RS resources can be determined/selected by the terminal device 110. In some embodiments, the bit field for the bitmap may be N_{TRP}_r. N_{TRP} may be at least one of {1,2,3,4}. N_{TRP}_r may be at least one of {1,2, . . . N_{TRP}}. In some embodiments, N_{TRP}_r may be configured via RRC (e.g. as part of codebook subset restriction (CBSR)).

In some embodiments, for one codebook configuration for one CSI report, at least one value of Lt and/or αₜ may be 0 for one combination of values. For example, in some embodiments, the union of indication of Lt and/or αₜ combination and bitmap may be applied to determine which TRP is selected or not selected. For example, N_{L_1}={4, 2, 0, 2}, N_{L_2}={4, 2, 2, 0}. If N_{L_1} is reported, the third TRP is not selected, and if N_{L_2} is reported, the fourth TRP is not selected.

Alternatively, among the N_{L} combinations, union of the TRPs corresponding to Lt=0 and/or αₜ=0 can be determined/selected by the terminal device 110 based on the bitmap. For example, N_{L_1}={4, 2, 2, 4}, N_{L_2}={4, 2, 4, 4}, N_{L_3}={4, 0, 0, 2}. In this case, the first and the fourth TRP may be always selected. The bitmap for TRP selection can be 2 bits, to indicate the second TRP and/or the third TRP selected or not. For example, if bitmap is reported, the value of Lt and/or αₜ corresponding to bit in the bitmap with value 0 may be assumed as 0 or ignored, and no coefficients (SD basis selection, rotation indication, FD basis selection, bitmap for non-zero coefficients, phase/amplitude coefficients) may be in CSI part 2. In some embodiments, pᵥ can be replaced with M. Alternatively, or in addition, Lₜ can be replaced with αₜ.

In some embodiments, if N_{L} is larger than one, one combination of {L₁, . . . , L_{NTRP}} may be restrictedly associated pᵥ and β. For example, within the N_{L} combinations, the values of

$${\sum }_{t = 1}^{N} 2 {L}_{t} * {p}_{v} * β$$

may be similar (i.e., not vary too much).

In some embodiments, if

$${\sum }_{t = 1}^{N} 2 {L}_{t}$$

corresponding to a first combination (e.g. N_{L_1}) is less than

$${\sum }_{t = 1}^{N} 2 {L}_{t}$$

corresponding to a second combination (e.g. N_{L_2}), the value of pᵥ and/or β associated with the first combination may be larger than or no less than the value of pᵥ and/or β associated with the second combination. In some embodiments, a maximum value of sum of Lₜ among the N_{L} combinations may be represented as Lmax, and the N_{L} combinations may be associated with 2 or 3 sets of pᵥ and/or β. And a sum of Lₜ corresponding to one of the N_{L} combinations may be represented as Ltot_nl. For example, if Ltot_nl<=Lmax/2 or Ltot_nl<=Lmax/N_{TRP}, a first set of pᵥ and/or β may be applied, and if Ltot_nl>=Lmax/2 or Ltot_nl>=Lmax/N_{TRP}, a second set of pᵥ and/or β may be applied. In this case, at least one of pᵥ and/or β in the first set may be larger than at least one of pᵥ and/or β in the second set. Alternatively, if N=1, Lt corresponding to the selected TRP may be min(4, Lmax/NTRP) or min(6,Lmax/NTRP) or max {Lt} among all the N_{L} combinations or among the Lt in the indicated one of the N_{L} combinations.

In some embodiments, the terminal device 110 may receive from the network device 120, first information that indicates a subset of the set of N_{L} combinations of values for first vector associated with at least one of: a subset of the set of values for second vector and a subset of the set of values for the first parameter. In this case, the CSI report may be based on one combination of the subset of the set of combinations. In some embodiments, the first information may be via at last one of: a RRC signaling or a medium access control (MAC) signaling. For example, a subset of candidates of the N_{L} combinations combined with possible values of pᵥ and/or β may be configured via RRC and/or MAC (e.g. a part of CBSR), and the reporting is restricted within the subset. In this way, the payload for CSI reporting is typically assigned based on the maximum payload, if reporting of Lt combination and/or bitmap leads to much less overhead, better performance may be achieved.

In some embodiments, if N_{L} is larger than 1, the possible values of bitmap and selected one of N_{L} combinations and/or associated pᵥ and β may be restricted. For example, a first value of the bitmap may be only possibly to be combined with a first subset of the N_{L} combinations, and/or a first subset of the Nₛ values of pᵥ and/or β, and a second value of the bitmap may be only possibly to be combined with a second subset of the N_{L} combinations, and/or a second subset of the Nₛ values of pᵥ and/or β.

In some embodiments, if the number of bits in the bitmap with value 1 is less than or no larger than N_{TRP}/2, a first set of values of pᵥ and/or β may be associated. Alternatively, if the number of bits in the bitmap with value 1 is no less than or larger than N_{TRP}/2, a second set of value of pᵥ and/or β may be associated. In this case, at least one of pᵥ and/or β in the first set may be larger than at least one of pᵥ and/or β in the second set.

In some embodiments, if at least one bits in the first bitmap is with value 0, and all bits in the second bitmap are with value 1, the value of pᵥ and/or β associated with the first bitmap may be larger than the value of pᵥ and/or β associated with the second bitmap. Alternatively, if only one bit in the bitmap is with value 1, Lₜ corresponding to the selected TRP may be min(4, Lmax/N_{TRP}) or min(6,Lmax/N_{TRP}) or max {Lₜ} among all the N_{L} combinations or among the Lₜ in the indicated one of the N_{L} combinations.

In some embodiments, the terminal device 110 may receive from the network device 120, second information that indicates a subset of candidate values of a bitmap associated with a subset of the set of combinations of values for first vector associated with at least one of: a subset of the set of values for second vector and a subset of the set of values for the first parameter. In this case, the CSI report may be based on one combination of the subset of the set of combinations. The second information may be via at last one of: a RRC signaling or a medium access control (MAC) signaling. For example, a subset of candidate values of bitmap combined with a subset of the N_{L} combinations combined with a subset of possible values of pᵥ and/or β may be configured via RRC and/or MAC (e.g. a part of CBSR), and the reporting is restricted within the subset.

In some embodiments, the field for number of non zero coefficients reporting may be based on the maximum value of K₀ among the candidates values of N_{L} combinations of values for {L₁, . . . , L_{NTRP}} and Nₛ values of pᵥ and/or β. For example, if the maximum number of layers is 1, the field size may be ┌log₂(max (K₀))┐, for example

$$⌈ {log}_{2} ( β * 2 * {max}_{{N}_{L}} ( {\sum }_{t = 1}^{{N}_{TRP}} {L}_{t} ) {M}_{1} ) ⌉ .$$

Alternatively, or in addition, if the maximum number of layers is larger than 1, the field size may be ┌log₂(2*max(K₀))┐, for example,

$$⌈ {log}_{2} ( 2 * β * 2 * {max}_{{N}_{L}} ( {\sum }_{t = 1}^{{N}_{TRP}} {L}_{t} ) {M}_{1} ) ⌉ .$$

In some embodiments,

$${M}_{1} = ⌈ {p}_{1} \frac{{N}_{3}}{R} ⌉ .$$

In some other embodiments, the candidate values of N_{L} combinations and Nₛ values of pᵥ and/or β may lead to similar value of K₀. For example, for N_{L} combinations, a first set of values of pᵥ and β with minimum value of pᵥ*β may be applied at least for all NTRP TRPs selected or applied for Lmax. And if Ltot<=Lmax/X, a second set of value of p_{v,2} and/or β₂ may be applied. In this case, p_{v,2}*β₂ is nearest to X*pᵥ*β and P_{v,2}*β₂≤X*pᵥ*β, and the second value of K₀ corresponding to the second set of value is no larger than the first value of K₀ corresponding to the first set of value. For example, X may be 2 or 3 or 4.

In some embodiments, a first configuration of combined value of pᵥ and β, a second configuration of Lt combination may be separately configured by the network device 120. There may be a table defined for all possible combinations for Ltot or Lmax or Lt combination with pᵥ and β. The first and the second configuration may be based on the table (within the possible candidates). For example, for different values of N_{TRP}, the combination tables may be different.

In some embodiments, there may be N_{TRP} sets of SD basis vectors restriction or first vector restriction or CSI-RS ports restriction or N_{TRP} sets of codebook subset restriction configured for the terminal device 110, and each set corresponding to one TRP or corresponding to one CSI-RS resource in the plurality of CSI-RS resources. In some other embodiments, there may be N_RI indications of RI restriction. In this case, N_RI>1. N_RI may be 2 or 3 or 4 or N_{TRP}. For example, a first indication of RI restriction may be applied for N=N_{TRP} (e.g. all TRPs selected) or for Ltot>=Y_L or K0>=Y_k. e.g. the bit string may be with size 4 or 2. For example, a second indication of RI restriction may be applied for N<N_{TRP} or for Ltot≤=Y_L or K0<=Y_k. e.g. the bit string may be with size 4. For example, a third indication of RI restriction may be applied for N=1 (e.g. only one TRP selected), e.g. the bit string may be with size 4. For example, if Ltot>=Y_L or K0>=Y_k, the number of layers may be restricted as 1 or 2, and if Ltot≤=Y_L or K0<=Y_k, the number of layers may be 1 or 2 or 3 or 4 (based on corresponding RI restriction). In some embodiments, there may be at least one TRP configured to be restricted to be jointly selected with other TRPs. Alternatively, the at least one TRP cannot be individually selected. In some embodiments, Y_L may be a positive integer. For example, 4<=Y_L<=16. For example, 4<=Y_L<=64. In some embodiments, Y_k may be a positive integer. For example, 4<=Y_k<=16. For example, 4<=Y_k<=64. In some embodiments, if the sum or total or summation or maximum value of the sum or total or summation value of Lₜ corresponding to one of the N_{L} combinations of values for first vector is larger than or no less than a first threshold, the candidates values of p, may be at least one of {¼ for v∈{1,2} and ⅛ for v∈{3,4}}, {¼ for v∈{1,2} and ¼ for v∈{3,4}}, {⅛ for v∈{1,2} and 1/16 for v∈{3,4}}, {¼ for v∈{1,2}(for example, v∈{3,4} not supported)} and {½ for v∈{1,2}(for example, v∈{3,4} not supported)} and/or the candidate values for β may be at least one of {¼, ½, ⅛} or {¼, ⅛}. In some embodiments, the first threshold may be a positive integer. For example, the first threshold may be no less than 4 and no larger than 16.

In some embodiments, if the sum or total or summation or maximum value of the sum or total or summation value of Lₜ corresponding to one of the N_{L} combinations of values for first vector is less than or no larger than a second threshold or the first threshold, the candidates values of p, may be at least one of {½ for v∈{1,2} and ½ for v∈{3,4}}, {½ for v∈{1,2} and ¼ for v∈{3,4}}, {¼ for v∈{1,2} and ¼ for v∈{3,4}}, {¼ for v∈{1,2} and ⅛ for v∈{3,4}}, {⅛ for v∈{1,2} and 1/16 for v∈{3,4}}, {¼ for v∈{1,2}(for example, v∈{3,4} not supported)} and {½ for v∈{1,2}(for example, v∈{3,4} not supported)} and/or the candidate values for β may be at least one of {¼, ½, ¾} or {½, ¾}. In some embodiments, the second threshold may be a positive integer. For example, the second threshold may be no less than 2 and no larger than 12. In some embodiments, the second threshold may be less than the first threshold. For example, for the first type of codebook.

In some embodiments, if the sum or total or summation or maximum value of the sum or total or summation value of Lₜ corresponding to one of the N_{L} combinations of values for first vector is larger than or no less than a third threshold, the candidates values of M may be 1 and/or the candidate values for β may be at least one of {¼, ½, ⅛} or {¼, ⅛}. In some embodiments, the third threshold may be a positive integer. For example, the third threshold may be no less than 6 and no larger than 32.

In some embodiments, if the sum or total or summation or maximum value of the sum or total or summation value of Lₜ corresponding to one of the N_{L} combinations of values for first vector is less than or no larger than a fourth threshold or the third threshold, the candidates values of M may be at least one of {1, 2} and/or the candidate values for β may be at least one of {¼, ½, ¾} or {½, ¾}. In some embodiments, the fourth threshold may be a positive integer. For example, the fourth threshold may be no less than 1 and no larger than 16. In some embodiments, the fourth threshold may be less than the third threshold. For example, for the second type of codebook.

In some embodiments, the value of the first threshold and/or the value of the second threshold and/or the value of the third threshold and/or the value of the fourth threshold may be different according to different value of N_{TRP} or N. In some embodiments, the value of the first threshold and/or the value of the second threshold and/or the value of the third threshold and/or the value of the fourth threshold may be different according to N_{TRP}=2 may be less than or no larger than the value of the first threshold and/or the value of the second threshold and/or the value of the third threshold and/or the value of the fourth threshold may be different according to N_{TRP}=3 or N_{TRP}=4. In some embodiments, the value of the first threshold and/or the value of the second threshold and/or the value of the third threshold and/or the value of the fourth threshold may be different according to N_{TRP}-3 may be less than or no larger than the value of the first threshold and/or the value of the second threshold and/or the value of the third threshold and/or the value of the fourth threshold may be different according to N_{TRP}=4.

In some embodiments, if at least one of the N_{L} combinations of Lₜ is 6 or combination is {6,6,6,6}, the number of layers may be 1 or 2, and the associated value of pᵥ and β may be at least one of {½, ⅛} or {¼, ⅛} or {¼, ¼} or {⅛, ¾} or {⅛, ¼} or {⅛, ½} or {⅛, ⅛}, for example, pᵥ*β≤ 3/32. In some embodiments, pᵥ=½ for v=1,2,3,4 may be applied for mode 2 or the second mode of codebook structure (e.g. common FD basis across TRPs) only. For enhancement based on Rel-17 codebook, if N_{L} combinations of Lt (αₜ) are configured, and if M is configured as 2, and/or N is configured as 2 or 4, if Ltot<=X, M=2 is applied, and if Ltot>X, M is assumed to be 1. For enhancement based on Rel-17 codebook, if P=32, and αₙ=1 or ¾, M may be 1. For enhancement based on Rel-17 codebook, if v≤2 and if total number of non zero coefficients (reported in CSI part 1) is same as the maximum value of total number of non zero coefficients based on selected TRPs, there may be no need of bitmap for non zero coefficients indication in CSI part 2. In this case,

$${K}^{NZ} = {\sum }_{t = 1}^{N} {α}_{t} * \frac{P}{2} * M * v .$$

The network device 120 may transmit one or more reference signals on the subset of the plurality of CSI-RS resources to the terminal device 110. The terminal device 110 may measure the received one or more reference signals. For example, the terminal device 110 may determine reference signal received power (RSRP) based on the measurement of the one or more reference signals. Alternatively, or in addition, the terminal device 110 may determine reference signal received quality (RSRQ) based on the measurement of the one or more reference signals. In some other embodiments, the terminal device 110 may determine a received signal strength indicator (RSSI) based on the measurement of the one or more reference signals. It is noted that the terminal device 110 may perform any proper measurements on the received reference signals.

The terminal device 110 transmits (2030) the CSI report to the network device 120 based on the first combination, the first value from the set of values for second vectors and the second value from the set of values for the first parameter. In some embodiments, the CSI report may include any proper measurement metric, for example, RSRP or RSRQ. It is noted that the CSI report may include any proper information.

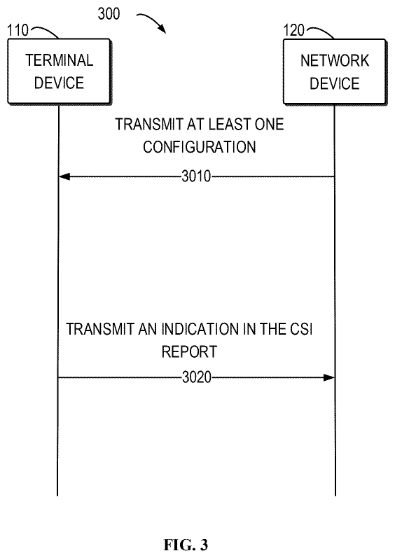

Reference is made to FIG. 3, which illustrates a signaling flow 300 of reporting angle information in accordance with some embodiments of the present disclosure. For the purposes of discussion, the signaling flow 300 will be discussed with reference to FIG. 1, for example, by using the terminal device 110 and the network device 120. It is noted that FIG. 2 is only an example embodiment.

The network device 120 transmits (3010) at least one configuration to the terminal device 110. The at least one configuration indicates a plurality of channel state information reference signal (CSI-RS) resources for channel measurement for a CSI report. The at least one configuration also indicates a number of second vectors and a size of a second vector window for a channel state information (CSI) report. In some embodiments, one CSI-RS resource in the plurality of CSI-RS resources corresponds to one transmission reception point (TRP) or TRP group.

In some embodiments, the second vector may refer to a FD basis or a FD vector. In some embodiments, the number of second vector may be 1 or 2. Alternatively, or in addition, the size of the second vector window may be 2 or 4. The terminal device 110 may be configured with number of FD basis vectors (M) to be 1 or 2, and the size of the FD basis window (e.g. FD_s or N_{f}) to be 2 or 4. In some embodiments, one or more of: the number of second vectors or the second vector window may be common to all TRPs (CSI-RS resources). In some embodiments, Table 15 shows FD basis vector for CJT CSI enhancement based on Rel-16 codebook or for the first type of codebook. In some embodiments, Table 16 shows FD basis vector for Rel-17 codebook or for the second type of codebook. It is noted that Tables 15 and 16 are only examples not limitations.

TABLE 15

| Number | | | |
|---|---|---|---|
| of FD | FD | | |
| basis | window | Report | |
| vectors | size | For reference TRP | For other TRPs |
| Mv = 1 | N/A | N/A | For a first example: |
| | | | FD basis selection among N3 vectors |
| | | | $( ⌈ {log}_{2} ( \begin{matrix}{N}_{3} \\ {M}_{v}\end{matrix} ) ⌉ )$ |
| | | | For a second example: |
| | | | $FD basis offset reporting ( ⌈ {log}_{2} ( \begin{matrix}{N}_{3} \\ {M}_{v}\end{matrix} ) ⌉ )$ |
| N3 <= 19, Mv ≠ 1 | N/A | $⌈ {log}_{2} ( \begin{matrix}{N}_{3} - 1 \\ {M}_{v} - 1\end{matrix} ) ⌉$ | For the first example: $FD basis selection ( ⌈ {log}_{2} ( \begin{matrix}{N}_{3} \\ {M}_{v}\end{matrix} ) ⌉ )$ |
| | | | For the second example: |
| | | | FD basis offset {0, ... N₃ − 1} |
| | | | (┌log₂(N₃)┐) and FD basis selection |
| | | | $( ⌈ {log}_{2} ( \begin{matrix}{N}_{3} - 1 \\ {M}_{v} - 1\end{matrix} ) ⌉ ) or$ |
| | | | FD basis offset assumed to be 0, and FD |
| | | | $basis selection ( ⌈ {log}_{2} ( \begin{matrix}{N}_{3} \\ {M}_{v}\end{matrix} ) ⌉ )$ |
| N3 > 19 | 2Mv | Mᵢₙᵢₜᵢₐₗ. For | For the first example: |
| | | example, | M_{initial,t}_. For example, M_{initial,t} ∈{0, ... |
| | | Mᵢₙᵢₜᵢₐₗ ∈ {−2Mv + | N₃ − 1}, and FD basis selection |
| | | 1, ... 0} and $⌈ {log}_{2} ( \begin{matrix}2 {M}_{V} - 1 \\ {M}_{v} - 1\end{matrix} ) ⌉$ | $( ⌈ {log}_{2} ( \begin{matrix}2 {M}_{v} - 1 \\ {M}_{v} - 1\end{matrix} ) ⌉ ) or ( ⌈ {log}_{2} ( \begin{matrix}2 {M}_{v} \\ {M}_{v}\end{matrix} ) ⌉ )$ For the second example: |
| | | | FD basis offset {0, ... N₃ − 1}, and FD basis |
| | | | $selection ( ⌈ {log}_{2} ( \begin{matrix}2 {M}_{v} - 1 \\ {M}_{v} - 1\end{matrix} ) ⌉ ) or$ |
| | | | $( ⌈ {log}_{2} ( \begin{matrix}2 {M}_{v} \\ {M}_{v}\end{matrix} ) ⌉ )$ |

TABLE 16

| Number of | | |
|---|---|---|
| FD basis | FD window | |
| vectors | size or Nf | Report |
| M = 1 | N/A | N/A |
| M = 2 | FD_s = 2 | N/A |
| M = 2 | FD_s = 4 | Second FD basis vector reported with |
| | | offset value {0, 1, . . . min(FD_s, N3)-1} |
| | | related to the first FD basis |
| | | vector (assumed to be 0) |

In some embodiments, for the reference CSI-RS resource in the second plurality of CSI-RS resources or in the plurality of CSI-RS resources, the terminal device 110 may determine and/or report a first offset for the second vectors (For example, represented as Mᵢₙᵢₜᵢₐₗ). In some embodiments, Mᵢₙᵢₜᵢₐₗ may be an integer. For example, Mᵢₙᵢₜᵢₐₗ ∈{−2M_{υ}+1, −2M_{υ}+2, . . . , 0}. In some embodiments, M_{υ} may be the number of second vectors for the reference CSI-RS resource or for each one CSI-RS resource in the second plurality of CSI-RS resources. In some embodiments, for the reference CSI-RS resource in the second plurality of CSI-RS resources, the terminal device 110 may determine a first plurality of second vectors (For example, a first window for the second vectors). In some embodiments, the first plurality of second vectors or the first window may be a plurality of second vectors with index {Mᵢₙᵢₜᵢₐₗ, (Mᵢₙᵢₜᵢₐₗ+1)mod N₃, (Mᵢₙᵢₜᵢₐₗ+2)mod N₃, . . . , (Mᵢₙᵢₜᵢₐₗ+2M~−1)mod N₃, (Mᵢₙᵢₜᵢₐₗ+2M_{υ})mod N₃}. In some embodiments, the number of second vectors in the first plurality of second vectors or the size of the first window may be M_{υ}. In some embodiments, the first plurality of second vectors may be selected or determined from a group or a whole set of N₃ second vectors. In some embodiments, when N₃>T_{N}. In some embodiments, T_{N} may be a positive integer. For example, 1≤T_{N}≤50. For example, T_{N}=19. In some embodiments, for each one of remaining CSI-RS resources t (except the reference CSI-RS resource), the terminal device 110 may determine and/or report a second offset for second vectors (For example, represented as M_{initial,t}). In some embodiments, M_{initial,t} may be an integer. In some embodiments, the number of candidate values for M_{initial,t} may be N₃ or floor(N₃/A) or ceil(N₃/A). In some embodiments, 0≤M_{initial,t}≤N₃−1. In some embodiments, B≤M_{initial,t}≤C. In some embodiments, B may be an integer. For example,

$$B = - ceil ( \frac{{N}_{3}}{2} ) or B = - ceil ( \frac{{N}_{3}}{2} ) + 1 or \\ B = - floor ( \frac{{N}_{3}}{2} ) or B = - floor ( \frac{{N}_{3}}{2} ) + 1$$

or B=0. In some embodiments, C may be an integer. For example,

$$C = ceil ( \frac{{N}_{3}}{2} ) or C = ceil ( \frac{{N}_{3}}{2} ) - 1 or \\ C = floor ( \frac{{N}_{3}}{2} ) or C = floor ( \frac{{N}_{3}}{2} ) - 1 or C = 2 {M}_{v} - 1 .$$

In some embodiments, A may be 2 or 3 or 4 or

$$floor ( \frac{{N}_{3}}{{M}_{v}} ) or ceil ( \frac{{N}_{3}}{{M}_{v}} ) .$$

In some embodiments, M_{initial,t}∈{0,1,2, . . . , N₃−1} or

$${M}_{initial , t} ∈ \{ - ceil ( \frac{{N}_{3}}{2} ) , - ceil ( \frac{{N}_{3}}{2} ) + 1 , - ceil ( \frac{{N}_{3}}{2} ) + 2 , … , 0 , 1 , 2 , … , ceil ( \frac{{N}_{3}}{2} ) - 2 , ceil ( \frac{{N}_{3}}{2} ) - 1 \} or$$

$${M}_{initial , t} ∈ \{ - floor ( \frac{{N}_{3}}{2} ) , - floor ( \frac{{N}_{3}}{2} ) + 1 , - floor ( \frac{{N}_{3}}{2} ) + 2 , \text{} … , 0 , 1 , 2 , … , floor ( \frac{{N}_{3}}{2} ) - 2 , floor ( \frac{{N}_{3}}{2} ) - 1 \} or$$

$${M}_{lnitial , t} ∈ \{ - ceil ( \frac{{N}_{3}}{2} ) + 1 , - ceil ( \frac{{N}_{3}}{2} ) + 2 , \text{} … , 0 , 1 , 2 , … , ceil ( \frac{{N}_{3}}{2} ) - 2 , ceil ( \frac{{N}_{3}}{2} ) - 1 \} or$$

$${M}_{initial , t} ∈ \{ - floor ( \frac{{N}_{3}}{2} ) + 1 , - floor ( \frac{{N}_{3}}{2} ) + 2 , \text{} … , 0 , 1 , 2 , … , floor ( \frac{{N}_{3}}{2} ) - 2 , floor ( \frac{{N}_{3}}{2} ) - 1 \} or$$

$${M}_{initial , t} ∈ \{ - floor ( \frac{{N}_{3}}{2} ) , - floor ( \frac{{N}_{3}}{2} ) + 1 , - floor ( \frac{{N}_{3}}{2} ) + 2 , \text{} … , 0 , 1 , 2 , … , ceil ( \frac{{N}_{3}}{2} ) - 2 , ceil ( \frac{{N}_{3}}{2} ) - 1 \} or$$

$${M}_{initial , t} ∈ \{ - ceil ( \frac{{N}_{3}}{2} ) - ceil ( \frac{{N}_{3}}{2} ) + 1 , - ceil ( \frac{{N}_{3}}{2} ) + 2 , \text{} … , 0 , 1 , 2 , … , floor ( \frac{{N}_{3}}{2} ) - 2 , floor ( \frac{{N}_{3}}{2} ) - 1 \} or$$

$${M}_{initial , t} ∈ \{ 0 , 1 , 2 , … , 2 Mv - 1 \} or {M}_{initial , t} ∈ \{ 0 , 1 , 2 , … , 2 Mv \} or \\ {M}_{initial , t} ∈ \{ 0 , A , 2 A , … , xA \} .$$

In some embodiments, wherein x may be

$$floor ( \frac{{N}_{3}}{A} ) or ceil ( \frac{{N}_{3}}{A} ) .$$

In some embodiments, t≠t_{ref}, and t_{ref} may be the index of reference CSI-RS resource. For example, M_{initial,t}_{_{ref}}∈{−2M_{υ}+1, −2M_{υ}+2, . . . , 0}.

In some embodiments, there may be a reference CSI-RS resource in the first plurality of CSI-RS resources or in the second plurality of CSI-RS resources. In some embodiments, the reference CSI-RS resource may be a CSI-RS resource in the second plurality of CSI-RS resources corresponding to a strongest coefficient indication (SCI) or a strongest amplitude coefficient or an indication in the bitmap for non zero coefficients indication. In some embodiments, the reference CSI-RS resource may be the first one of CSI-RS resource or the last one of CSI-RS resource or the latest one of CSI-RS resource in time in the first plurality of CSI-RS resources. In some embodiments, the reference CSI-RS resource may be the first one of CSI-RS resource or the last one of CSI-RS resource or the latest one of CSI-RS resource in time in the second plurality of CSI-RS resources.

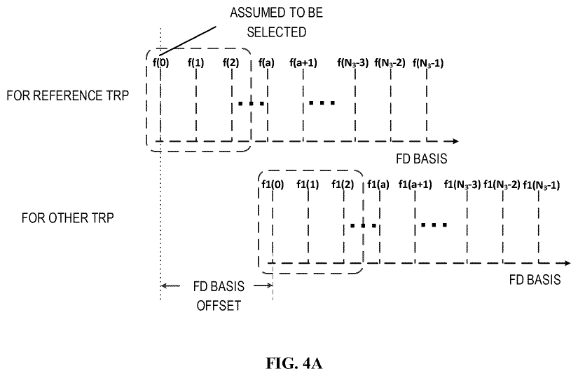

In some embodiments, the specific or a first value range may be {0, 1, 2, . . . , N3−1}, where N3 represent a total number of precoding matrices in the CSI report. In this case, the relative delay offsets across TRPs may be not known to the network device 120. For example, as shown in FIG. 4A, FD basis offset for TRPs which excludes the reference TRP for delay may be applied for adjustment of relative delay offset.

In some embodiments, the specific value or a second range may be at least one of {−2, −1, 0, 1, 2} or {−1, 0, 1, 2} or {−2, −1, 0, 1} or {−4, −3, −2, −1, 0, 1, 2, 3, 4} or {−3, −2, −1, 0, 1, 2, 3, 4} or {−4, −3, −2, −1, 0, 1, 2, 3} or {−3, −2, −1, 0, 1, 2, 3}. Alternatively, the specific range may be {0, 1, 2, N₃−2, N₃−1} or {0, 1, 2, N₃−1} or {0, 1, 2, 3, 4, N₃−4, N₃−3, N₃−2, N₃−1} or {0, 1, 2, 3, 4, N₃−3, N₃−2, N₃−1}. In some embodiments, the relative delay offset across TRPs may be known to the network device 120 but not accurate. In some embodiments, the reference TRP may be the TRP corresponding to strongest coefficient indication or strongest coefficient indicator (SCI) or strongest amplitude coefficient (delay may not be the smallest). For example, as shown in FIG. 4B, FD basis offset for TRPs (excluding reference TRP (e.g. reference for SCI)) may be applied for adjustment of relative delay offset.

In some embodiments, the specific or a third value range may be at least one of {0, 1, 2, 3} or {0,1,2} or {0,1} or {0,2} or {0,1,2,3,4,5,6,7}. In this case, the relative delay offset across TRPs may be known to the network device 120 but not accurate. Reference TRP may refer to the TRP corresponding to smallest delay (relative delay offsets for N−1 TRPs are non-negative), while the index of reference TRP for delay needs to be reported (┌log₂(N_{TRP})┐). For example, as shown in FIG. 4C, FD basis offset for TRPs (excluding reference TRP (e.g. reference for smallest delay)) may be applied for adjustment of relative delay offset.

In some embodiments, the specific value range may be configured by the network device 120. In this case, the configured value range may be one of: the first value range or the second value range or the third value range. In some embodiments, the configuration may reuse mode 1 and mode 2 configurations or the first mode of codebook structure and the second mode of codebook structure for Rel-18 CJT codebook. In some embodiments, Table 17 shows FD basis vector for CJT CSI enhancement.

TABLE 17

| Number | | Report | |
|---|---|---|---|
| of | FD | For | |
| FD basis | window | reference | |
| vectors | size | TRP | For other TRPs |
| M = 1 | N/A | N/A | For a third example: |
| | | | FD basis selection, range based on |
| | | | Case 2 |
| | | | For a fourth example: |
| | | | FD basis offset, range based on the |
| | | | above examples |
| M = 2 | FD_s = 2 | N/A | For the third example: |
| | | | FD window starting position needed |
| | | | For the fourth example: |
| | | | FD basis offset, range based on the |
| | | | above examples |
| M = 2 | FD_s = 4 | Second FD | For the third example: |
| | | basis vector | FD window starting position needed, |
| | | reported with | and second FD basis selection needed |
| | | offset value | For the fourth example: |
| | | {0, 1, . . . min | FD basis offset and second FD basis |
| | | (FD_s, N3)- | vector selection |
| | | 1} related to | |
| | | the first | |
| | | FD basis | |
| | | vector | |
| | | (assumed to | |
| | | be 0) | |

The terminal device 110 transmits (3020) an indication to the network device 120. The indication in the CSI report indicates a second vector offset corresponding to one CSI-RS resource of the plurality of CSI-RS resources, and the second vector offset is in a specific value range. In some embodiments, the second vector offset corresponds to one CSI-RS resource in the plurality of CSI-RS resources excluding a reference CSI-RS resource. In this case, the reference CSI-RS resource may be a CSI-RS resource corresponding to a strongest coefficient indication. In some embodiments, the second vector offset that corresponds to the reference CSI-RS resource may be 0.

In some embodiments, there may be a parameter “O₁”, and “O₁” may represent a first discrete fourier transform (DFT) oversampling in the first dimension. For example, “O₁” may be one of {1, 2, 4}. For another example, “O₁” may be 2 or 4. In some embodiments, there may be a parameter “O₂”, and “O₂” may represent a second DFT oversampling in the second dimension. For example, “O₂” may be one of {1, 2, 4}. For another example, “O₂” may be 2 or 4.

In some embodiments, one configuration of (N₁, N₂) may correspond to one configuration of (O₁, O₂). In some embodiments, one configuration of (O₁, O₂) may correspond to one configuration of (N₁, N₂). In some embodiments, the example configurations of (N₁, N₂) and (O₁, O₂) may be at least one of row and/or column in Table 18.

TABLE 18
Supported configurations of (N₁, N₂) and (O₁, O₂)

| Number of | | |
|---|---|---|
| CSI-RS | | |
| antenna ports, | | |
| P_{CSI-RS} | (N₁, N₂) | (O₁, O₂) |
| 4 | (2, 1) | (4, 1) |
| 8 | (2, 2) | (4, 4) |
| | (4, 1) | (4, 1) |
| 12 | (3, 2) | (4, 4) |
| | (6, 1) | (4, 1) |
| 16 | (4, 2) | (4, 4) |
| | (8, 1) | (4, 1) |
| 24 | (4, 3) | (4, 4) |
| | (6, 2) | (4, 4) |
| | (12, 1) | (4, 1) |
| 32 | (4, 4) | (4, 4) |
| | (8, 2) | (4, 4) |
| | (16, 1) | (4, 1) |

In some embodiments, the terminal device 110 does not expect to be configured with codebook mode 1 or the first mode of codebook structure (e.g. independent or separate FD basis across CSI-RS resources) and same QCL source RS (Type A/B/C (or average delay/delay spread)) for all the CSI-RS resources configured for one CSI report (Rel-18 CJT). In some embodiments, if the terminal device 110 is configured with same QCL source RS (Type A/B/C) for all the CSI-RS resources configured for one CSI report (Rel-18 CJT), the terminal device 110 does not expect to be configured with codebook mode 1 or the first mode of codebook structure. Alternatively, in some embodiments, the terminal device 110 does not expect to be configured with same QCL source RS for all the CSI-RS resources configured for one CSI report (Rel-18 CJT).

In some embodiments, for CSI enhancement based on Rel-16 codebook or for the first type of codebook, (e.g. as FD basis rotation/shift is applied), the field for SCI reporting may be

$$( ⌈ {log}_{2} ( {\sum }_{t = 1}^{N} 2 {L}_{t} ) ⌉ ) or ( ⌈ {log}_{2} ( {\sum }_{t = 1}^{{N}_{TRP}} 2 {L}_{t} ) ⌉ )$$

corresponding to selected TRPs or selected CSI-RS resources or the second plurality of CSI-RS resources (For example, at least for number of layers=1 or for layer 1). In some embodiments, for CSI enhancement based on Rel-17 codebook or for the second type of codebook, (e.g. FD basis rotation/shift is not specified), the field for SCI reporting may be

$$( ⌈ {log}_{2} ( M * {\sum }_{t = 1}^{N} 2 {L}_{t} ) ⌉ or ⌈ {log}_{2} ( M * {\sum }_{t = 1}^{N} {K}_{t} ) ⌉ or ⌈ {log}_{2} ( M * {\sum }_{t = 1}^{{N}_{TRP}} 2 {L}_{t} ) ⌉ or ⌈ {log}_{2} ( M * {\sum }_{t = 1}^{{N}_{TRP}} {K}_{t} ) ⌉ )$$

corresponding to selected TRPs (For example, at least for number of layers=1 or for layer 1). In some embodiments, SCI for different layers may correspond to same selected TRP or CSI-RS resource (For example, the reference CSI-RS resource). For example, SCI corresponding to layer v (v>1) may be

$$⌈ {log}_{2} ( {max}_{t} 2 {L}_{t} ) ⌉$$

for CSI enhancement based on Rel-16 codebook or for first type of codebook or

$$⌈ {log}_{2} ( M * {max}_{t} 2 {L}_{t} ) ⌉$$

for CSI enhancement based on Rel-17 codebook or for the second type of codebook.

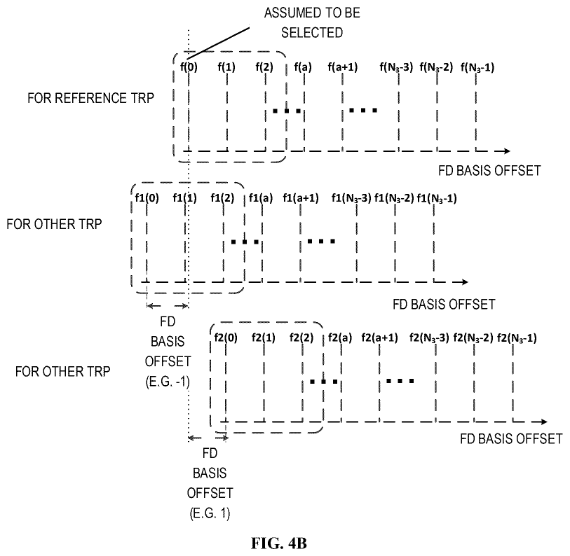

FIG. 5 shows a flowchart of an example method 500 in accordance with an embodiment of the present disclosure. The method 500 can be implemented at any suitable terminal devices. Only for the purpose of illustrations, the method 500 can be implemented at a terminal device 110 as shown in FIG. 1.

At block 510, the terminal device 110 receives, from a network device 12o, a configuration. The configuration indicates a plurality of channel state information reference signal (CSI-RS) resources for channel measurement for a CSI report and at least one configuration for a set of combinations of values for first vector, a set of values for second vector and a set of values for a first parameter for the CSI report. In this case, each value in a combination of values for first vector corresponds to one of the plurality of CSI-RS resources. In some embodiments, one CSI-RS resource corresponds to one transmission reception point (TRP) or TRP group.

At block 520, the terminal device 110 determines a first combination from the set of combinations of values for first vector, a first value from the set of values for second vector and a second value from the set of values for the first parameter based on at least a set of CSI-RS resources from the plurality of CSI-RS resources. In some embodiments, the first combination from the set of combinations of values for first vector is configured to be associated with at least one of the first value and the second value.

At block 530, the terminal device 110 transmit the CSI report based on the first combination, the first value from the set of values for second vectors and the second value from the set of values for the first parameter.

In some embodiments, for a first number of the plurality of CSI-RS resources, the terminal device 110 may determine whether to select one of a second number of CSI-RS resources. In this case, the first number may be at least one of {1, 2, 3, 4}, and the second number may be at least one of {1, . . . , the first number}. The second number may be configured via a radio resource control (RRC) signaling. In some embodiments, selection or not for each one of the second number of CSI-RS resources may be indicated with a bitmap in a first part of CSI, and a number of bits in the bitmap is the second number. In some embodiments, a remaining CSI-RS resource in the plurality of CSI-RS resources excluding the second number of CSI-RS resources may be selected for the CSI report.

In some embodiments, the terminal device 110 receives, from the network device 120, first information that indicates a subset of the set of combinations of values for first vector associated with at least one of: a subset of the set of values for second vector and a subset of the set of values for the first parameter. The CSI report may be based on one combination of the subset of the set of combinations. In some embodiments, the first information may be via at last one of: a RRC signaling or a medium access control (MAC) signaling.

In some embodiments, the terminal device 110 receives, from the network device 120, second information that indicates a subset of candidate values of a bitmap associated with a subset of the set of combinations of values for first vector associated with at least one of: a subset of the set of values for second vector and a subset of the set of values for the first parameter. The CSI report may be based on one combination of the subset of the set of combinations. In some embodiments, the second information may be via at last one of: a RRC signaling or a medium access control (MAC) signaling.

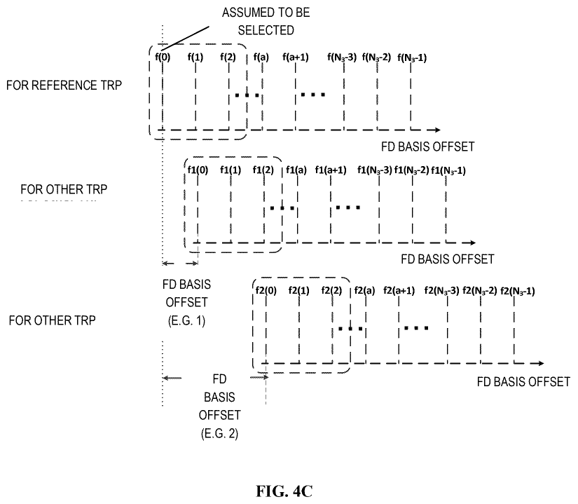

FIG. 6 shows a flowchart of an example method 600 in accordance with an embodiment of the present disclosure. The method 600 can be implemented at any suitable terminal devices. Only for the purpose of illustrations, the method 600 can be implemented at a terminal device 110 as shown in FIG. 1.

At block 610, the terminal device 110 receives, from the network device 120, at least one configuration indicating a plurality of channel state information reference signal (CSI-RS) resources for channel measurement for a CSI report. The at least one configuration indicates a number of second vectors and a size of a second vector window for a channel state information (CSI) report.

At block 620, the terminal device 110 transmits, to the network device 120, an indication in the CSI report indicating a second vector offset corresponding to one CSI-RS resource of the plurality of CSI-RS resources, and the second vector offset is in a specific value range.

In some embodiments, the number of second vectors is 1 or 2. In some embodiments, the size of the second vector window is 2 or 4.

In some embodiments, the specific value range is {0, 1, 2, . . . , N3−1}. In some embodiments, N3 is a total number of precoding matrices in the CSI report.

In some embodiments, the specific value range is {−2, −1, 0, 1, 2}. In some embodiments, the specific value range is {0, 1, 2, N3−2, N3−1}.

In some embodiments, the specific value range is configured by the network device. In some embodiments, the second vector is frequency domain (FD) basis vector.

In some embodiments, one CSI-RS resource in the plurality of CSI-RS resources corresponds to one transmission reception point (TRP) or TRP group. In some embodiments, the second vector offset corresponds to one CSI-RS resource in the plurality of CSI-RS resources excluding a reference CSI-RS resource, wherein the reference CSI-RS resource is a CSI-RS resource corresponding to a strongest coefficient indication. In some embodiments, the second vector offset corresponding to the reference CSI-RS resource is set to be 0.

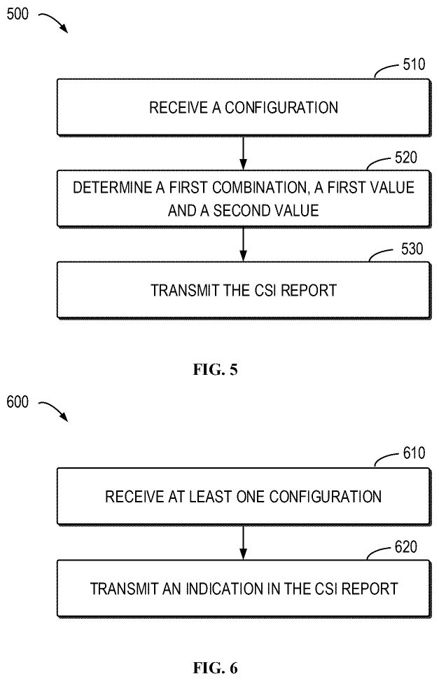

FIG. 7 shows a flowchart of an example method 700 in accordance with an embodiment of the present disclosure. The method 700 can be implemented at any suitable terminal devices. Only for the purpose of illustrations, the method 700 can be implemented at a network device 120 as shown in FIG. 1.

At block 710, the network device 120 transmits, to the terminal device 110, a configuration indicating a plurality of channel state information reference signal (CSI-RS) resources for channel measurement for a CSI report and at least one configuration for a set of combinations of values for first vector, a set of values for second vector and a set of values for a first parameter for the CSI report. Each value in a combination of values for first vector corresponds to one of the plurality of CSI-RS resources.

At block 720, the network device 120 receives the CSI report based on a first combination, a first value from the set of values for second vectors and a second value from the set of values for the first parameter. The first combination is determined from the set of combinations of values for first vector, the first value is determined from the set of values for second vector and the second value is determined from the set of values for the first parameter based on at least a set of CSI-RS resources from the plurality of CSI-RS resources.

In some embodiments, the first combination from the set of combinations of values for first vector is configured to be associated with at least one of the first value and the second value.

In some embodiments, one CSI-RS resource corresponds to one transmission reception point (TRP) or TRP group.

In some embodiments, the processor is configured to further cause the network device to: transmit, to the terminal device, first information that indicates a subset of the set of combinations of values for first vector associated with at least one of: a subset of the set of values for second vector and a subset of the set of values for the first parameter, and wherein the CSI report is based on one combination of the subset of the set of combinations, and wherein the first information is transmitted via at last one of: a RRC signaling or a medium access control (MAC) signaling.

In some embodiments, the processor is configured to further cause the network device to: transmit, to the terminal device, second information that indicates a subset of candidate values of a bitmap associated with a subset of the set of combinations of values for first vector associated with at least one of: a subset of the set of values for second vector and a subset of the set of values for the first parameter, and wherein the CSI report is based on one combination of the subset of the set of combinations, and wherein the second information is transmitted via at last one of: a RRC signaling or a medium access control (MAC) signaling.

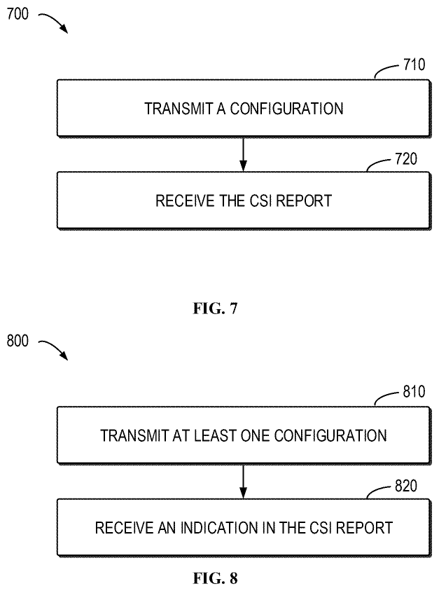

FIG. 8 shows a flowchart of an example method 800 in accordance with an embodiment of the present disclosure. The method 800 can be implemented at any suitable terminal devices. Only for the purpose of illustrations, the method 800 can be implemented at a network device 120 as shown in FIG. 1.

At block 810, the network device 120 transmits to the terminal device 110, at least one configuration indicating a plurality of channel state information reference signal (CSI-RS) resources for channel measurement for a CSI report. The at least one configuration indicates a number of second vectors and a size of a second vector window for a channel state information (CSI) report.

At block 820, the network device 120 receives, from the terminal device 110, an indication in the CSI report indicating a second vector offset corresponding to one CSI-RS resource of the plurality of CSI-RS resources. The second vector offset is in a specific value range.

In some embodiments, the number of second vectors is 1 or 2, or the size of the second vector window is 2 or 4.

In some embodiments, the specific value range is {0, 1, 2, . . . , N3−1}, and N3 is a total number of precoding matrices in the CSI report. In some embodiments, the specific value range is {−2, −1, 0, 1, 2}, or the specific value range is {0, 1, 2, N3−2, N3−1}.

In some embodiments, the specific value range is configured by the network device. In some embodiments, the second vector is frequency domain (FD) basis vector. In some embodiments, one CSI-RS resource in the plurality of CSI-RS resources corresponds to one transmission reception point (TRP) or TRP group. In some embodiments, the second vector offset corresponds to one CSI-RS resource in the plurality of CSI-RS resources excluding a reference CSI-RS resource, wherein the reference CSI-RS resource is a CSI-RS resource corresponding to a strongest coefficient indication. In some embodiments, the second vector offset corresponding to the reference CSI-RS resource is set to be 0.

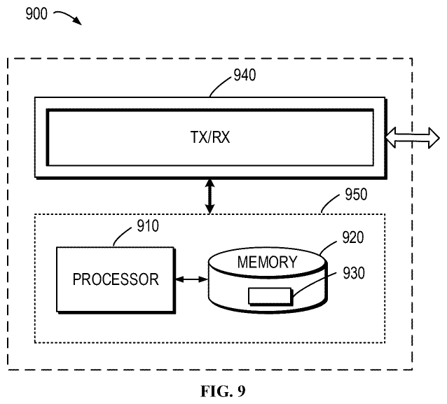

FIG. 9 is a simplified block diagram of a device 900 that is suitable for implementing embodiments of the present disclosure. The device 900 can be considered as a further example implementation of any of the devices as shown in FIG. 1. Accordingly, the device 900 can be implemented at or as at least a part of the terminal device 110 or the network device 120.

As shown, the device 900 includes a processor 910, a memory 920 coupled to the processor 910, a suitable transmitter (TX)/receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1 to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to perform: the above methods.

In some embodiments, a network device comprises a circuitry configured to perform the above methods.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, a terminal device, comprises a processor, configured to cause the terminal device to: receive, from a network device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; determine a first combination from the set of combinations of values for first vector, a first value from the set of values for second vector and a second value from the set of values for the first parameter based on at least a set of CSI-RS resources from the plurality of CSI-RS resources; and transmit the CSI report based on the first combination, the first value from the set of values for second vectors and the second value from the set of values for the first parameter.

In some embodiments, the first combination from the set of combinations of values for first vector is configured to be associated with at least one of the first value and the second value.

In some embodiments, one CSI-RS resource corresponds to one transmission reception point (TRP) or TRP group.

In some embodiments, the processor is configured to further cause the terminal device to: for a first number of the plurality of CSI-RS resources, determine whether to select one of a second number of CSI-RS resources, the first number is at least one of {1, 2, 3, 4}, the second number is at least one of {1, . . . , the first number}, and the second number is configured via a radio resource control (RRC) signaling, wherein selection or not for each one of the second number of CSI-RS resources is indicated with a bitmap in a first part of CSI, and a number of bits in the bitmap is the second number.

In some embodiments, a remaining CSI-RS resource in the plurality of CSI-RS resources excluding the second number of CSI-RS resources is selected for the CSI report.

In some embodiments, the processor is configured to further cause the terminal device to: receive, from the network device, first information that indicates a subset of the set of combinations of values for first vector associated with at least one of: a subset of the set of values for second vector and a subset of the set of values for the first parameter, and wherein the CSI report is based on one combination of the subset of the set of combinations, and wherein the first information is received via at last one of: a RRC signaling or a medium access control (MAC) signaling.

In some embodiments, the processor is configured to further cause the terminal device to: receive, from the network device, second information that indicates a subset of candidate values of a bitmap associated with a subset of the set of combinations of values for first vector associated with at least one of: a subset of the set of values for second vector and a subset of the set of values for the first parameter, and wherein the CSI report is based on one combination of the subset of the set of combinations, and wherein the second information is received via at last one of: a RRC signaling or a medium access control (MAC) signaling.

In an aspect, a terminal device, comprises a processor, configured to cause the terminal device to: receive, from a network device, at least one configuration indicating a plurality of channel state information reference signal (CSI-RS) resources for channel measurement for a CSI report, wherein the at least one configuration indicates a number of second vectors and a size of a second vector window for a channel state information (CSI) report; and transmit, to the network device, an indication in the CSI report indicating a second vector offset corresponding to one CSI-RS resource of the plurality of CSI-RS resources, and the second vector offset is in a specific value range.

In some embodiments, the number of second vectors is 1 or 2, or the size of the second vector window is 2 or 4.

In some embodiments, the specific value range is {0, 1, 2, . . . , N3−1}, and N3 is a total number of precoding matrices in the CSI report.

In some embodiments, the specific value range is {−2, −1, 0, 1, 2}, or the specific value range is {0, 1, 2, N3−2, N3−1}.

In some embodiments, the specific value range is configured by the network device.

In some embodiments, the second vector is frequency domain (FD) basis vector.

In some embodiments, one CSI-RS resource in the plurality of CSI-RS resources corresponds to one transmission reception point (TRP) or TRP group.

In some embodiments, the second vector offset corresponds to one CSI-RS resource in the plurality of CSI-RS resources excluding a reference CSI-RS resource, wherein the reference CSI-RS resource is a CSI-RS resource corresponding to a strongest coefficient indication.

In some embodiments, the second vector offset corresponding to the reference CSI-RS resource is set to be 0.

In an aspect, a network device, comprises a processor, configured to cause the network device to: transmit, to a terminal device, a configuration indicating a plurality of channel state information reference signal (CSI-RS) resources for channel measurement for a CSI report and at least one configuration for a set of combinations of values for first vector, a set of values for second vector and a set of values for a first parameter for the CSI report, wherein each value in a combination of values for first vector corresponds to one of the plurality of CSI-RS resources; receive the CSI report based on a first combination, a first value from the set of values for second vectors and a second value from the set of values for the first parameter, wherein the first combination is determined from the set of combinations of values for first vector, the first value is determined from the set of values for second vector and the second value is determined from the set of values for the first parameter based on at least a set of CSI-RS resources from the plurality of CSI-RS resources.

In some embodiments, the first combination from the set of combinations of values for first vector is configured to be associated with at least one of the first value and the second value.

In some embodiments, one CSI-RS resource corresponds to one transmission reception point (TRP) or TRP group.

In some embodiments, the processor is configured to further cause the network device to: transmit, to the terminal device, first information that indicates a subset of the set of combinations of values for first vector associated with at least one of: a subset of the set of values for second vector and a subset of the set of values for the first parameter, and wherein the CSI report is based on one combination of the subset of the set of combinations, and wherein the first information is transmitted via at last one of: a RRC signaling or a medium access control (MAC) signaling.

In some embodiments, the processor is configured to further cause the network device to: transmit, to the terminal device, second information that indicates a subset of candidate values of a bitmap associated with a subset of the set of combinations of values for first vector associated with at least one of: a subset of the set of values for second vector and a subset of the set of values for the first parameter, and wherein the CSI report is based on one combination of the subset of the set of combinations, and wherein the second information is transmitted via at last one of: a RRC signaling or a medium access control (MAC) signaling.

In an aspect, a network device, comprises a processor, configured to cause the network device to: transmit, to a terminal device, at least one configuration indicating a plurality of channel state information reference signal (CSI-RS) resources for channel measurement for a CSI report, wherein the at least one configuration indicates a number of second vectors and a size of a second vector window for a channel state information (CSI) report; and receive, from the terminal device, an indication in the CSI report indicating a second vector offset corresponding to one CSI-RS resource of the plurality of CSI-RS resources, and the second vector offset is in a specific value range.

In some embodiments, the number of second vectors is 1 or 2, or the size of the second vector window is 2 or 4.

In some embodiments, the specific value range is {0, 1, 2, . . . , N3−1}, and N3 is a total number of precoding matrices in the CSI report.

In some embodiments, the specific value range is {−2, −1, 0, 1, 2}, or the specific value range is {0, 1, 2, N3−2, N3−1}.

In some embodiments, the specific value range is configured by the network device.

In some embodiments, the second vector is frequency domain (FD) basis vector.

In some embodiments, one CSI-RS resource in the plurality of CSI-RS resources corresponds to one transmission reception point (TRP) or TRP group.

In some embodiments, the second vector offset corresponds to one CSI-RS resource in the plurality of CSI-RS resources excluding a reference CSI-RS resource, wherein the reference CSI-RS resource is a CSI-RS resource corresponding to a strongest coefficient indication.

In some embodiments, the second vector offset corresponding to the reference CSI-RS resource is set to be 0.

In another solution, a computer readable medium having instructions stored thereon, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method, performed by a terminal device, the method comprising:
receiving, from a network device, a first configuration indicating a plurality of channel state information reference signal (CSI-RS) resources and a second configuration indicating a set of combinations of values associated with first vectors; and
transmitting a CSI report, to the network device, based on a combination of values, wherein:
the combination of values is from the set of combinations of values based on a subset of CSI-RS resources from the plurality of CSI-RS resources, and each value in the combination of values corresponds to one CSI-RS resource of the subset of CSI-RS resources.

22. The method of claim 21, wherein:
the CSI-RS report is transmitted based on a first value, wherein:
the first value is from a set of values for a second vector based on the subset of CSI-RS resources, and the set of values for the second vector is based on a third configuration from the network device.

23. The method of claim 21, wherein:
the CSI-RS report is transmitted based on a second value,
the second value is from a set of values for a first parameter, and
the set of values for the first parameter is based on the first configuration and the second configuration.

24. The method of claim 21, wherein
a number of the first vectors, corresponding to the one CSI-RS resource in the subset of CSI-RS resources, is one of 2, 4 and 6.

25. The method of claim 21, wherein:
the CSI report comprises a field for a strongest coefficient indication with a bitwidth of
$$⌈ {log}_{2} ( {\sum }_{t = 1}^{N} 2 {L}_{t} ) ⌉ ,$$
wherein N is a number of CSI-RS resources comprised in the subset of CSI-RS resources, Lₜ is a value corresponding to t-th CSI-RS resource in the subset of CSI-RS resources.

26. The method of claim 21, wherein:
the CSI report comprises an indication indicating an offset, the offset corresponds to one CSI-RS resource in the plurality of CSI-RS resources excluding a reference CSI-RS resource, and the reference CSI-RS resource is a first CSI-RS resource in the subset of CSI-RS resources.

27. The method of claim 21, wherein:
the combination of values is one of {2,2}, {2,4} or {4,4}, in a case where a number of the plurality of CSI-RS resources is 2;
the combination of values is one of {2,2,2}, {4,2,2} or {4,4,4}, in a case where the number of the plurality of CSI-RS resources is 3;
the combination of values is one of {2,2,2,2} or {4,4,4,4}, in a case where the number of the plurality of CSI-RS resources is 4.

28. A method, performed by a network device, the method comprising:
transmitting, to a terminal device, a first configuration indicating a plurality of channel state information reference signal (CSI-RS) resources and a second configuration indicating a set of combinations of values associated with first vectors; and
receiving a CSI report, from the terminal device, associated with a combination of values, wherein:
the combination of values is from the set of combinations of values based on a subset of CSI-RS resources from the plurality of CSI-RS resources, and each value in the combination of values corresponds to one CSI-RS resource of the subset of CSI-RS resources.

29. The method of claim 28, wherein:
the CSI-RS report is transmitted based on a first value, wherein:
the first value is from a set of values for a second vector based on the subset of CSI-RS resources, and the set of values for the second vector is based on a third configuration from the network device.

30. The method of claim 28, wherein:
the CSI-RS report is transmitted based on a second value,
the second value is from a set of values for a first parameter, and
the set of values for the first parameter is based on the first configuration and the second configuration.

31. The method of claim 28, wherein
a number of the first vectors, corresponding to the one CSI-RS resource in the subset of CSI-RS resources, is one of 2, 4 and 6.

32. The method of claim 28, wherein:
the CSI report comprises a field for a strongest coefficient indication with a bitwidth of
$$⌈ {log}_{2} ( {\sum }_{t = 1}^{N} 2 {L}_{t} ) ⌉ ,$$
wherein N is a number of CSI-RS resources comprised in the subset of CSI-RS resources, Lₜ is a value corresponding to t-th CSI-RS resource in the subset of CSI-RS resources.

33. The method of claim 28, wherein:
the CSI report comprises an indication indicating an offset, the offset corresponds to one CSI-RS resource in the plurality of CSI-RS resources excluding a reference CSI-RS resource, and the reference CSI-RS resource is a first CSI-RS resource in the subset of CSI-RS resources.

34. The method of claim 28, wherein:
the combination of values is one of {2,2}, {2,4} or {4,4}, in a case where a number of the plurality of CSI-RS resources is 2;
the combination of values is one of {2,2,2}, {4,2,2} or {4,4,4}, in a case where the number of the plurality of CSI-RS resources is 3;
the combination of values is one of {2,2,2,2} or {4,4,4,4}, in a case where the number of the plurality of CSI-RS resources is 4.

35. A terminal device, comprising a processor configured to cause the terminal device to:
receive, from a network device, a first configuration indicating a plurality of channel state information reference signal (CSI-RS) resources and a second configuration indicating a set of combinations of values associated with first vectors; and
transmit a CSI report, to the network device, based on a combination of values, wherein:
the combination of values is from the set of combinations of values based on a subset of CSI-RS resources from the plurality of CSI-RS resources, and each value in the combination of values corresponds to one CSI-RS resource of the subset of CSI-RS resources.

36. The terminal device of claim 35, wherein:
the CSI-RS report is transmitted based on a first value, wherein:
the first value is from a set of values for a second vector based on the subset of CSI-RS resources, and the set of values for the second vector is based on a third configuration from the network device.

37. The terminal device of claim 35, wherein:
the CSI-RS report is transmitted based on a second value,
the second value is from a set of values for a first parameter, and
the set of values for the first parameter is based on the first configuration and the second configuration.

38. The terminal device of claim 35, wherein
a number of the first vectors, corresponding to the one CSI-RS resource in the subset of CSI-RS resources, is one of 2, 4 and 6.

39. The terminal device of claim 35, wherein:
the CSI report comprises a field for a strongest coefficient indication with a bitwidth of
$$⌈ {log}_{2} ( {\sum }_{t = 1}^{N} 2 {L}_{t} ) ⌉ ,$$
wherein N is a number of CSI-RS resources comprised in the subset of CSI-RS resources, Lₜ is a value corresponding to t-th CSI-RS resource in the subset of CSI-RS resources.

40. The terminal device of claim 35, wherein:
the CSI report comprises an indication indicating an offset, the offset corresponds to one CSI-RS resource in the plurality of CSI-RS resources excluding a reference CSI-RS resource, and the reference CSI-RS resource is a first CSI-RS resource in the subset of CSI-RS resources.
